(19) United States
(12) Patent Application Publication
(10) Pub. No.: US 2024/0347722 A1
(43) Pub. Date: Oct. 17, 2024

(54) Defect-driven Ion Storage on Hexagonal Boron Nitride Anodes for High-Performance and Fire-Safe Lithium Ion Batteries

(71) Applicant: The Penn State Research Foundation, University Park, PA (US)

(72) Inventors: Mauricio Terrones, University Park, PA (US); Yu Lei, University Park, PA (US); Venkata Sai Avvaru, Madrid (ES); Kazunori Fujisawa, University Park, PA (US); George Bepete, University Park, PA (US); Vinodkumar Etacheri, Madrid (ES)

(21) Appl. No.: 18/625,259

(22) Filed: Apr. 3, 2024

Related U.S. Application Data
(60) Provisional application No. 63/496,514, filed on Apr. 17, 2023.

(51) Int. Cl. H01M 4/58; C01B 21/064; H01G 11/50; H01M 4/02; H01M 10/0525; H01M 10/054; H01M 10/42; H01M 50/383

(52) U.S. Cl. CPC H01M 4/58; H01M 10/0525; H01M 10/054; H01M 10/4235; H01M 50/383; C01B 21/064; H01G 11/50; H01M 2004/027

(57) ABSTRACT

Embodiments can relate to a method for defect engineering boron nitride (BN). The method can involve forming reactive BN (RBN) by breaking B—N bonds, and activation of the RBN. Forming RBN can involve cryo-milling, ball-milling, sonication, focused ion/electron beam irradiation, detonation, chemical treatment, and/or thermal treatment in limited oxygen. Activation of the RBN can involve chemical activation and/or electrochemical activation. The defect engineered BN can be used to form or be a component of an anode electrode. The anode electrode can include an electrically conductive member including a microstructure layer. The microstructure layer can be made of BN having a surface defect configured to provide a diffusion independent pseudocapacitive ion storage mechanism.

### CROSS-REFERENCE TO RELATED APPLICATIONS

This patent application is related to and claims the benefit of U.S. provisional patent application No. 63/496,514, filed on Apr. 17, 2023, the entire contents of which is incorporated herein by reference.

### FIELD OF THE INVENTION

Embodiments relate to a method for defect engineering boron nitride (BN) by forming reactive BN (RBN) via mechanisms that break B—N bonds, followed by activation of the RBN. Embodiments of the defect engineered BN can be used to fabricate an anode electrode, wherein the surface defect is configured to provide a diffusion independent pseudocapacitive ion storage mechanism.

### BACKGROUND OF THE INVENTION

Rechargeable batteries are one of the most important energy storage devices for portable electronics, medical applications, electric vehicles and power grids. Additionally, secondary Li-ion batteries have attracted tremendous interest due to their high energy density, good cycle-life and superior efficiency when compared to Pb-acid, Ni-MH and Ni—Cd batteries. However, the energy (100-300 Wh kg⁻¹) and power density (250-400 W kg⁻¹) of the current generation in Li-ion batteries are inadequate for several applications including long-range electric vehicles. One of the main reasons for this is the use of graphite anodes possessing low specific capacity (<372 mAh g⁻¹) and the degradation under extreme condition. The use of graphite anodes and flammable carbonaceous electrolyte solutions can seriously compromise the safety of Li-ion batteries. These drawbacks of graphite anodes triggered extensive research on high-capacity anodes based on conversion (SnO₂, Fe₂O₃, Co₃O₄, CoO, NiO, MnO₂, MoO₃, WO₃, etc.) and alloying (Si, Ge, Sn, etc.) reactions. However, these conversion and alloying type electrodes experience severe capacity fading on extended cycling due to extreme volume changes related to variations in the crystal structure of the host material.

As can be appreciated, mediocre electrochemical performance and poor safety characteristics of graphite anodes are seriously limiting the practical applications of current generation Li-ion batteries. Especially with the upsurge in demand for energy storage at extreme conditions (e.g., elevated temperature), anodes with thermal tolerance (room temperature to 60° C.) are in demand. Rational design of alternative fire-safe and high-capacity anodes with a wide operating temperature window, capable of fast-charging and long cycle-life is crucial for the development of Li-ion batteries development under extreme conditions.

Hence, there is a need in the art to develop high specific capacity, fast-charging, and long-cycle life anodes for the realization of innovative high energy/power density and long-lasting Li-ion batteries.

Conventional methods and systems in this field can be appreciated by U.S. Pat. Nos. 11,813,674; 11,552,296; 11,075,395; U.S. 2021/0370271; Towards Integration of Two-Dimensional Hexagonal Boron Nitride (2D h-BN) in Energy Conversion and Storage Devices by Shayan Angizi, et al. which is available at https://doi.org/10.3390/en15031162.

### SUMMARY OF THE INVENTION

Embodiments can relate to a high performance and fire-safe hBN electrode with a wide operation window (room temperature to 60° C.) for fuel cell Li-ion electrochemical energy storage devices through defect engineering. Exemplary fuel cell electrochemical devices include batteries, capacitors, hybrid-capacitor devices, all solid-state devices. Examples disclosed herein demonstrate a technique in which electrochemically inert hBN is activated by introducing nitrogen vacancy defects on surfaces and edges through cryoOmilling. Results indicate that defective hBN anodes demonstrated high specific capacity (880 mAh g⁻¹ @25 mA g⁻¹), rate performance (480 mAh g⁻¹ @ 5 A g⁻¹) and cycling stability (5000 cycles) compared to insertion, conversion, and alloying type anodes reported in prior art and current technologies. These anodes also exhibit superior fire-safety characteristics compared to conventional graphite anodes. In addition, Li-ion fuel cells containing LiNiMnCoO₂ cathode and defective hBN anodes demonstrated significantly higher energy and power density (400 Wh kg⁻¹ and 1 kW kg⁻¹) compared to graphite/LiNiMnCoO₂ fuel cell (121 Wh kg⁻¹ and 250 W kg⁻¹). The Li-ion storage mechanism in the defective hBN based fuel cell can be attributed to the reversible LiF formation on defective hBN during charge-discharge process. Nitrogen antisite (N_{B}V_{N}) defect are the biggest contributor of the surface pseudocapacitive Li-ion storage. It is worth noting that Li-ion storage through reversible LiF formation established in this case is drastically different from the intercalation type mechanism of conventional graphite anodes. Pseudocapacitive type surface storage also facilitates high specific capacity, rate performance and cycling stability. Defect induced electrochemical activation of hBN in this disclosure opens up new avenues for the designing of high-performance electrochemical energy storage electrodes through defect engineering. The defective hBN based electrode is applicable to other fuel cells including, batteries, capacitors, hybrid battery-capacitor device, all solid-state devices, etc.

As can be appreciated from the present disclosure, one of the technical improvements relates to a particular application of specific cryomilling time and conditions that can lead to the fabrication of battery electrodes that are more efficient. Intrinsic reactivities of the defects in hBN can accelerate the ion storage (Li), so that it can be used for Li-ion batteries, Li-ion capacitors. The storage mechanism can be based on pseudocapacitive storage, and the defects can catalyze reversible conversion of LiF, which is the intermediates during Li-ion storage reaction. Pseudocapacitive storage is already a known phenomenon that is widely used, but the techniques disclosed herein provide for catalytic reactivities of the defects that can promote the formation of useful intermediates that can help Li-ion conversion.

Embodiments can relate to an electrode. The electrode can include an electrically conductive member including a microstructure layer. The microstructure layer can include boron nitride (BN) having a surface defect configured to provide a diffusion independent pseudocapacitive ion storage mechanism.

In some embodiments, the BN microstructure can be hexagonal BN (hBN) platelets, hBN nanotubes, cubic BN, BN nanostructures, amorphous BN, non-stoichiometric BN, BₐX_{b}Y_{c}N_{d} (X, Y═H, C, O, P, Si), or any combination thereof.

In some embodiments, the electrode can include plural surface defects, at least one surface defect of the plural surface defects being configured to provide the pseudocapacitive ion storage mechanism.

In some embodiments, at least one surface defect can be a type of defect that differs from a type of defect for at least one other surface defect.

In some embodiments, the surface defect can include a nitrogen vacancy.

In some embodiments, the plural surface defects can include a vacancy defect, a Stone-Wales defect, an oxygenated defect, a hydroxylized defect, and/or a substitutional defect.

In some embodiments, the surface defect can be configured to provide the pseudocapacitive ion storage mechanism for a Li ion, a Na ion, a K ion, a Ca ion, a Zn ion, an Al ion, or a Mg ion.

In some embodiments, the electrically conductive member can be configured as an anode electrode for a fuel cell, a battery device, a capacitor device, a hybrid battery-capacitor device, or a solid-state device.

In some embodiments, the electrically conductive member can be an electrode for a thermally stable secondary fuel cell operable within a range from −30° C. to 100° C.

In some embodiments, the thermally stable secondary fuel cell can be an ion battery comprising a Li-ion battery, a K-ion battery, a Na-ion battery, an Al-ion battery, a Ca-ion battery, a Zn-ion battery, a Mg-ion battery, or any combination thereof.

In some embodiments, at least a portion of the electrically conductive member having the microstructure layer can be fire retardant, fire resistance, or fireproof.

Embodiments can relate to a fuel cell having an anode including a microstructure layer. The microstructure layer can include boron nitride (BN) having a surface defect configured to provide a diffusion independent pseudocapacitive ion storage mechanism.

In some embodiments, the cycle-life of the fuel cell can be equal to or greater than 500 cycles, the energy density can be equal to or greater than 400 Wh kg⁻¹; and/or the power density can be equal to or greater than 1 kW kg⁻¹.

Embodiments can relate to a method for defect engineering boron nitride (BN). The method can involve forming reactive BN (RBN) by breaking B—N bonds. The method can involve activation of the RBN.

In some embodiments, forming RBN can involve cryo-milling, ball-milling, sonication, focused ion/electron beam irradiation, detonation, chemical treatment, and/or thermal treatment in limited oxygen. Activation of the RBN can involve chemical activation and/or electrochemical activation.

In some embodiments, the activation can involve creating an F-ion, and forming a metal-F bond with the F-ion.

In some embodiments, the activation can involve electrochemical cyclic voltammetry, galvanostatic cycling, and/or potentiostatic cycling.

In some embodiments, the activation can involve cycling the RBN using a F-ion supporting electrolyte. The cycling can decompose the electrolyte to reversibly store a metal ion through metal ion-F bond formation.

In some embodiments, the activation can involve cycling an electrochemical cell comprising: an anode comprising a microstructure layer of RBN; a cathode comprising a metal; and electrolyte containing ion salts of the metal and F.

In some embodiments, anions can include PF6, TFSI, and/or F.

Embodiments can relate to a method of generating an ion storage mechanism in or on a microstructure surface. The method can involve generating a surface defect configured to provide a diffusion independent pseudocapacitive ion storage mechanism without use of intercalation.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIGS. 1A, 1B, 1C, 1D, and 1E show an exemplary formation of defective boron nitride (150BN) via cryo-milling. FIG. 1A shows a schematic formation of 150BN via cryo-milling; FIG. 1B shows XRD spectra of 150BN and hBN; FIG. 1C shows N₂ adsorption-desorption isotherms of 150BN and hBN at 70 K; FIG. 1D shows selected HRTEM image of hBN and its FFT pattern (inset); FIG. 1E shows selected HRTEM image of 150BN and the STEM image with atomic vacancies.

FIGS. 2A, 2B, 2C, 2D, and 2E show formation and characterizations of 150BN-EA60. FIG. 2A shows a schematic illustration of the electrochemical activation at 60° C. (EA60) process to form 150BN-EA60; FIG. 2B shows XPS survey spectra of 150BN and 150BN-EA60; FIG. 2C shows XPS B Is spectra of hBN, 150BN, and 150BN-EA60; FIG. 2D shows FTIR spectra of 150BN and 150BN-EA60; FIG. 2E shows selected HRTEM image of 150BN-EA60 and the intensity profile of the LiF (111) plane.

FIGS. 3A, 3B, 3C, 3D, and 3E show in situ and ex situ characterizations of 150BN-EA60 at the charged (CHG-3 V) and discharged (DCH-0 V) states. FIG. 3A shows in situ XRD of 150BN-EA60 electrode in Li-ion half-cell; FIG. 3B shows XRD spectra from a at different conditions: no bia, CHG-3 V and DCH-0 V; FIG. 3C shows XPS B Is profile of 150BN-EA60 at CHG-3 V; FIG. 3D shows XPS F 1s profile of 150BN-EA60 at DCH-0 V and CHG-3 V; FIG. 3E shows a schematic of the storage mechanism.

FIGS. 4A, 4B, 4C, 4D, 4E, and 4F show electrochemical performance of the half-cells. FIG. 4A shows high temperature (60° C.) rate performance of hBN, 150BN, and 150BN-EA60; FIG. 4B shows charge-discharge profiles of 150BN-EA60 at different current densities (25, 50, 100, 200, 500, 1000, 2000, 5000 A/g); FIG. 4C shows quantification of pseudocapacitive and diffusion limited contributions to total charge storage of 150BN-EA60 at 1 mV/s; FIG. 4D shows a summary and comparison of the pseudocapacitive and diffusion limited contributions to total charge storage of hBN and 150BN-EA60 at different scan rates (0.1, 0.3, 0.5, 1, 2, 5, and 10 mV/s); FIG. 4E shows EIS spectra of hBN, 150BN, and 150BN-EA60; FIG. 4F shows cycling performance of 150BN-EA60.

FIGS. 5A, 5B, 5C, 5D, 5E, and 5F show fuel cell performance with LiNiMnCoO₂ cathodes. FIG. 5A shows specific capacity vs. current density comparison among 150BN-EA60, graphite, and 150BN fuel cell at room temperature (RT), as well as that of 150BN-EA60 fuel cell at 60° C.;

FIG. 5B shows a schematic of the 150BN-EA60/LiNiMnCoO₂ fuel cell; FIG. 5C shows cycling performance of 150BN-EA60/LiNiMnCoO₂ and graphite/LiNiMnCoO₂ fuel cell at 60° C. with 1 A/g; FIG. 5D shows charging-discharging profiles of 150BN-EA60/LiNiMnCoO₂ fuel cell at different cycles (1, 50, 100, 500, 1000, and 2000 cycle); FIG. 5E shows DSC curves of 150BN-EA60 and graphite anodes and the fire retardant electrode tests (inset); FIG. 5F shows Ragone plots of different energy storage system and 150BN-EA60/LiNiMnCoO₂ fuel cell.

FIGS. 6A, 6B, 6C, 6D, and 6E show DFT calculations. FIG. 6A shows simulated and experimental PL Spectra for potential defects responsible for the emission observed in 150BN; FIG. 6B shows the defects shown in FIG. 6A; simulated and experimental PL Spectra for FIG. 6C, CHG-3 V, and FIG. 6D, DCH-0 V; FIG. 6E shows the reaction mechanism pathway for the adsorption of a F-ion in the presence of an N_{B}V_{N} defect.

FIG. 7A shows the measured full width half maximum (FWHM) and the calculated grain size of the BN vs. different cryo-milling time (0, 9, 18, 27, 45, 90, 120, 150, and 900 min), based on the BN (002) peak. The grain size perpendicular to (002) was calculated using the Scherrer equation with the measured FWHM. FIG. 7B shows particle size vs. cryo-milling time (0, 9, 18, 27, 45, and 90 min).

FIG. 8 shows N₂ adsorption/desorption isotherms (filled/empty squares, respectively) of hBN, 45BN, 90BN, and 900BN.

FIGS. 9A, 9B, and 9C show HRTEM of the disordered structures with extended vacancies in 90BN: FIG. 9A curved planes; FIG. 9B exposed edges; FIG. 9C amorphous region.

FIG. 10A shows XPS analysis of hBN; FIG. 10B shows XPS analysis of 90BN. The insets are the high-resolution B Is, O Is, and N Is scan, and the concentration of B, N, and O.

FIG. 11 shows ESR spectra of hBN, 45 BN, 90BN at 293 K.

FIG. 12 shows statistic PL emission study of 90BN with a 488 nm excitation laser.

FIG. 13 shows model systems of 11 types of defects in dBN are shown: (a) V_{N}, (b) V_{N}—OH, (c) V_{BN}, (d) V_{3N3B}, (e) V_{3N4B}, (f) V_{6N2B}, (g) V_{6N3B}, and (h) V_{6N3B-}3O, (i) V_{6N3B}—OH, (j) V_{6N3B}-2OH, and (k) V_{6N3B}-3OH. The structures were computed by periodic DFT.

FIG. 14 shows the electron spin densities are shown for various dBN in a unit cell: (a) V_{N}, (b) V_{N}—OH, (c) V_{BN}, (d) V_{3N3B}, (c) V_{3N4B}, (f) V_{6N2B}, (g) V_{6N3B}, and (h) V_{6N3B}-3Ocomputed by DFT. The yellow color represents the up-spin electrons (i.e. α electrons) and blue down-spin electrons (i.e. β electrons).

FIGS. 15A, 15B, 15C, 15D, and 15E show a characterization of 9, 90 and 150BN reducing (FIG. 15A) Ag, (FIG. 15B) Pt, (FIG. 15C) Au, (FIG. 15D) Cu and (15E) Fe. The photographs show the 9, 90 and 150BN samples after reaction at room temperature with (FIG. 15A) 0.001 M AgNO₃, (FIG. 15B) 0.001 M PtCl₄, (FIG. 15C) 0.01 M HAuCl₄ (FIG. 15D) 0.01 M CuSO₄, (FIG. 15E) 0.01 M FeCl₃ aqueous solution, respectively. UV-Vis spectra of the supernatant after d-BN (9, 90, and 150BN) reacts with (FIG. 15B) PtCl₄, (FIG. 15C) HAuCl₄ (FIG. 15D) CuSO₄, and (FIG. 15E) FeCl₃ aqueous solution. The reduction is visually evident by observing more discoloration for 150BN when compared to 9BN.

FIG. 16 shows XRD of the dried resultants from 500 mg d-BN (9, 18, 27, 45, 90, 120, 150, and 900 min) after the reaction with 10 ml 0.001 M AgNO₃ aqueous solution at room temperature.

FIG. 17A shows the Fourier transformed R-space and FIG. 17B shows Pt L3-edge XANES spectra of 90BN—Pt, 90BN—Ag₁Pt₁, Pt foil and PtO₂ from EXAFS.

FIGS. 18A, 18B, 18C, 18D, 18E, and 18F show XPS survey spectra measured for (FIG. 18A) 90BN—Ag, (FIG. 18B) 90BN—Pt, (FIG. 18C) 90BN-Fe, (FIG. 18D) 90BN—Cu, and (FIG. 18E) 90BN—Au. FIG. 18F shows the summary of the metal content based on the XPS results.

FIGS. 19A, 19B, 19C, 19D, and 19E show electrochemical active surface area (ECSA) measurements using cyclic voltammetry (CV) scans at different scan rates (10 mV s⁻¹, 20 mV s⁻¹, 30 mV s⁻¹, 40 mV s⁻¹, 50 mV s⁻¹, 60 mV s⁻¹, 70 mV s⁻¹, 80 mV s⁻¹, 90 mV s⁻¹, 100 mV s⁻¹); CV scans of (FIG. 19A) 90BN—Pt, (FIG. 19B) 90BN—Ag₂Pt₁, (FIG. 19C) 90BN—Ag₁Pt₁, and (FIG. 19D) 90BN-Ag₁Pt₂; (FIG. 19E) the average of the absolute values of cathodic and anodic current collected at 0.16 V (vs. RHE) as the function of the scan rate, and the slope of the linear fitted line is used to calculate the double-layer capacitance. FIG. 19F shows EIS curves of the 90BN with Pt, Ag₂Pt₁, Ag₁Pt₁, and Ag₁Pt₂ as the working electrodes in 0.5 M H₂SO₄.

FIG. 20A shows the amperometric I-t stability curve at a constant overpotential of 55 m V for 50 h. FIG. 20B shows a STEM image of 90BN—Ag₁Pt₁ after the amperometric stability test.

FIGS. 21A and 21B show XPS spectra of 90BN—Pt, Ag₁Pt₂, Ag Pt₁, and Ag₂Pt₁ in the (FIG. 21A) Pt 4f region; (FIG. 21B) Ag 3d region.

FIG. 22 shows DFT calculations, illustrating the optimized structures, band structure, and DOS for d-BN: Pt. The DOS also shows the subshells contributions.

FIGS. 23A and 23 B show DFT calculations. FIG. 23A shows the optimized d-BN: Ag₁Pt₁ structure, band structure, and total and partial DOS. FIG. 23 B shows the mechanism for HER in d-BN: Ag₁Pt₁: (i) cluster adsorption; (ii) H⁺ adsorption, and (iii) H₂ formation. The reactions pathways are performed in an implicit solvation model for H₂SO₄.

FIG. 24 shows (a) the equilibrium structures of the d-BN: Ag₂Pt₂, (b) its band structure and total DOS along with s-subshells contribution from Ag atoms and d-subshells contributions from the Pt atom, (c) the equilibrium structures of the d-BN: AgPt bonded with O, and (d) its band structure and total DOS along with s-subshells contribution from Ag atoms and d-subshells contributions from the Pt atom.

FIG. 25 shows molecular cluster model system to investigate the HER; (i) Pt adsorption; (ii) H⁺ adsorption; and (iii) H₂ formation. The reaction pathways are computed in acidic solvent phase using PCM model with a dielectric constant of 21.90 for H₂SO₄. The highly exothermic values are because the values for the cohesive energy of the metals are not included in the calculations.

FIG. 26 shows the mechanism for HER in d-BN: Ag₂Pt₂: (i) cluster adsorption; (ii) H⁺ adsorption, and (iii) H₂ formation. The reaction pathways are in solvent phase (H₂SO₄). The highly exothermic values are because the values for the cohesive energy of the metals are not included in the calculations.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

Embodiments can relate to a defect engineered hexagonal boron nitride (hBN) based battery anode derived through an efficient cryo-milling strategy. Examples and test results presented herein demonstrate the development of a fire safe and defective hBN anode exhibiting high specific capacity (880 mAh g−1 @ 25 mA g−1), rate performance (480 mAh g⁻¹ @5 A g⁻¹), and long cycle-life (5000 cycles) when operating at 60° C. Li-ion fuel cell composed of hBN anode and LiNiMnCoO₂ cathode delivered significantly higher energy (400 Wh kg⁻¹) and power density (1 kW kg⁻¹) compared to graphite/LiNiMnCoO₂ fuel cell (121 Wh kg⁻¹ and 250 W kg⁻¹ respectively). The strategy of defect-induced electrochemical activation disclosed here opens up an avenue for the designing of high-performance electrode materials for numerous secondary batteries and other fuel cells.

Compared with the prior art, embodiments of the present invention can have the following beneficial effects: (1) The Li-ion storage mechanism in this case is entirely different from F-ion batteries and conventional Li-ion batteries. Excellent Li-ion storage performance of defect engineered BN is credited to the diffusion independent pseudocapacitive surface Li-ion storage driven by nitrogen antisite (N_{B}V_{N}) defects without phase change. (2) The specific capacities achieved are comparable to the conversion type anodes, and cycling stabilities are much superior to conversion/alloying type electrode materials. (3) The inherent thermal stability of hBN results in the stable high temperature (60° C.) operation of the Li-ion secondary battery. (4) The fire safety of the defective hBN anodes is considerably better than the conventional graphite anodes. As a result, this defect driven Li-ion storage technique has the potential to revolutionize rechargeable electrochemical energy storage industry. Embodiments used for developing electrodes is applicable to all fuel cells including, batteries, capacitors, hybrid battery-capacitor devices, all solid-state devices, etc.

Embodiments can relate to an electrode. The electrode can include an electrically conductive member including a microstructure layer. The entire electrically conductive member can be electrically conductive, a portion of the electrically conductive member can be electrically conductive, a surface (entire surface or a portion thereof) of the electrically conductive member can be electrically conductive, etc. The microstructure layer can be a portion of the electrically conductive member, a coating on a surface (entire surface or a portion thereof) of the electrically conductive member, a deposition on a surface (entire surface or a portion thereof) of the electrically conductive member, etc. having a microstructure that can be engineered to provide a desired physical or chemical property (e.g., electrical conductance, corrosion resistance, strength, ductility, etc.). The microstructure can be a homostructure, heterostructure, etc. There can be one or more microstructures. The microstructures can be layered on top of each other, adjacent each other, configured as a pattern on the electrically conductive member, etc. The microstructure can include a chemistry, a crystalline structure, amorphous structure, semi-amorphous structure, a defect, crystalline grains, a thickness, etc. Any one microstructure can be the same or different from another microstructure. It is contemplated for the microstructure layer to include boron nitride (BN). For instance, the microstructure layer can be hexagonal (hBN), hBN platelets, hBN nanotubes, cubic BN, BN nanostructures, amorphous BN, non-stoichiometric BN, BaXbYcNd (X, Y═H, C, O, P, Si), etc. In an exemplary embodiment, the microstructure layer can include BN having a surface defect configured to provide a diffusion independent pseudocapacitive ion storage mechanism. This independent pseudocapacitive ion storage mechanism can provide desired benefits, and in particular beneficial material properties for electrodes used in a fuel cell battery. While embodiments describe use of the electrode for a fuel cell, the electrode can be used for a battery device, a capacitor device, a hybrid battery-capacitor device, a solid-state device, etc. The ion storage mechanism can be for Li ions, Na ions, K ions, Ca ions, Zn ions, Al ions, Mg ions, etc., and thus the electrode can be for a Li-ion fuel cell battery, a Na-ion fuel cell battery, a K-ion fuel cell battery, a Ca-ion fuel cell battery, a Zn-ion fuel cell battery, an Al-ion fuel cell battery, a Mg-ion fuel cell battery, etc. For instance, embodiments of the electrode can be used as an anode in a Li-ion fuel cell battery, and the BN microstructure layer having the surface defect(s) can provide a diffusion independent pseudocapacitive Li-ion storage mechanism for the battery. As will be demonstrated herein, embodiments of the electrode can be used for a thermally stable secondary fuel cell that is operable within a range from −30° C. to 100° C. In some embodiments, the cycle-life of the fuel cell can be equal to or greater than 500 cycles, the energy density can be equal to or greater than 400 Wh kg⁻¹; and/or the power density can be equal to or greater than 1 kW kg⁻¹.

Another benefit is the electrode, or at least portions of the electrically conductive member having the microstructure layer, can be fire retardant, fire resistance, or fireproof.

It is understood that the microstructure layer can include plural surface defects. At least one surface defect of the plural surface defects can be configured to provide the pseudocapacitive ion storage mechanism. It is further understood that at least one surface defect can be a type of defect that differs from a type of defect for at least one other surface defect. The type of defects can include a vacancy defect, a Stone-Wales defect, an oxygenated defect, a hydroxylized defect, a substitutional defect, etc. Other defects can include formation of edge defects, functional groups, reactive surfaces, etc. The functional groups can be oxygen functional groups (e.g., OH groups), amino groups, etc. A particularly beneficial defect is a nitrogen vacancy defect. The reasons for this will be explained in more detail later.

As can be appreciated, the pseudocapacitive ion storage mechanism is generated via defect engineering BN of the microstructure layer. Thus, embodiments can relate to a method for defect engineering BN. The method can involve forming reactive BN (RBN) by breaking B—N bonds, and then subsequent activation of the RBN. Breaking of B—N bonds can exfoliate the BN and generate one or more defects in the BN. Defect formation in BN can facilitate formation of chemical bonds between B and high electronegativity elements (e.g., O and F) via the subsequent activation step—i.e., it can facilitate formation of B—O and B—F bonds. Forming RBN can involve cryo-milling, ball-milling, sonication, focused ion/electron beam irradiation, detonation, chemical treatment, thermal treatment in limited oxygen, etc.

Activation of the RBN can involve chemical activation and/or electrochemical activation, which can include electrochemical cyclic voltammetry, galvanostatic cycling, potentiostatic cycling, chemical reactions to create F and form metal fluoride bonds, etc. In some embodiments, the activation can involve cycling the RBN using a F-ion supporting electrolyte. The cycling can occur under high current density. The activation can involve cycling an electrochemical cell comprising: an anode comprising a microstructure layer of RBN (e.g., vacancy-rich BN can be mixed with carbon black and polyvinylidene fluoride (PVDF) to form an anode); a cathode or counter electrode comprising a metal (e.g., Li metal); and electrolyte (e.g., LiPF₆-EC/EMC) containing ion salts of the metal and F. Anions in the electrolyte can include PF6, TFSI, F, etc. This can create F-ions, which form metal-F bonds with the F-ions. The type of metal-F bonds will depend on the type of cathode electrode used during the cycling process. For instance, if the cathode electrode is a Li electrode, the metal-F bons will be LiF bonds. The activation can decompose the electrolyte to reversably store metal ions (e.g., Li ions) through metal ion-F bond formation. For instance, the activation can decompose metal salts containing F ions to free metal and F ions for reversable metal fluoride reactions. For example, for a Li-ion electrochemical cell system, LiPF₆ can be decomposed to free Li- and F-ions for reversible LiF reactions. More specifically, the LiPF₆ in the electrolyte can be decomposed into HF which ca be catalyzed by oxygen functional groups (e.g., OH) on the BN. F-ions from the HF can be absorbed on the BN surface so that F-ions bond to Li to form LiF (cubic phase). As the activation continues, Li—F bonds break so that the F-ions are absorbed to the BN surface.

The reversable storage of metal (e.g., Li) ions is on the BN surface, and in particular in the nitrogen vacancy defects generated via the inventive method. The defects generated in the microstructure layer can provide charge transfer resistance and/or superior contact with electrolyte, which results in the pseudocapacitive ion storage mechanism. It should be noted that the ion storage mechanism is a non-intercalation ion storage mechanism based on reversible metal-F formation which is catalyzed on the RBN surface.

### Examples

The following describes exemplary materials, electrodes, and experimental test results based on embodiments of the inventive methods disclosed herein.

A defect engineered hexagonal boron nitride (hBN) derived through an efficient cryo-milling strategy is demonstrated via the following examples. An exemplary fire safe and defective hBN anode exhibited high specific capacity (880 mAh g⁻¹ @ 25 mA g⁻¹), rate performance (480 mAh g⁻¹ @5 A g⁻¹) and long cycle-life (5000 cycles) when operating at 60° C. Li-ion fuel cell composed of hBN anode and LiNiMnCoO₂ cathode delivered significantly higher energy (400 Wh kg⁻¹) and power density (1 kW kg⁻¹) compared to graphite/LiNiMnCoO₂ fuel cell (121 Wh kg⁻¹ and 250 W kg⁻¹ respectively). In-situ and ex-situ spectroscopic/microscopic studies verified defect-driven pseudocapacitive type Li-ion storage through reversible LiF formation without the phase change of hBN. First-principles calculations confirmed that a nitrogen antisite (N_{B}V_{N}) defect is responsible for the electrochemical activation of otherwise inactive hBN. The strategy of defect-induced electrochemical activation presented here opens up an avenue for the designing of high-performance electrode materials for numerous secondary batteries.

As noted herein, rechargeable batteries are one of the most important energy storage devices for portable electronics, medical applications, electric vehicles and power grids. Additionally, secondary Li-ion batteries have attracted tremendous interest due to their high energy density, good cycle-life and superior efficiency when compared to Pb-acid, Ni-MH and Ni—Cd batteries. However, the energy (100-300 Wh kg⁻¹) and power density (250-400 W kg⁻¹) of the current generation in Li-ion batteries are inadequate for several applications including long-range electric vehicles. One of the main reasons for this is the use of graphite anodes possessing low specific capacity (<372 mAh g⁻¹) and sluggish Li-ion diffusion kinetics. The use of graphite anodes and flammable carbonaceous electrolyte solutions can seriously compromise the safety of Li-ion batteries. These drawbacks of graphite anodes triggered extensive research on high capacity anodes based on conversion (SnO₂, Fc₂O₃, Co₃O₄, CoO, NiO, MnO₂, MoO₃, WO₃, etc.) and alloying (Si, Ge, Sn, etc.) reactions. However, these conversion and alloying type electrodes experience severe capacity fading on extended cycling due to extreme volume changes related to variations in the crystal structure of the host material.

Batteries based on F-ion electrochemistry are now attracting interest due to their high energy density, wide potential window and superior electrochemical stability. Therefore, they become a clear alternative to solid state Li-ion technologies. One of the most investigated fluoride ion batteries (FIBs) consists of Li-metal anode and CFₓ cathode. Despite their numerous advantages, the non-rechargeable nature of this system limits its real-world applications. Another class of FIBs consist of Li-metal anode and metal fluoride cathodes (FcF₂, CuF₂, SnF₂, BiF₃, SnF₂ etc.). Nevertheless, rechargeable batteries based on fluoride-ions reported to date suffer from poor cycling performance. F-ion based electrochemistry also plays a key role in modern rechargeable Li-ion batteries. For example, LiF forms as a major solid electrolyte interface (SEI) which facilitates stable cycling of intercalation electrodes. Fluoride-ions are also unavoidable components of non-aqueous electrolyte solutions used in the current generation of Li-ion batteries.

It is noteworthy that Li-ion battery electrodes with layered microstructure such as few layer graphene received immense interest due to their unique physiochemical properties. Hexagonal boron nitride (hBN), also a layered material is widely used in the area of microelectronics. The chemical/electrochemical stability, layered structure and flame retardant nature of hBN are highly beneficial for its application as Li-ion battery electrodes. However, its electrochemical performance is limited due to its chemical inertness, sluggish electron/ion transport, and narrow interlayer spacing, which restricts Li-ion intercalation. Although different strategies such as functionalization, hybrid formation of BN with carbonaceous materials have been investigated, the development of high performance and fire-safe Li-ion batteries based on BN anodes remains a challenge.

Pseudocapacitive transition metal oxide electrodes (TiO₂, V₂O₅, Nb₂O₅, TiNb₂O₇ and Li₄TisO₁₂ etc.) were recently investigated for ultrafast Li-ion storage. However, specific capacity of these anodes are not sufficient (<200 mAh g⁻¹) for the realization of high-energy density Li-ion batteries. Pseudocapacitance is nominal in the case of conversion type transition metal oxide anodes. While pseudocapacitance can be induced (extrinsic pseudocapacitance) by nanostructuring, this method remains elusive in the case of hBN-based anodes. The main reason is that the sluggish Li-ion diffusion does not satisfy the requirement of pseudocapacitive Li-ion storage. An electrode microstructure facilitating high electronic and ionic conductivity is crucial to induce acceptable pseudocapacitive type Li-ion storage.

Exemplary embodiments disclosed herein demonstrate a high energy (400 Wh kg⁻¹) and power density (1 kW kg⁻¹) secondary Li-ion battery based on extremely pseudocapacitive defect engineered hBN anodes. This is achieved through cryo-milling of BN powder followed by its electrochemical activation under high current density. The pseudocapacitive type Li-ion storage mechanism in this case involves reversible formation of LiF on BN surface facilitated by the presence of nitrogen vacancies. The Li-ion storage mechanism in this case is entirely different from F-ion batteries and conventional Li-ion batteries. Excellent Li-ion storage performance of defect engineered BN can be credited to the diffusion independent pseudocapacitive surface Li-ion storage driven by nitrogen antisite (N_{B}V_{N}) defects without phase change. Specific capacities achieved in this case are comparable to the conversion type anodes and cycling stabilities are much superior to conversion/alloying type electrode materials. Inherent thermal stability of hBN also resulted in the stable high temperature (60° C.) operation of the Li-ion secondary battery. Fire safety of the defective hBN anodes is considerably better than the conventional graphite anodes. The demonstrated strategy of defect driven Li-ion storage has the potential to revolutionize rechargeable battery industry.

### Activation of hBN

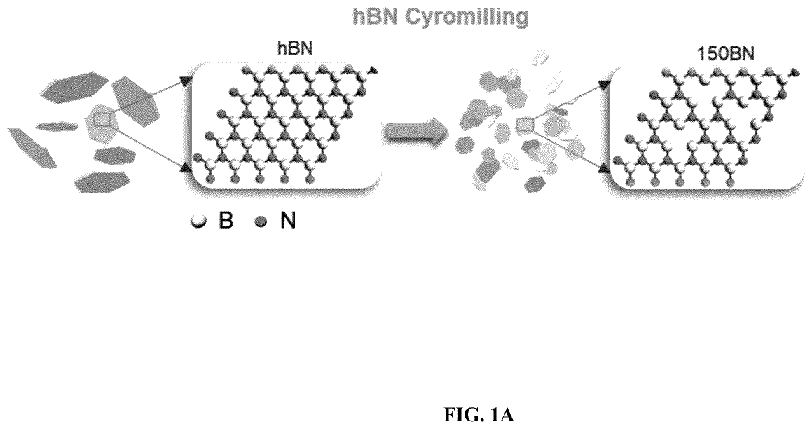

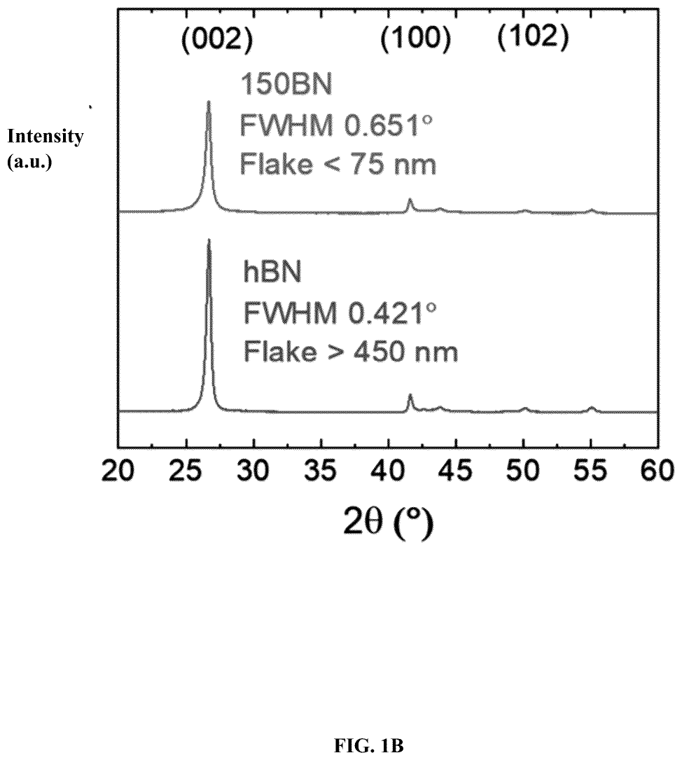

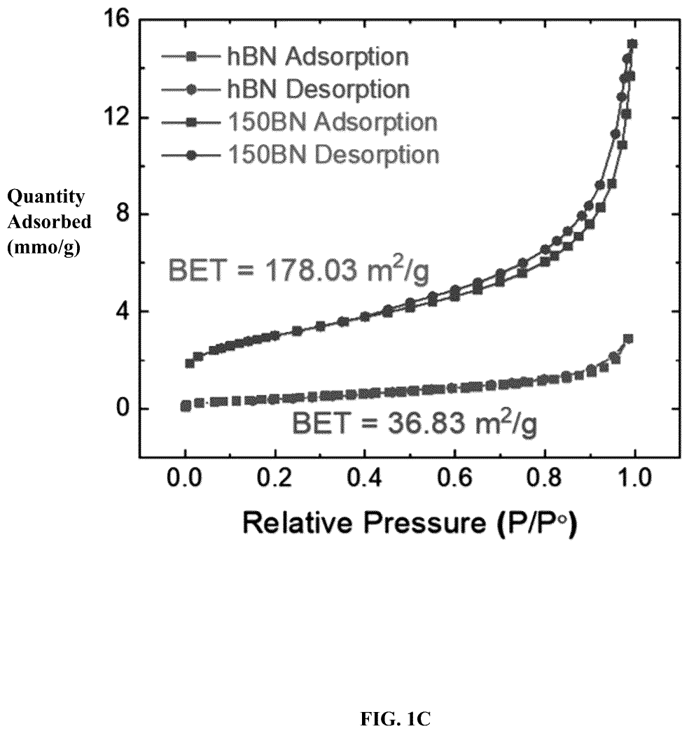

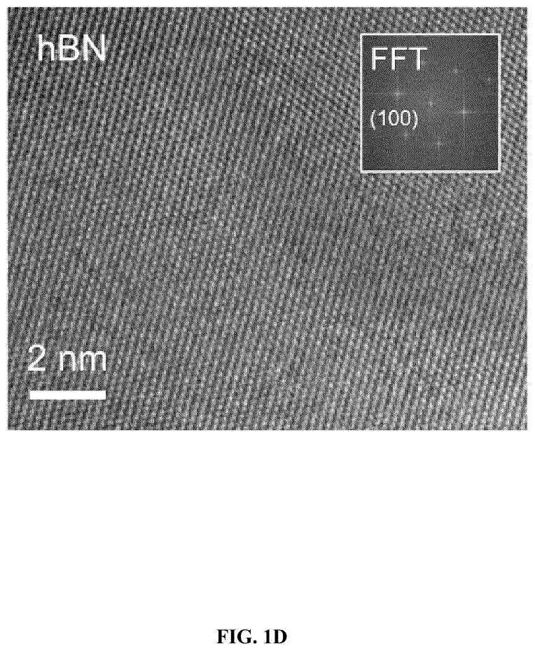

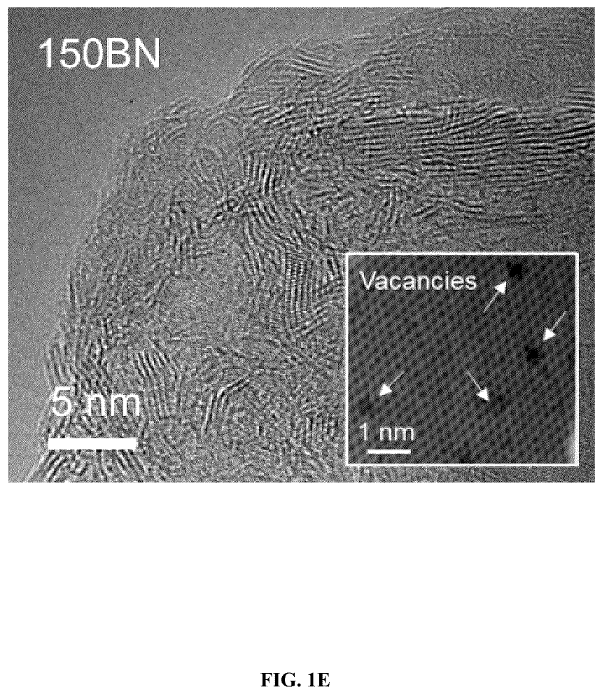

FIGS. 1A, 1B, 1C, 1D, and 1E show an exemplary formation of defective boron nitride (150BN) via cryo-milling. FIG. 1A shows a schematic formation of 150BN via cryo-milling; FIG. 1B shows XRD spectra of 150BN and hBN; FIG. 1C shows N2 adsorption-desorption isotherms of 150BN and hBN at 70 K; FIG. 1D shows selected HRTEM image of hBN and its FFT pattern (inset); FIG. 1E shows selected HRTEM image of 150BN and the STEM image with atomic vacancies.

To induce defects in hBN, pristine hBN powder was cryo-milled in liquid N₂ (77 K) for 150 min (150BN, FIG. 1A). Due to the pulverization at 77 K, vacancies and other defects are generated as the (002) reflection of hBN is broadened with an increasing full width half maximum (FWHM). The cryo-milling and the resulting shearing force also exfoliates hBN and generates defects. As shown in FIG. 1B, the N₂ adsorption isotherms of 150BN are classified as type II, corresponding to a microporous solid (similar to exfoliated graphite). As a result, the Brunauer-Emmer-Teller (BET) surface area increases from 36.8 m² g⁻¹ in hBN to 178.0 m² g⁻¹ in 150BN, and the total pore volume expands from 100.0 mm³ g⁻¹ in pristine hBN to 412.1 mm³ g⁻¹ in 150BN

(FIG. 1C). The atomic structure of hBN and 150BN was further studied by high-resolution transmission electron microscopy (HRTEM, FIGS. 1D and 1E)). The fast Fourier transform (FFT) obtained from pristine hBN (FIG. 1D and the inset) reveals one group of distinct hexagonal symmetric spots, confirming the high degree of crystallinity of pristine hBN. In contrast, for 150BN, large number of disordered planes is observed in FIG. 1E, and the scanning transmission electron microscopy (STEM) images reveal the formation of atomic vacancies in 150BN. Apart from metal sub-nanoparticle reduction, the vacancy-induced reactivity can also be utilized for Li-ion storage.

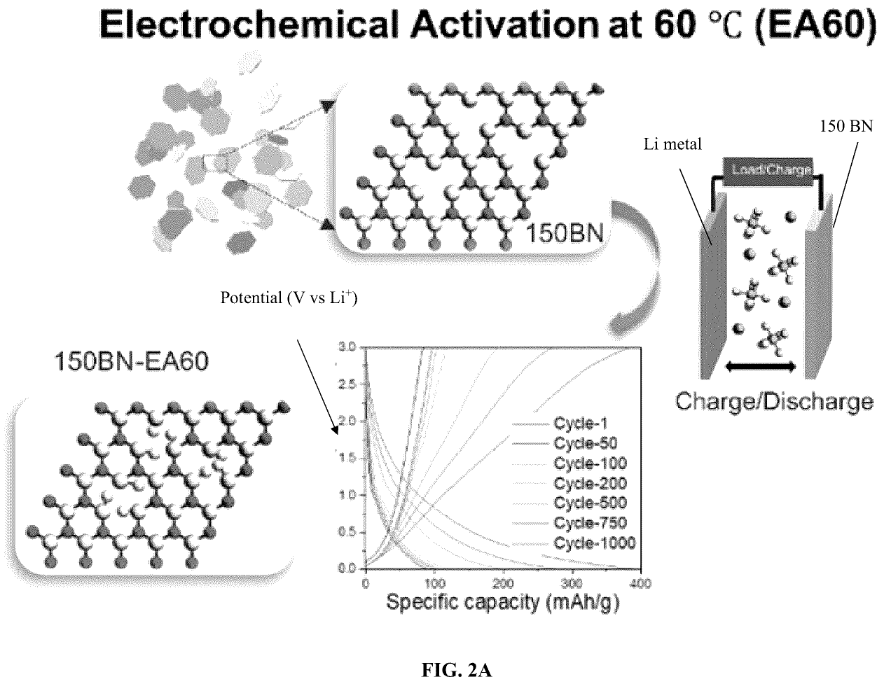

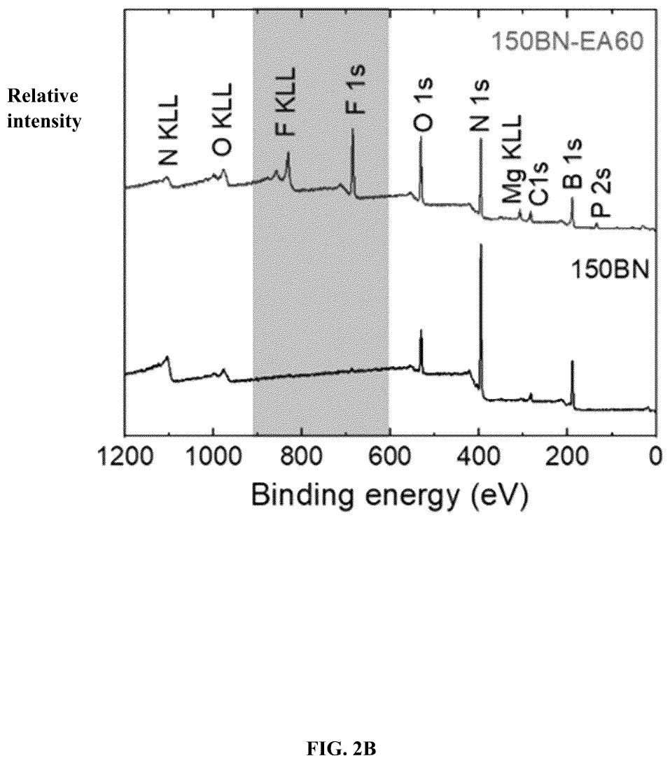

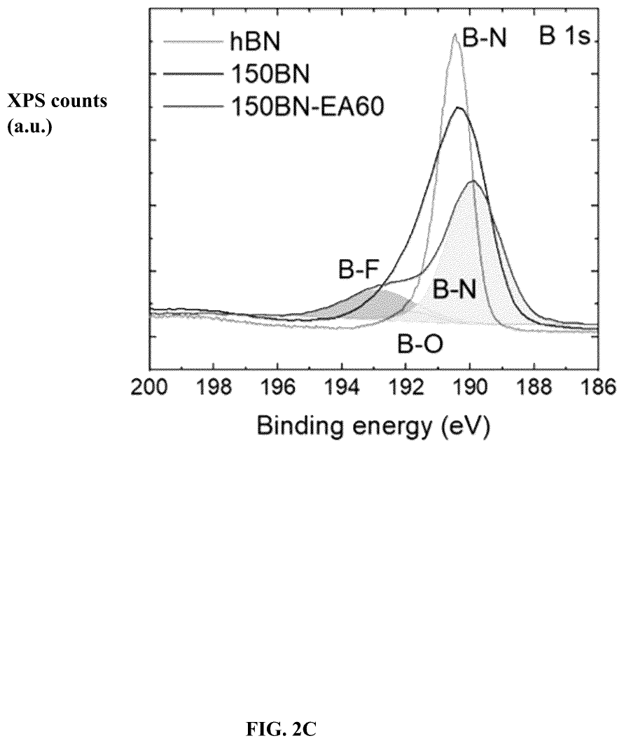

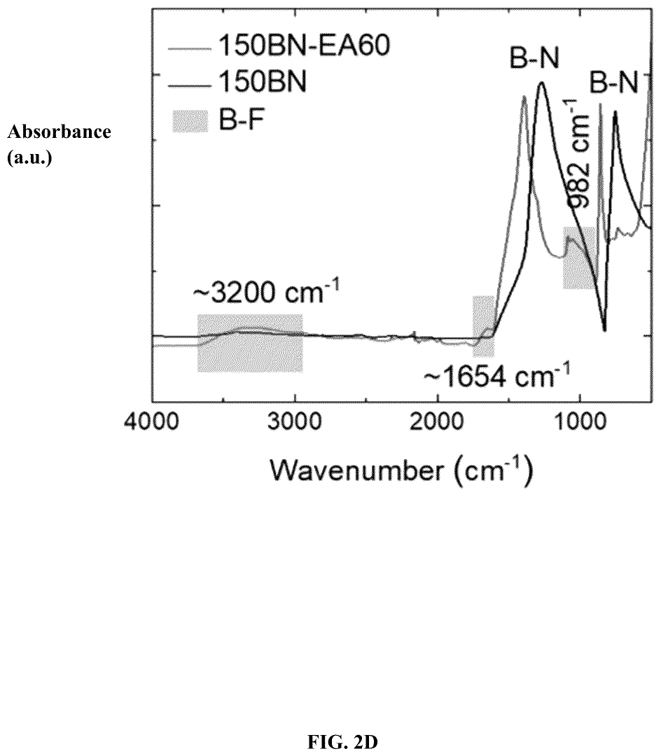

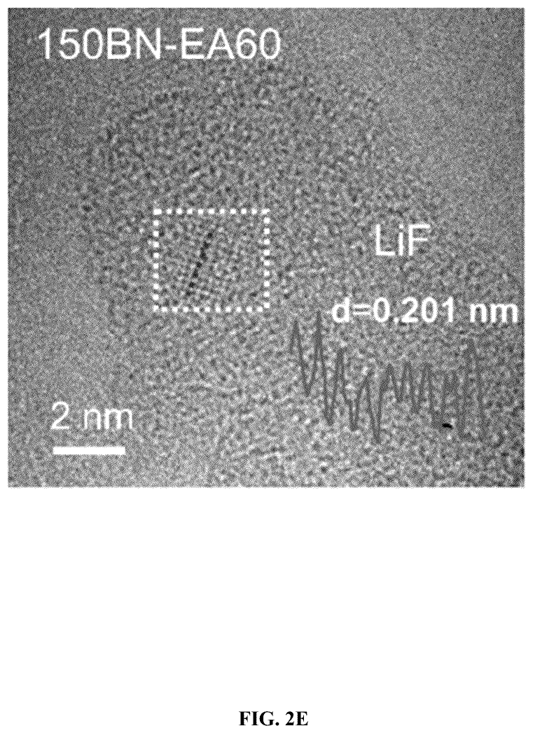

FIGS. 2A, 2B, 2C, 2D, and 2E show formation and characterizations of 150BN-EA60. FIG. 2A shows a schematic illustration of the electrochemical activation at 60° C. (EA60) process to form 150BN-EA60; FIG. 2B shows XPS survey spectra of 150BN and 150BN-EA60; FIG. 2C shows XPS B Is spectra of hBN, 150BN, and 150BN-EA60; FIG. 2D shows FTIR spectra of 150BN and 150BN-EA60; FIG. 2E shows selected HRTEM image of 150BN-EA60 and the intensity profile of the LiF (111) plane. As seen in FIG. 2A, the vacancy-rich 150BN was mixed with carbon black and polyvinylidene fluoride (PVDF), and then assembled in a Li-ion half-cell with Li metal as the counter electrode and LiPF₆-EC/EMC as the electrolyte. Upon charging-discharging at different current densities (25 to 1000 mA g⁻¹), the highest capacity of 150BN is only ˜120 mAh g⁻¹ when the cell is charged/discharged at 25 mA g⁻¹. Pristine hBN and BN that was cryomilled for 45 min and 300 min (45BN and 300BN) exhibited even poorer performance. However, when the cells were cycled at 1 A g⁻¹, instead of the capacity fading, a gradual increase in the capacity was noticed as the cell was cycling, and the capacity reached ˜225 mAh g⁻¹ at the 3000th cycle for 150BN, which behaved as the electrochemical activation (EA). On the contrary, the capacity enhancement of hBN is not as significant as that of 150BN. After the EA process (denoted as 150BN-EA30), the half-cell can deliver stable and higher capacities when compared to those before EA process (150BN), and even overperforming when comparing to conventional mesocarbon microbead (MCMB) anodes. The EA process was apparently accelerated at 2 A g⁻¹ and 60° C. (denoted as 150BN-EA60). As seen in FIG. 2A, when the cell is cycled 200^{th} cycles, the capacity is almost doubled, and even reached to ˜400 mAh g⁻¹ at the 1000th cycle when the EA process is at 2 A g⁻¹ and 60° C.

To further understand the mechanism behind the capacity increase, the 150BN-EA60 electrode was removed from the cell and washed with acetonitrile to remove the absorbed salts and electrolyte. The X-ray photoelectron spectroscopy (XPS) spectra shown in FIG. 2B indicates that extra F-ions are bonded to the surface of the washed post-cycle 150BN-EA60 electrode when compared to that of pre-cycle 150BN surface. The XPS B1s spectra further reveals the surface chemistry change after cryo-milling and the EA process. As seen in FIG. 2B, before the treatment, hBN exhibits a sharp peak at 190.5 eV, corresponding to the B—N bonds. After cryo-milling, the XPS B1s spectra of 150BN is clearly broadened and shifted due to the as-produced vacancies and oxygen functional groups. The peak is further broadened and forms a side peak at higher bonding energy in 150BN-EA60, indicating the formation of new chemical bonds with high electronegativity elements, such as O and F. The deconvoluted XPS spectra in FIG. 2B indeed confirms the formation of B—F bonds at 192.9 eV²² in 150BN-EA60, as well as B—O bonds at 191.7 eV. Moreover, the formation of B—F bonds on the surface of 150BN-EA60 is demonstrated by Fourier transform infrared spectroscopy (FTIR), as the emergence of B—F bonds at ˜3200 cm⁻¹ and ˜982 cm⁻¹. Other than the B—F bonded F ions, F-ions are also found to be bonded to Li to form LiF (cubic phase), as revealed by HRTEM (FIG. 2C).

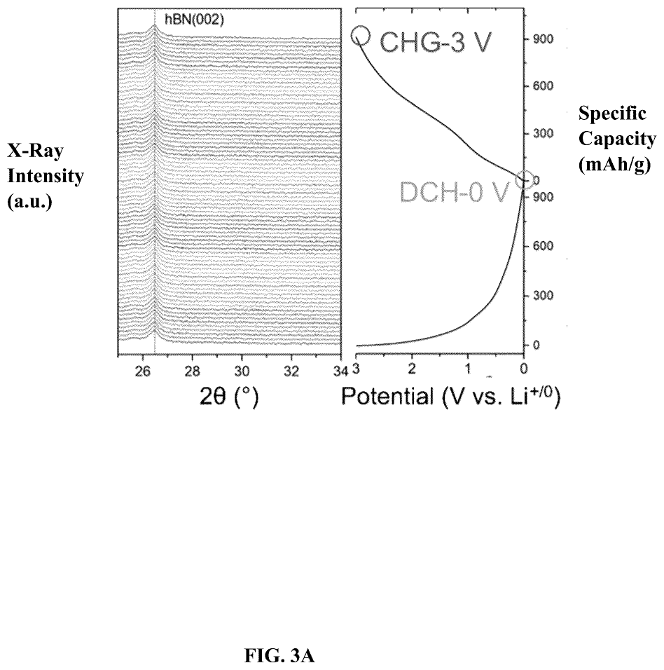

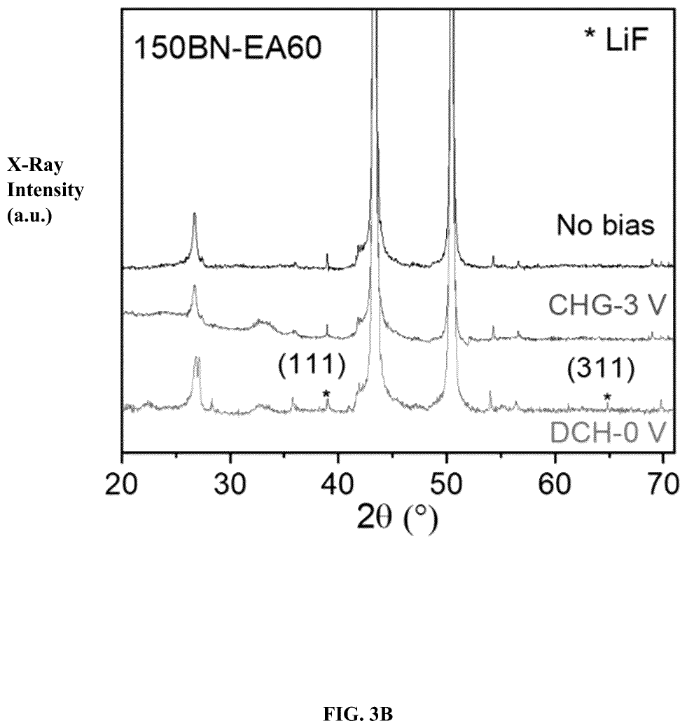

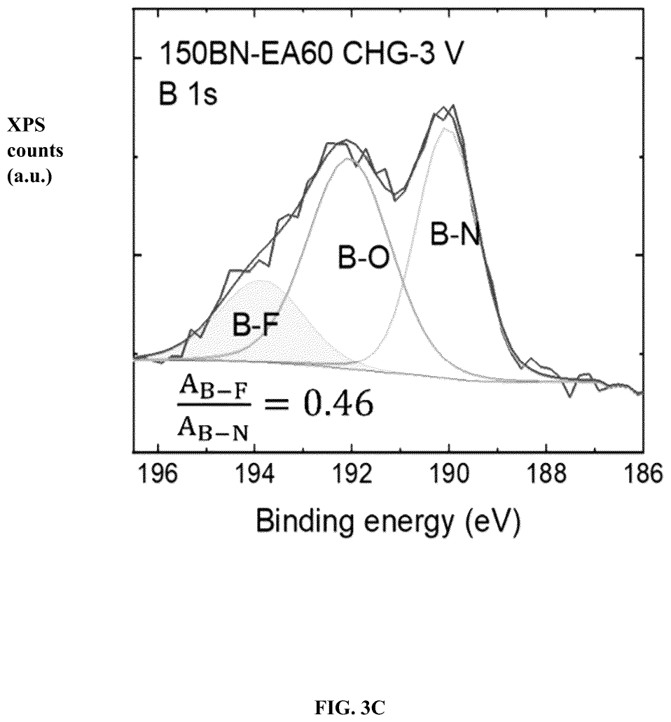

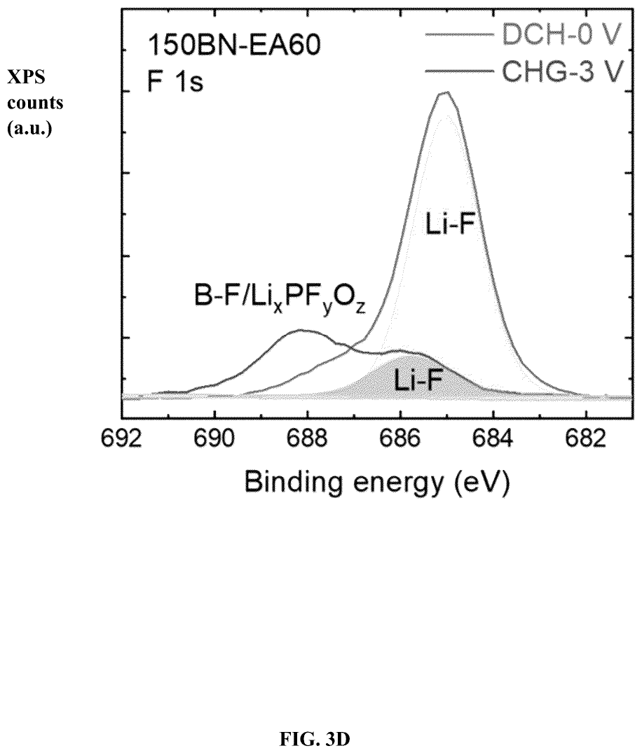

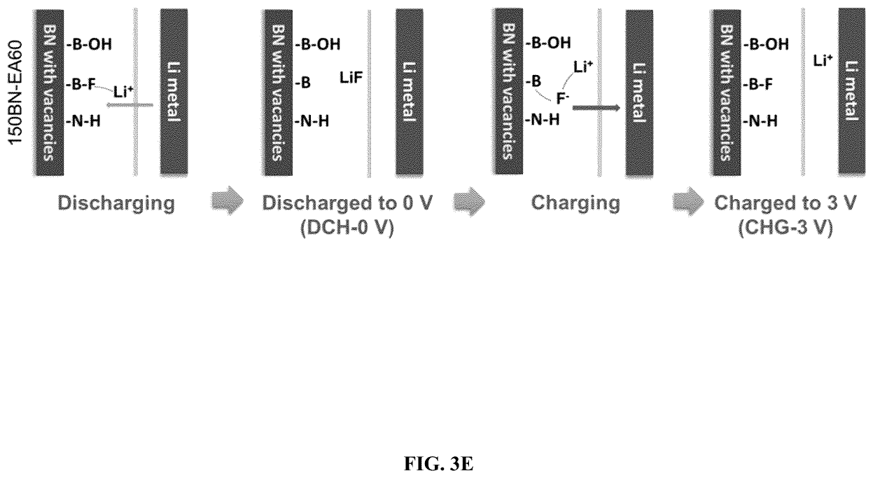

FIGS. 3A, 3B, 3C, 3D, and 3E show in situ and ex situ characterizations of 150BN-EA60 at the charged (CHG-3 V) and discharged (DCH-0 V) states. FIG. 3A shows in situ XRD of 150BN-EA60 electrode in Li-ion half-cell; FIG. 3B shows XRD spectra from a at different conditions: no bia, CHG-3 V and DCH-0 V; FIG. 3C shows XPS B 1s profile of 150BN-EA60 at CHG-3 V; FIG. 3D shows XPS F Is profile of 150BN-EA60 at DCH-0 V and CHG-3 V; FIG. 3E shows a schematic of the storage mechanism. The characterization of the post-cycle 150BN-EA60 electrode implies that F-ions are bonded to the surface by B—F and Li—F bonds. However, the Li-ion storage mechanism is still unclear. Since hBN is a layered material similar as graphite, in-situ XRD was used to probe whether Li ions are intercalated among the hBN layers as graphite. However, the (002) peak of hBN remains the same upon charging/discharging, as seen in FIG. 3A, indicating that Li-ions are not stored through intercalation like in graphite. By extracting the XRD spectra at CHG-3 V (charged to 3 V) and DCH-0 V (discharged to 0 V), the LiF (111) and (311) peaks emerge in DCH-0 V XRD spectra, but not in that of CHG-3 V (FIG. 3B). The LiF formation is consistent with TEM results (FIG. 2C), but further studies indicate that LiF is only formed when the cell is discharged (DCH-0 V). The reaction pathway of LiF formation was also confirmed by ex-situ XPS shown in FIG. 2D. The 150BN-EA60 electrodes at the DCH-0 V and CHG-3 V condition were taken out from the cell and washed with acetonitrile before transferring to the XPS inert transfer vessel for ex situ XPS measurements. Similar to FIGS. 2B-2C, F-ions are detected in the form of B—F and Li—F bonds. Ex-situ B 1s XPS of the 150BN-EA60 surface at the DCH-0 V and CHG-3 V (FIG. 3C) implies that B—F bonds are mainly formed at the CHG-3 V state, as the concentration ratio of B—F bonds vs. B—N bonds increased from 0.29 in DCH-0 V state to 0.46 in CHG-3 V state. On the contrary, when the cell is discharged (DCH-0 V), Li—F bonds are mainly formed, as seen in the F 1s XPS spectra (FIG. 3D) showing the Li—F peak at ˜684.8 eV emerged at DCH-0 V. This indicates that the Li storage mechanism on 150BN is related to B—F and Li—F bond formation.

The EA process is needed to activate the 150BN surface. As seen in FIG. 2A, during the EA process (cycling), LiPF₆ in the electrolyte is decomposed into HF which is catalyzed by OH groups on 150BN. After the EA process, F ions from HF are absorbed on 150BN-EA60 surface as seen in FIG. 2A. When the 150BN-EA60//Li cell is discharged, Li ions move from Li metal to 150BN-EA60, and form into LiF (FIG. 3E). As the cell is discharged to 0 V (DCH-0 V), a significant amount of LiF is formed which is confirmed by in-situ XRD (FIG. 3B) and XPS (FIG. 3D). When the cell is charged, Li—F bonds break, and the F-ions are further absorbed to the 150BN-EA60 surface. Then, F-zons are bonded to the dangling B on the surface to form B—F bonds at CHG-3 V, which is also confirmed by XPS (FIG. 3C). To further confirm the necessity of F-ions in the electrolyte, other salts, including LiCIO₄, LINO₃, LITSFI, were also used in the electrolyte. The EA process can only be triggered in electrolyte containing LiPF₆. Thus, the Li-ion storage mechanism is based on B—F/Li—F bond formation on the BN surface and edges.

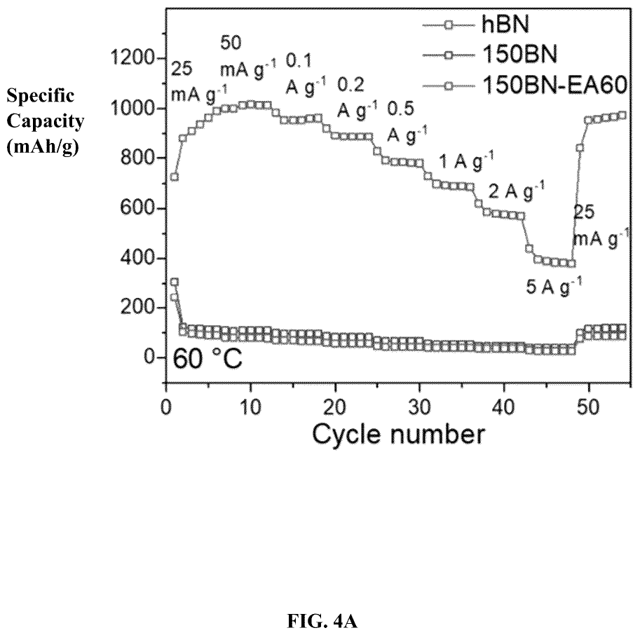

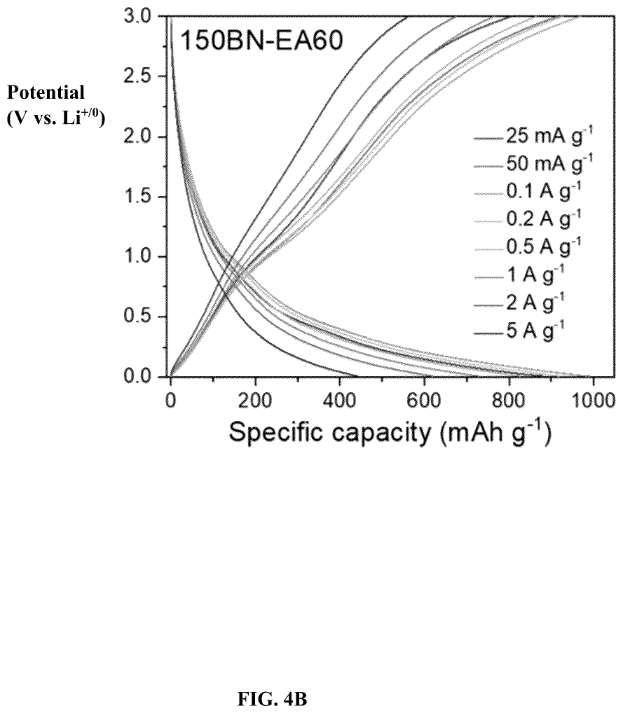

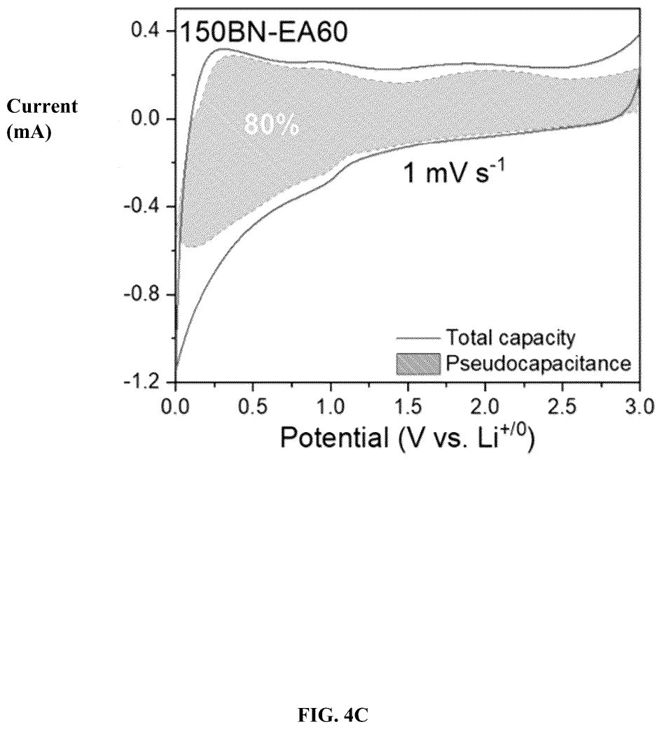

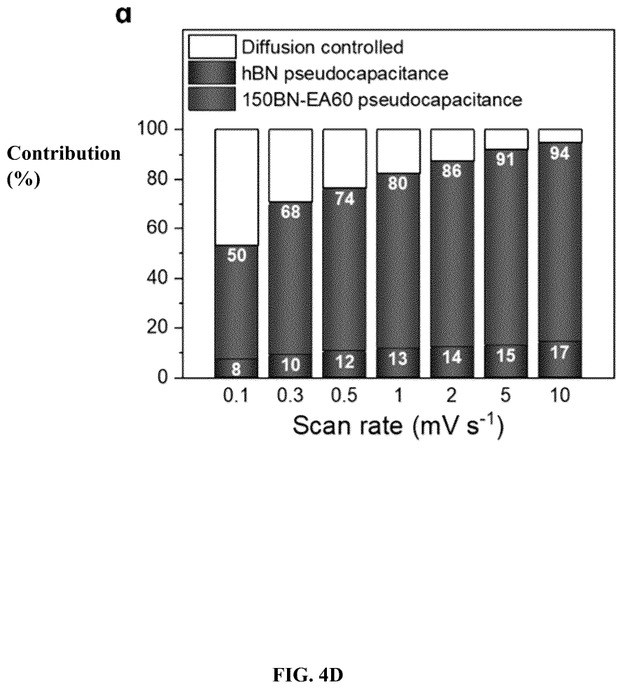

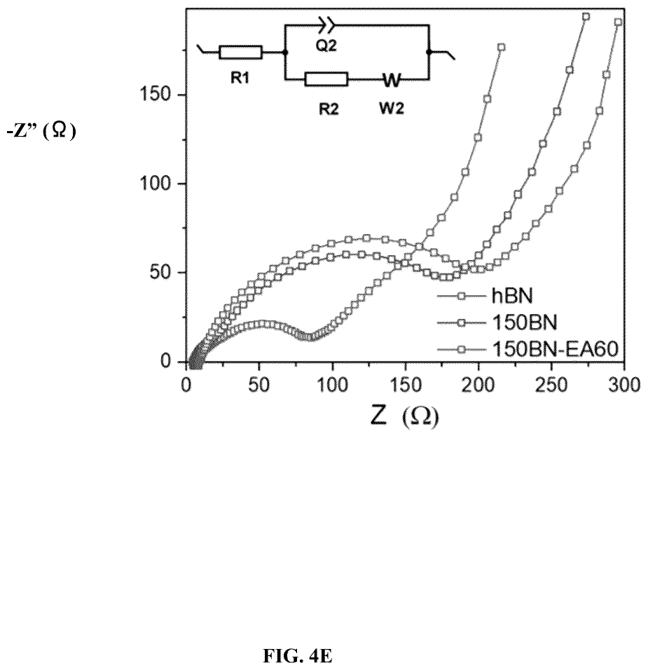

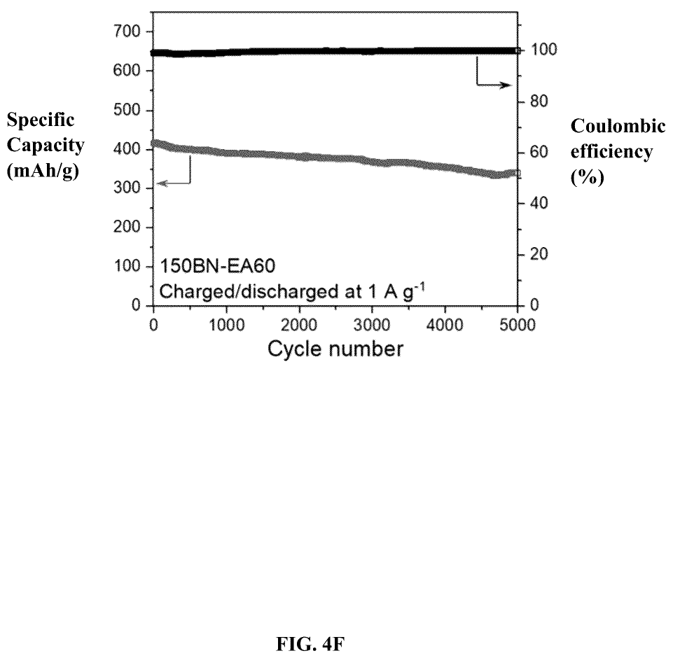

FIGS. 4A, 4B, 4C, 4D, 4E, and 4F show electrochemical performance of the half-cells. FIG. 4A shows high temperature (60° C.) rate performance of hBN, 150BN, and 150BN-EA60; FIG. 4B shows charge-discharge profiles of 150BN-EA60 at different current densities (25, 50, 100, 200, 500, 1000, 2000, 5000 A/g); FIG. 4C shows quantification of pseudocapacitive and diffusion limited contributions to total charge storage of 150BN-EA60 at 1 mV/s; FIG. 4D shows a summary and comparison of the pseudocapacitive and diffusion limited contributions to total charge storage of hBN and 150BN-EA60 at different scan rates (0.1, 0.3, 0.5, 1, 2, 5, and 10 mV/s); FIG. 4E shows EIS spectra of hBN, 150BN, and 150BN-EA60; FIG. 4F shows cycling performance of 150BN-EA60. As a result, 150BN-EA60 anodes demonstrated excellent Li-ion storage performance in a half-cell configuration between 0-3 V. The galvanostatic rate performance of BN with different cryo-milling time after EA process (hBN-EA60, 45BN-EA60, 150BN-EA60, 300BN-EA60) are initially performed to identify the optimal electrode composition. It is clear that the 150BN-EA60 electrode exhibited superior performance compared to 45BN-EA60 and 300BN-EA60. Moreover, Li-ion storage capability of 150BN-EA60 is considerably superior to pristine hBN, 150BN and conventional graphite under similar experimental conditions. 150BN-EA60 delivered an outstanding reversible capacity of 880 mAh g⁻¹ when compared to 150BN (122 mAh g⁻¹) and hBN (102 mAh g⁻¹) at lower current densities (25 mA g⁻¹) (FIG. 4A). 150BN and hBN experienced severe capacity fading, which is due to sluggish kinetics of BN electrodes towards the electrochemical lithiation/delithiation mechanism. In addition, 150BN-EA60 demonstrated excellent rate capability by retaining 619 and 480 mAh g⁻¹ even at higher rates of 2 and 5 A g⁻¹, respectively, and regained 950 mAh g⁻¹ when lowering to 25 mA g⁻¹. It is worth noting that the irreversible capacity loss for 150BN-EA60 is negligible (unlike 150BN-40% and hBN-42%), which is crucial for developing Li-ion fuel cells. Galvanostatic discharge profiles of 150BN-EA60 anodes displayed identical slopping profiles irrespective of current densities, indicating that the charge storage mechanism is mostly dominated by diffusion independent pseudocapacitive process (FIG. 4B). Moreover, coulombic efficiency of this electrode is outstanding (>99.8%) signifying the complete reversibility of the Li-ion storage mechanism.

Cyclic voltammetry (CV) of hBN, 150BN and 150BN-EA60 are performed in a voltage range of 0-3 V in order to study a detailed investigation of the redox processes. For 150BN-EA60, the broad cathodic peak centered at 0.7 V corresponds to the reaction of Li-ions with BN and no shift in the cathodic/anodic is observed in subsequent cycles. It is interesting to note that the cathodic peaks corresponding to Li₂O formation (SEI) are absent in 150BN-EA60 unlike hBN and 150BN that consist of a peak at 0.6 V. This cathodic response resembles well with the initial specific capacities and slopping galvanostatic voltage profiles. Anodic and cathodic peak current from CV of 150BN-EA60 followed a linear dependence with scan rate, signifying the characteristic pseudocapacitive type Li-ion charge storage. Calculated b-values for cathodic and anodic scans from the log (i) vs. log (v) plot of 150BN-EA60 are 0.6 and 0.7 respectively. Although the values are low, still it represents a high degree of pseudocapacitive type charge storage. Moreover, Li-ion storage through diffusion controlled and diffusion independent pseudocapacitive charge storage is distinguished. Pseudocapacitance in 150BN-EA60 dominated the complete voltage range with least contribution below 0.5 V, where the diffusion dependent reaction occurs (FIG. 4C). Extremely low pseudocapacitance (20%) observed in the case of hBN signifies that the charge storage is mainly controlled by diffusion processes. A high pseudocapacitive contribution (80%) exhibited by the 150BN-EA60 electrode at 1 mV s⁻¹ indicates the surface dominated Li-ion storage mechanism. Gradual increase of capacitive contribution is observed with an increase of scan rates and achieved a maximum of 94% at 10 mV s⁻¹ (FIG. 4D). This observation is in good agreement with the slopping voltage profiles, which is characteristic of the pseudocapacitive type Li-ion storage.

Electrochemical impedance spectroscopic (EIS) measurements provided further details on Li-diffusion kinetics of boron-nitride based electrodes (FIG. 4C). Charge transfer resistance (Ret) of 80 (2 (150BN-EA60), 198 22 (hBN) and 175 (2 (150BN) is obtained from Nyquist plots after fitting to the equivalent circuit. Lower charge transfer resistance for 150BN-EA60 when compared to hBN and 150BN can be related to the presence of surface defects that allows superior contact with the electrolyte solution. Li-ion diffusion coefficients calculated from the Warburg impedance are 2.7×10⁻¹⁴ cm² s⁻¹, 1.9×10⁻¹⁵ cm² s⁻¹, and 1.3×10⁻¹⁵ cm² s⁻¹ for 150BN-EA60, hBN, and 150BN respectively. Such a 10-fold higher Li-ion diffusion coefficient validates the strong dependence of kinetics with pseudocapacitance, specific capacities and cycling stability. Furthermore, galvanostatic cycling stability of the 150BN-EA60 anode is exceptional at 1 A g⁻¹ with a high reversible capacity of 415 mAh g⁻¹ while retaining a capacity of 345 mAh g⁻¹ (82% of initial capacity) after 5000 charge-discharge cycles (FIG. 4F). Coulombic efficiency on extended cycling is also excellent (99.8% at 1 A g⁻¹) in case of 150BN-EA60, which is crucial to develop fuel cells. Specific capacities and ultra-long cycling stability of the 150BN-EA60 anode at various current densities are superior to the state-of-the-art Li-ion battery anodes.

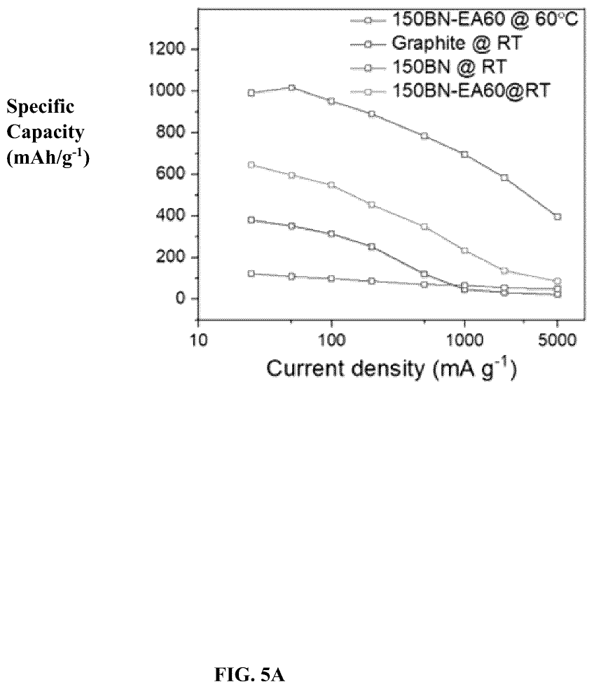

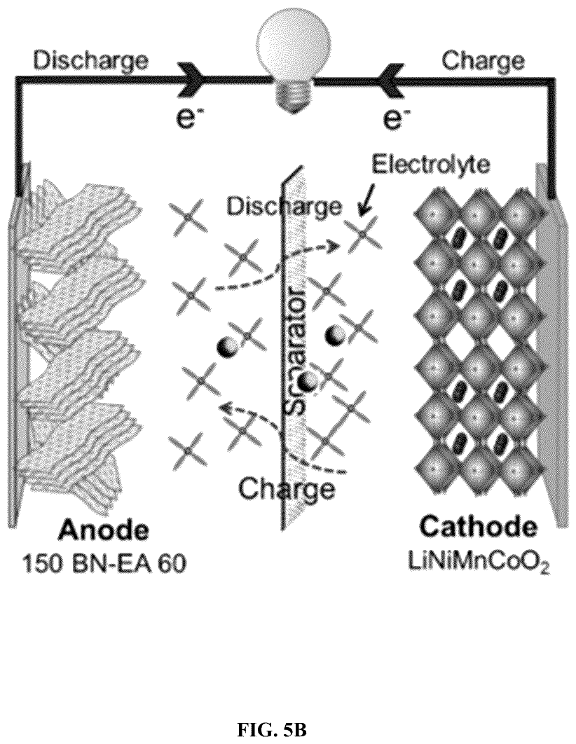

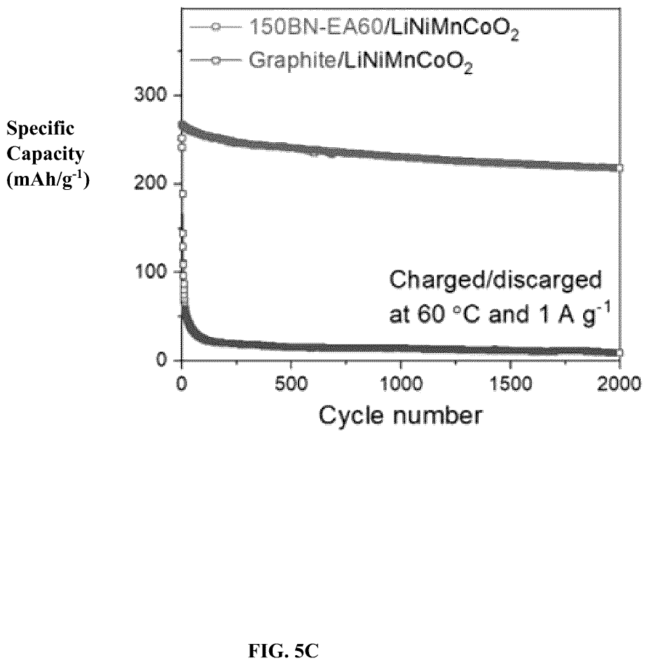

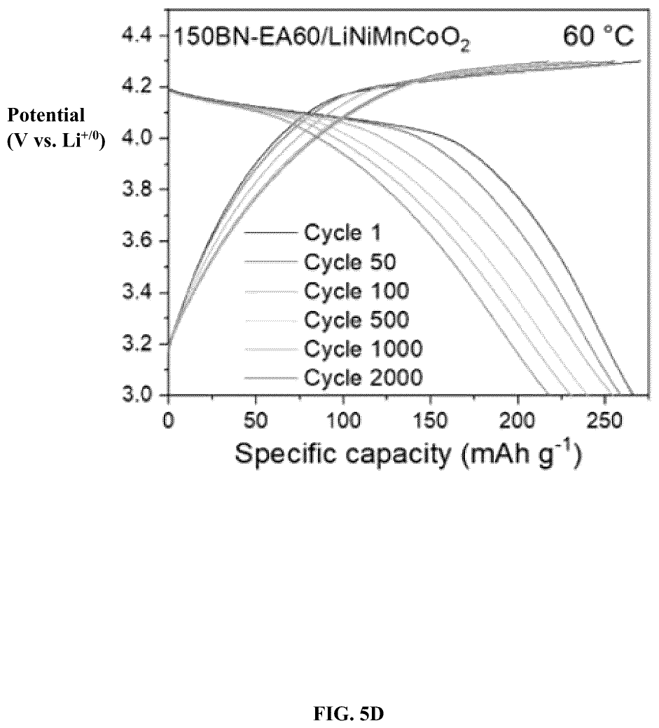

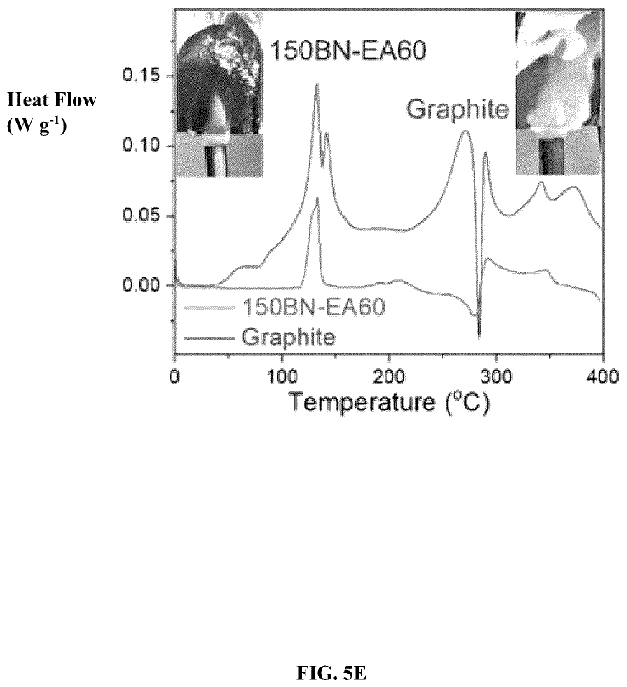

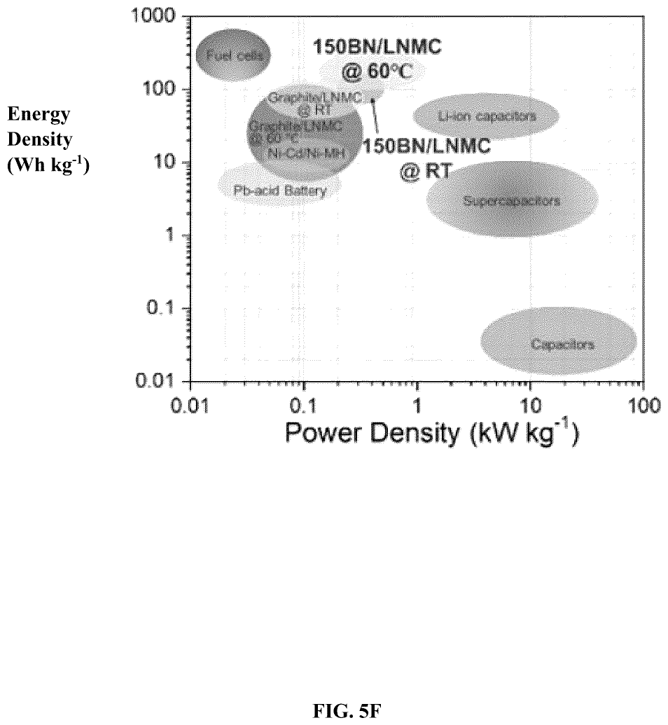

FIGS. 5A, 5B, 5C, 5D, 5E, and 5F show fuel cell performance with LiNiMnCoO₂ cathodes. FIG. 5A shows specific capacity vs. current density comparison among 150BN-EA60, graphite, and 150BN fuel cell at room temperature (RT), as well as that of 150BN-EA60 fuel cell at 60° C.; FIG. 5B shows a schematic of the 150BN-EA60/LiNiMnCoO₂ fuel cell; FIG. 5C shows cycling performance of 150BN-EA60/LiNiMnCoO₂ and graphite/LiNiMnCoO₂ fuel cell at 60° C. with 1 A/g; FIG. 5D shows charging-discharging profiles of 150BN-EA60/LiNiMnCoO₂ fuel cell at different cycles (1, 50, 100, 500, 1000, and 2000 cycle); FIG. 5E shows DSC curves of 150BN-EA60 and graphite anodes and the fire retardant electrode tests (inset); FIG. 5F shows Ragone plots of different energy storage system and 150BN-EA60/LiNiMnCoO₂ fuel cell. Specific capacity of the 150BN-EA60 is substantially superior to the performance of commercial graphite and BN with various cryo-milling and activation conditions investigated under similar experimental conditions (FIG. 5A). Finally, we implemented the 150BN-EA60 anode in a Li-ion fuel cell with commercial a LiNiMnCoO₂ cathode and 1M LiPF₆-EC/EMC electrolyte solution (FIG. 5B). The 150BN-EA60/LiNiMnCoO₂ fuel cell exhibited an excellent reversible capacity of 266 mA g⁻¹ at a high current density of 1 A g⁻¹ (based on anode weight) in the potential window of 3.0-4.3V. Galvanostatic cycling stability of the 150BN-EA60/LiNiMnCoO₂ fuel cell is also excellent, retaining 81% of the initial capacity after 2000 charge-discharge cycles (FIG. 5C). The graphite/LiNiMnCoO₂ fuel cell displayed less stable charge-discharge cycles (10% after 2000 cycles) under similar experimental conditions. This is higher than the specific capacity obtained for graphite anodes in the fuel cell configuration, which should be expected due to the sluggish Li-ion diffusion kinetics associated with graphite anodes. Galvanostatic charge-discharge profiles of the 150BN-EA60/LiNiMnCoO₂ fuel cell (FIG. 5D) displayed slopping behavior that is distinctive of pseudocapacitive Li-ion storage unlike the diffusion limited behavior of the graphite/LiNiMnCoO₂ system. Current density used in this case is notably higher compared to the previous reports of Li-ion fuel cells based of graphite and other conversion/alloying type anodes. The operating potential of the 150BN-EA60/LiNiMnCoO₂ fuel cell (˜4.0 V @ 1 A g⁻¹) is comparable to those of the secondary graphite/LiNiMnCoO₂ battery (3.9 V @ 1 A g⁻¹) and superior to previously reported values for graphite-based Li-ion fuel cells. The energy and power density of the 150BN-EA60/LiNiMnCoO₂ fuel cell are 492 Wh kg⁻¹ and 1.7 kW kg⁻¹, respectively (based on the weight of both electrodes). The graphite/LiNiMnCoO₂ fuel cell only achieved an energy and power density of 121 Wh kg⁻¹ and 250 W kg⁻¹ under similar experimental condition. This 4-fold and 6-fold higher energy and power density, respectively, are particularly attractive for applications such as fast-charging electric vehicles capable of long-range driving. Further, the energy release calculated from the differential scanning calorimetry (DSC) profiles (FIG. 5E) confirms the thermal stability of 150BN-EA60 (0.71 J g⁻¹) over graphite (18.7 J g⁻¹) electrodes lithiated to 0 V. A fire test performed for the electrodes soaked in the 1M LiPF₆ EC/EMC electrolyte exposed to a forced flame are also recorded (FIG. 5E inset). Energy and power densities demonstrated herein are considerably higher than previously reported Li-ion fuel cells and are also on par with the Li-ion capacitors and supercapacitors (FIG. 5F).

### DFT Calculations

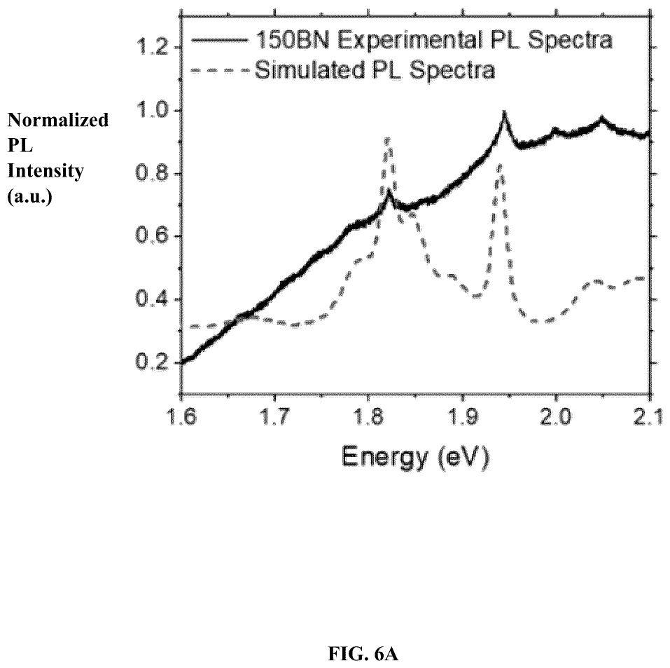

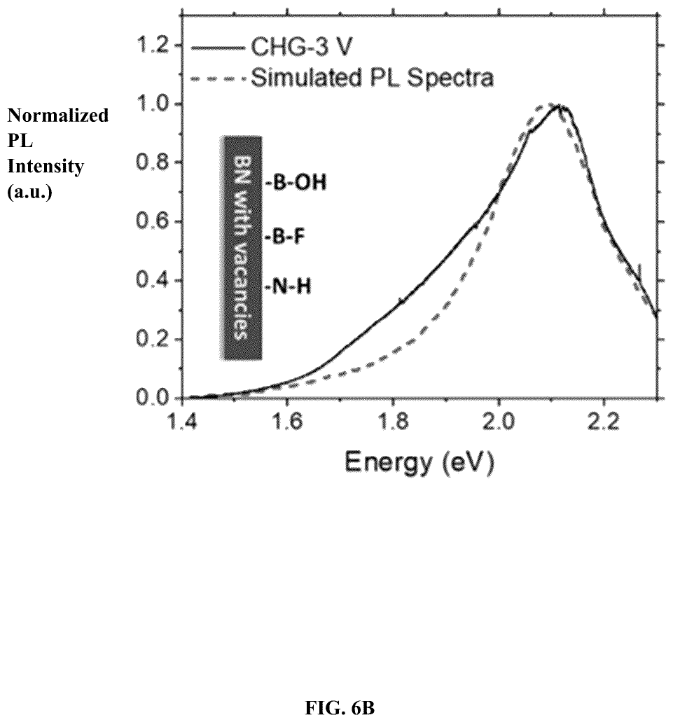

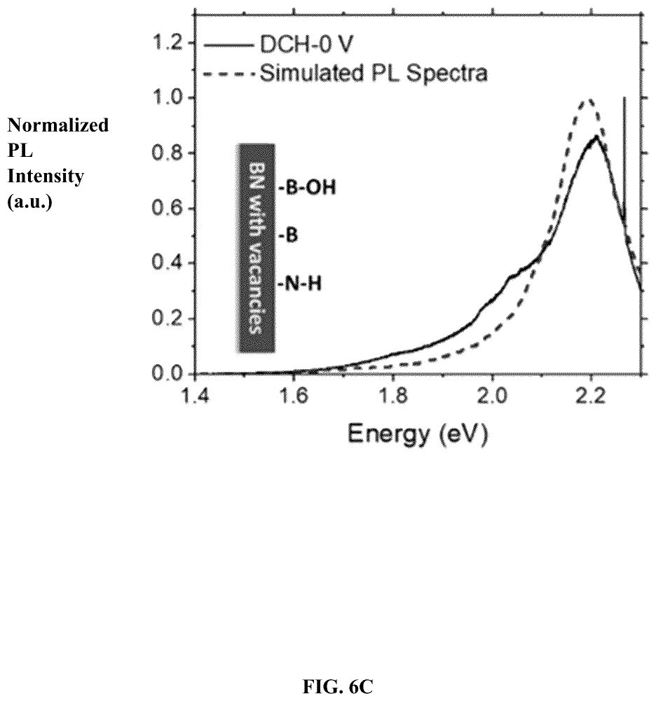

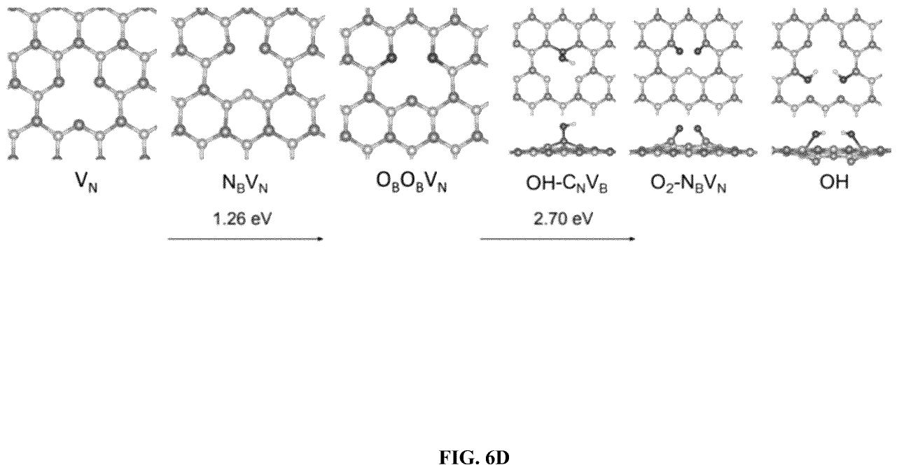

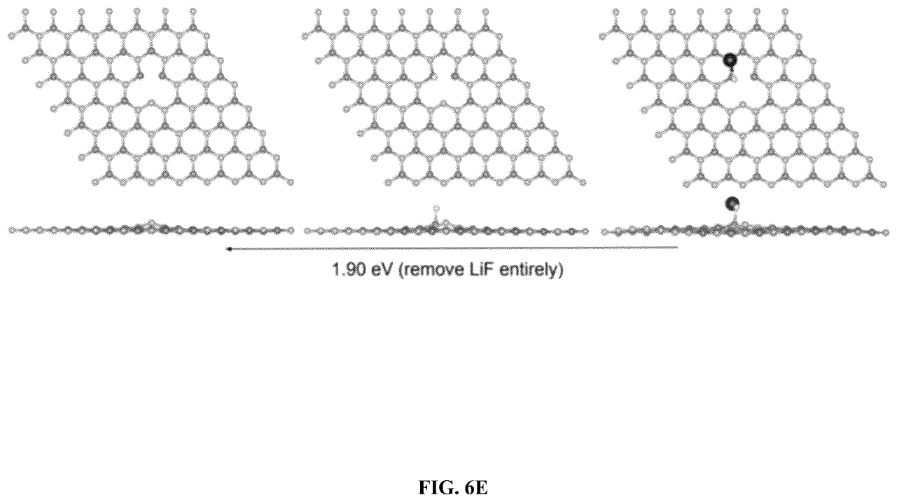

FIGS. 6A, 6B, 6C, 6D, and 6E show DFT calculations. FIG. 6A shows simulated and experimental PL Spectra for potential defects responsible for the emission observed in 150BN;

FIG. 6B shows the defects shown in FIG. 6A; simulated and experimental PL Spectra for FIG. 6C, CHG-3 V, and FIG. 6D, DCH-0 V; FIG. 6E shows the reaction mechanism pathway for the adsorption of a F⁻ ion in the presence of an N_{B}V_{N} defect. After the F⁻ ion binds to the surface, a Li⁺ ion is introduced creating a lingering LiF compound. In order to better understand the process involved during the proposed Li-ion storage mechanism, various defects including vacancies, Stone-Wales defects, oxygenated, hydroxylized, and substitutional defects are investigated to identify potential defects responsible for the PL spectra. It has been widely reported the emission peaks in the PL spectra arise from point defects emitting photons in the 1.6-2.2 eV range. The generating function procedure is performed to generate and identify the PL spectra and linewidths in FIG. 6A. Among all the defects studied, the best candidate identified are the hydroxylized C_{N}V_{B} (OH—C_{N}V_{B}), O_{B}O_{B}V_{N}, V_{N}, triangular shaped defect (OH₃), N_{B}V_{N}, and O₂—N_{B}V_{N} which exhibit emission peaks at 1.67 eV, 1.83 eV, 1.88 eV, 1.9 and 2.05 eV, 1.95 eV, and 2.10 eV, respectively (FIGS. 6A and 6B). The formation energies are calculated with: E_{form}=E_{Defective}+Eₚᵣᵢₛₜᵢₙₑ−Eₓ+E_{y} where E_{defect}, Eₜₒₜₐₗ, E_{X}, and E_{Y} are the total energies for the defective hBN material, pristine hBN, elemental impurities included, and elements removed, respectively. Both the OH₃ and O₂—N_{B}V_{N} defect have formation energies of E_{form}=4.72 eV and E_{form}=5.76 eV, respectively, while the other defects such as V_{N}, N_{B}V_{N}, O_{B}O_{B}V_{N}, and V_{B3}V_{N} have higher formation energies of E_{form}=7.78 eV, 10.21 eV, 10.88 eV, and 14.94 eV, respectively.

From the PL spectra measurements, a broad emission peak is observed at ˜2.1 eV when the F⁻ ions are chemisorbed, while a narrow emission peak at ˜2.2 eV is observed after the LiF compound is formed. Since the O_{B}O_{B}V_{N}, N_{B}V_{N}, and V_{N} defects exhibit sharp peaks, these defects are likely responsible for the observed sharp emissions. Among the defects studied, the N_{B}V_{N} defect yields peak emission energies which are the closest to the observed PL spectra for both when the F ions are bonded to the B site and after the LiF compound is formed. When the F-ion chemisorbs to the N_{B}V_{N} defect, there is an increase in the total structural change of ΔQ=0.63 amu^{1/2}·Å to ΔQ=0.76 amu^{1/2}. Å, which shows that the PL spectra broadens. The PL spectra approximations are overlaid on the experimental PL spectra both with and without the F-ion attached in FIGS. 6C and 6D. The adsorption energy (E_{ad}) is calculated for both the adsorption of the F⁻ and Li⁺ ion to the hBN surface. When the most stable position for the ion is identified in the first step of the reaction, the F³¹ (Li₊) ion is introduced in the presence of the Li⁺ (F⁻) ion to describe the second step of the reaction. For both reaction steps, the adsorption energy (E_{ad}) is determined with: E_{ad}=Eᵢ+Eᵢₒₙ−Eᵢ₊₁ where Eᵢ, Eᵢ₊₁, and Eᵢₒₙ are the energies of the i^{th} step state, (i+1)^{th} step state, and ion energy, respectively, where i=1 for the first step and i=2 for the second step. For the N_{B}V_{N} defect, the F⁻ ions adsorbs to the defective hBN surface with an adsorption energy of E_{ad}=1.26 eV. When the Li⁺ ion is introduced in the presence of the chemisorbed F⁻ ion, a lingering LiF compound is formed with E_{ad}=2.70 eV where the LiF compound can be completely removed with 1.90 eV applied (FIG. 6E). Even though the other defects have small E_{form} with some even broadening when the F⁻ ions bind to the defective hBN surfaces, there are no other possible configurations found with peak energies matching the experimental PL measurements and the Li ion battery mechanism is not reversible unlike the N_{B}V_{N} defect, where the LiF compound can be easily removed and even dissociate.

Through the examples above, development of a high performance and fire-safe hBN anode with a wide operation window (RT to 60° C.) for Li-ion batteries through defect engineering is demonstrated. Electrochemically inactive hBN was activated by introducing nitrogen vacancy defects on surfaces and edges through cryo-milling. Defective hBN anodes demonstrated high specific capacity (880 mAh g⁻¹ @25 mA g⁻¹), rate performance (480 mAh g⁻¹ @5 A g⁻¹) and cycling stability (5000 cycles) compared to insertion, conversion and alloying type anodes reported earlier. These anodes also exhibited superior fire-safety characteristics compared to conventional graphite anodes. In addition, Li-ion fuel cells containing LiNiMnCoO₂ cathode and defective hBN anodes demonstrated significantly higher energy and power density (400 Wh kg⁻¹ and 1 kW kg⁻¹) compared to graphite/LiNiMnCoO₂ fuel cell (121 Wh kg⁻¹ and 250 W kg⁻¹). Investigation of the Li-ion storage mechanism through in-situ and ex-situ spectroscopic/microscopic techniques verified reversible LiF formation on defective hBN during charge-discharge process. This is further substantiated by the first principles calculations, which revealed nitrogen antisite (N_{B}V_{N}) defect as the biggest contributor of the surface pseudocapacitive Li-ion storage. Again, Li-ion storage through reversible LiF formation established in this case is drastically different from the intercalation type mechanism of conventional graphite anodes. Pseudocapacitive type surface storage also facilitates high specific capacity, rate performance and cycling stability. Defect induced electrochemical activation of hBN opens up a new avenue for the designing of high-performance battery electrodes through defect engineering.

### Methods

### Material Synthesis

5 g hBN powders were cryo-milled in a polycarbonate encapsulated cell (SPEX 6875D Freezer/Mill) at −196° C. for 150 min (150BN). The polycarbonate capsulated compactor (SPEX 6761) hits the two ends of the cell with a frequency of 10 cycles per second (cps).

### Material Characterization

XRD was performed using PANalytical Empryean X-Ray Diffractometer. The grain size perpendicular to (002) was calculated using the Scherrer equation with the measured full width at half maximum (FWHM). PL measurements were performed at room temperature using a Renishaw in Via confocal Raman spectrometer with 488 nm laser excitation. All PL spectra were acquired from powder samples of 90BN.

Nitrogen adsorption analysis was carried at 77 K with an Accelerated Surface Area and Porosimetry Analyzer (ASAP 2020; Micrometritics Instrument Corp.). Surface area was estimated using the Brunauer, Emmett and Teller (BET) equation. Prior to the measurement, the sample was degassed at 333 K for 24 h under 4 μm Hg vacuum.

XPS measurements were conducted in a high-resolution Thermo Scientific XPS with monochromatic Al Kα X-ray source, and a Physical Electronics VersaProbe II instrument equipped with a monochromatic Al kα X-ray source (hv=1,486.7 eV) and a concentric hemispherical analyzer. Charge neutralization was performed using both low energy electrons (<5 eV) and argon ions. The binding energy axis was calibrated using sputter cleaned Cu (Cu 2p_{3/2}=932.62 eV, Cu 3p_{3/2}=75.1 eV) and Au foils (Au 4f_{7/2}=83.96 eV). Peaks were charge referenced to the nitride band in the nitrogen Is spectra at 397.7 eV. Measurements were made at a takeoff angle of 45° with respect to the sample surface plane. This resulted in a typical sampling depth of 3-6 nm (95% of the signal originated from this depth or shallower). For ex situ XPS experiments, to avoid the signal overlapping, cycled electrodes (without PVDF and acetylene black) were rinsed with dimethyl carbonate several times and dried under a vacuum at room temperature.

Quantification was done using instrumental relative sensitivity factors (RSFs) that account for the x-ray cross section and inelastic mean free path of the electrons. In order to avoid oxidation, the samples with Li were loaded with the inert transfer vessel to minimize exposure to O₂ and H₂O.

Fourier Transformed Infrared Spectroscopy (FTIR) experiments were conducted using a Bruker Vertex 70 FTIR spectrometer (Billerica) with an Attenuated Total Reflection (ATR) accessory, equipped with a liquid nitrogen-cooled MCT detector. Spectra were collected at room temperature and were obtained from an average of 200 scans in the wavelength range of 500-4000 cm⁻¹.

In-situ X-ray diffraction analysis of 150BN-EA60 at different state of charge was carried out in a split test cell with beryllium (Be) window (MTI Corporation). Working electrode was prepared by casting 150BN-EA60 based slurry (as mentioned in previous section) on a ‘Be’ disk (thickness of 250 μm) that serves as a current collector and window for the x-ray beams. Split test cell was built in an argon filled glove box with working electrode, Li-foil counter electrode, glass fiber separator and a 1M LiPF₆ electrolyte in EC/EMC mixture (1:1). Each XRD pattern was recorded over a time span of ˜30 min including 1 min rest time between each pattern. Simultaneously, galvanostatic discharge-charge of the in-situ cell was performed through a biologic SP-200 potentiostat at a current density of 50 mA/g in the voltage range of 0.01-3 V.

DSC profiles are recorded using Q200, TA Instruments at a heating rate of 10° C. min 1. The fire behavior of 150BN and graphite samples are investigated using Micro-scale Combustion calorimeter (MCC, FTT) with an electrode weight of ˜20.0 mg soaked in 1M LiPF₆ EC/EMC electrolyte.

### Electrochemical Study

Composite electrodes for various electrochemical performances were prepared by mixing 60% active material with 20% carbon black and 20% polyvinylidene fluoride (MW: 600,000, MTI Chemicals) in N-methylpyrrolidone solvent (99.9%, Sigma-Aldrich) followed by casting on a copper foil (10 μm thickness) using a doctor blade. Lithium-ion storage performance was evaluated using coin-type 2032 two-electrode cells (MTI corp.) assembled in an Ar-filled glovebox (Vigor tech USA) equipped with oxygen and moisture sensors/absorbers (H₂O and O₂ content <1 ppm). Half cells were fabricated using the composite working electrode (12 mm diameter) containing 2-3 mg of active material, Li-foil counter/reference electrode and a glass fiber separator (Whatman, GF/B type). Electrolyte consists of a 1M solution of lithium hexafluorophosphate (LiPF₆) (99.99%, Sigma-Aldrich) in a 1:1 mixture of ethylene carbonate (EC) and ethyl methyl carbonate (EMC). Li-ion half-cells were measured in voltage range 0-3 V at various current densities (25-5 A/g) by a Neware BTS-4000 multi-channel battery tester using galvanostatic charge/discharge mode at 60° C. Cryomilled BN electrodes were electrochemically activated at 60° C. for 1000 charge/discharge cycles (vs Li^{+/0}) at 2 A g⁻¹ current density (150BN-EA60). Coin-type fuel cells were assembled with commercial LiNiMnCoO₂ (NMC532, Sigma-Aldrich) cathode (on 10 μm thick Al-foil), 150BN-EA60 anode, glass fiber separator and 1M LiPF₆ in EC/EMC electrolyte. Fuel cells were optimized by balancing the N/P ratio (where N is negative 150BN-EA60 electrode capacity and P is a positive LiNiMnCoO₂ electrode capacity in mAh/g) to compensate the lower specific capacities of the LiNiMnCoO₂ cathode at higher current density (N/P ˜1.7). A typical fuel cell consists of 1.5-2 mg of a 150BN-EA60 anode and 6-8 mg of the LiNiMnCoO₂ cathode. Galvanostatic cycling performance of fuel cells were conducted at a current density of 1 A g⁻¹ (based on anode weight) in the voltage range 3-4.3 V. Energy density (Wh kg⁻¹) and power density (W kg⁻¹) of Li-ion fuel cells (considering the mass of both the electrodes) are calculated by Equations (1) and (2):

$$Energy density , E = {\int }_{t 1}^{t 2} IV dt \qquad ( 1 )$$

$$Power density , P = E / t \qquad ( 2 )$$

where I is the applied current (mA), V is the average working voltage and t1,t2 are the initial and final discharge times.

Cyclic voltammetry (CV) and electrochemical impedance spectroscopy (EIS) were measured using a Biologic SP-200 potentiostat. In order to eliminate the SEI interference, potentiostatic EIS measurements were carried out on fresh batteries at open circuit voltage in the frequency range of 1 MHz to 0.01 Hz. Capacitive contribution and diffusion-controlled response to the applied current (i) at a fixed potential (V) can be described by Equation (3):

$$i ( V ) = {k}_{1} v + {k}_{2} {v}^{1 / 2} \qquad ( 3 )$$

where v is the sweep rate, k₁v and k₂v^{1/2} are current contributions from capacitance and diffusion-controlled process respectively.

k₁ and k₂ are constants, determined from the slope and intercept of scan rate dependence of current plot. Lithium-ion diffusion coefficients of BN-based electrodes were calculated using the Equation (4):

$$D = 1 / 2 ( RT / {AF}^{2} {σ}_{ω} C ) \qquad ( 4 )$$

where D is the diffusion coefficient, R is the gas constant, T is the absolute temperature in Kelvin.

F is the Faraday's constant, C is the lithium concentration, and A is the electrode area. The Warburg impedance coefficient ow is determined from the slope of the linear plot between Z′ and ω^{-1/2}. For the post cycling studies, the cycled cells were carefully disassembled inside a glove box under an inert atmosphere. Cycled electrodes were then rinsed with dimethyl carbonate several times and dried inside the glove box at room temperature. All potentials presented are vs. Li/Li⁺, and the specific capacity measurements are within a 5% error limit.

### DFT Calculation

The DFT calculations are performed using Quantum Espresso (QE) with the generalized gradient approximation by Perdew, Burke, and Ernzerhof (PBE). Hexagonal supercells of size 6×6×1 (˜72 atoms) with a lattice constant of 15.06 Å are performed at the gamma point (T) with a vacuum of 24.7 Å in the z-direction between periodic images. The calculations are performed with a plane wave kinetic energy cutoff of 1088 eV and the atomic coordinates are considered to be relaxed when the total force is smaller than 0.01 eV/Å with an scf convergence threshold of 10⁻⁶ eV. Constrained density functional theory (CDFT) calculations with spin-polarization are performed to determine the excited state electronic structure for the defective hBN⁴³. The DFT-D method is utilized to describe the van der Waals (vdW) interaction between the ions and the hBN surface. The bandgaps are measured from the density of states (DOS) using the HSE functional with an additional electron introduced to appropriately describe the charged and uncharged states.

### hBN Cryo-Milling

5 g boron nitride was cryomilled in a polycarbonate encapsulated cell (SPEX 6875D Freezer/Mill) at −196° C. The polycarbonate capsulated compactor (SPEX 6761) hits the two ends of the cell with a frequency of 10 cycles per second (cps). Eight samples were prepared with different cryo-milling time: 9, 18, 27, 45, 90, 120, 150, and 900 min.

### Metal Reduction

To prepare d-BN: Ag, 500 mg d-BN with different cryo-milling time (9, 18, 27, 45, 90, 120, 150, and 900 min) was mixed with 10 mL 0.001 M AgNO₃ aqueous solution at room temperature. After 24 h, the solid was washed with DI water by centrifugation at 4,000 rpm for 5 min twice, followed by a wash in ethanol by centrifugation at 4000 rpm for 5 min. The resultant was then dried in an oven overnight at 60° C. To prepare d-BN: Pt, 500 mg d-BN was added to 10 ml 0.001 M PtCl₄ aqueous solution, and the rest of the steps remain the same as d-BN: Ag. To prepare d-BN:AgPt, the solution was changed to 10 mL 0.001 M AgNO₃/PtCl₄ (1:2), AgNO₃/PtCl₄ (1:1), AgNO₃/PtCl₄ (2:1) mixture, respectively, and the rest of steps remain the same. To prepare d-BN:Au, d-BN:Cu, d-BN:Fe, the solution was changed to 10 mL 0.01 M HAuCl₄, 0.01 M CuSO₄, and 0.01 M FeCl₃ aqueous solution, and the rest steps remain the same. Characterization

XRD was performed using PANalytical Empryean X-Ray Diffractometer. The grain size perpendicular to (002) was calculated using the Scherrer equation with the measured full width at half maximum (FWHM). PL measurements were performed at room temperature using a Renishaw in Via confocal Raman spectrometer with 488 nm laser excitation. All PL spectra were acquired from powder samples of 90BN.

Nitrogen adsorption analysis was carried at 77 K with an Accelerated Surface Area and Porosimetry Analyzer (ASAP 2020; Micrometritics Instrument Corp.). Surface area was estimated using the Brunauer, Emmett and Teller (BET) equation. Prior to the measurement, the sample was degassed at 333 K for 24 h under 4 μm Hg vacuum.

Particle size measurements were performed using Malvern Zetasizer Nano ZS. The d-BN powders were first dispersed in ethanol solutions at 1 mg/ml concentrations and sonicated for 2 min. prior to measurements for optimized results. The particle size is calculated by Dynamic Light Scattering (DLS) intensity fluctuations yields the velocity of the Brownian motion using the Stokes-Einstein relationship.

As received hBN was firstly dispersed into ethanol solution, and then a drop of BN containing solution was casted to a Quantifoil TEM grid. STEM was carried out by FEI Titan G2 S/TEM operating at 80 kV. In order to reduce beam damage, the beam current was kept below 40 pA. A high-angle annular dark field (HAADF) detector was used for STEM-ADF imaging. For most images in the text, a Gaussian blur filter was applied by the ImageJ program to reduce noise and enhance the visibility of structural details, but raw images were used to acquire line profiles of ADF intensity.

After the metal reduction, the solution containing d-BN:metal and metal precursor was centrifuged at 10,000 rpm for 5 min. The supernatant containing un-reacted metal cations was collected for UV-vis measurements with a LAMBDA 950 UV/vis/NIR spectrometer.

XPS measurements were conducted in a high-resolution Thermo Scientific XPS with monochromatic Al Kα X-ray source, and a Physical Electronics VersaProbe II instrument equipped with a monochromatic Al kα x-ray source (hv=1,486.7 eV) and a concentric hemispherical analyzer. Charge neutralization was performed using both low energy electrons (<5 eV) and argon ions. The binding energy axis was calibrated using sputter cleaned Cu (Cu 2p3/2=932.62 eV, Cu 3p3/2=75.1 eV) and Au foils (Au 417/2=83.96 eV).³ Peaks were charge referenced to nitride band in the nitrogen Is spectra at 397.7 eV. Measurements were made at a takeoff angle of 45° with respect to the sample surface plane. This resulted in a typical sampling depth of 3-6 nm (95% of the signal originated from this depth or shallower). Quantification was done using instrumental relative sensitivity factors (RSFs) that account for the x-ray cross section and inelastic mean free path of the electrons.

X-ray absorption (XAFS) measurements around Pt L3 edge were performed at BL5S1 of Aichi Synchrotron Radiation Center (Experiment No. 2018D4008). X-rays from the normal bend-magnet were collimated by a rhodium-coated bent-cylindrical mirror, monochromatized by a Si (111) double-crystal monochromator, and then focused onto the samples by another rhodium-coated bent-cylindrical mirror. The mirrors also eliminate higher harmonics. This configuration enables us to deliver about 5×10¹⁰ photons/s into the area of 0.5 mm×0.5 mm at the sample position. The photon energies were calibrated at Cu—K absorption edge by measuring a copper foil. The synthesized powder samples were pressed into pellet and all the samples were measured in transmission mode. Incident photon flux was monitored just before the sample by a 17 cm long ion chamber filled with N₂ at the normal pressure, and transmitted flux was detected by a 31 cm long ion chamber filled with (N₂/Ar=1/1) at the normal pressure.

The ESR data were recorded on a Bruker EMX Plus X-band ESR Spectrometer equipped with a high sensitivity probe head. A ColdEdge™ ER4112HV In-Cavity Cryo-Free VT system connected with an Oxford temperature controller was used for low-temperature measurements. The complete system was operated by the Bruker Xenon software. In addition, all ESR experimental settings were kept constant for reproducibility and consistency. ESR settings: modulation amplitude=2 G (peak-to-peak), and modulation frequency=100 kHz.

PIXE measurements were performed by Elemental Analysis Corporation. The PIXE system is composed of a General Ionex 4 MV tandem accelerator with a duoplasmatron source capable of producing beam currents in the range of a few nanoamps to tens of microamps, a dual quadrupole focusing lens, an x-y beam scanner to ensure beam homogeneity, a beam pulse with 50 ns response time and a vacuum/helium chamber with internal dimensions of 20″w×16″l×8″h. The data acquisition system consists of a combination of an AT style computer which drives a CAMAC crate front-ended with a 150 eV resolution, 30 mm² Si (Li) detector for X-ray collection and Au surface barrier detector to monitor scattered protons.

### HER Measurements

To fabricate the electrode, 25 mg sample are mixed with 5 mg carbon and 100 μL Nafion, 800 μL DI water, and 200 μL isopropanol. The mixture was then sonicated for 1 h to form a slurry. Then, 5 μL slurry was drop-casted on the glassy carbon electrode (3 mm diameter). Thus, the average loading catalyst was 1.61 mg cm-2. Based on the PIXE, the Pt concentration is 0.185 wt. %, 0.197 wt. %, 0.119 wt. %, and 0.122 wt. % in 90BN—Ag₁Pt₁, 90BN—Ag₁Pt₂, 90BN—Ag₂Pt₁, and 90BN—Pt, respectively. Thus, the actual number of Pt active sites are 9.18E15, 9.78E15, 5.91E15, and 6.05E15 in 90BN—Ag₁Pt₁, 90BN—Ag₁Pt₂, 90BN—Ag₂Pt₁, and 90BN—Pt, respectively (Eq.5):

$$( 5 )$$

$$Number of Pt active sites = \frac{Catalyst loading on the electrode ( {gcm}^{- 2} ) \times Pt concentration ( wt . \% ) \times 6.022 \times {10}^{23}}{Pt atomic weight ( {gmol}^{- 1} )}$$

The electrolyte used for HER measurement is purged 0.5 M H₂SO₄ with a graphite rod as the counter electrode and a saturated calomel electrode (SCE) as the reference electrode using a Versa STAT 4 potentiostat with a rotating electrode system (BASI RDE-2). The scan rate of linear sweep voltammetry (LSV) was 1 mV s⁻¹ with iR-compensation, and the working electrode was rotated at 3000 rpm during the LSV tests. To stabilize the electrode surface, open circuit potential (OCP) was monitor before the measurements. The LSV was measured only when the OCP was stabilized. Each sample was tested with 3 distinct electrodes with 5 measurements/electrode to get a statistic result. EIS was performed in the same configuration at an overpotential of 30 mV, and the frequency range is 10 kHz. The cycling performance was evaluated by repeating LSV 10,000 (scan rate of 40 mV s⁻¹), and the amperometric I-t stability curve was tested at a constant overpotential of 35 mV for 10 h and 55 mV for 50 h. To reduce the data size, the current was recorded every 200 s for 50 h-stability test. After 50 h stability test, the glassy carbon electrode was sonicated in IPA, and the dispersion was drop casted to the TEM grid for further STEM imaging. The Ca which is proportional to ECSA was determined by CV at different scan rates (10 mV s⁻¹, 20 mV s⁻¹, 30 mV s⁻¹, 40 mV s⁻¹, 50 mV s⁻¹, 60 mV s⁻¹, 70 mV s₋₁, 80 mV s₋₁, 90 mV s⁻¹, 100 mV s⁻¹) within the non-Faradaic region (0.11 to 0.21V vs. RHE).

TOF is calculated based on the assumption that all the Pt atoms are considered as the active sites (Eq. 6). Pt concentration was obtained by PIXE:

$$TOF = \frac{Total hydrogen turnovers per geometric area}{The number of Pt active sites} \qquad ( 6 )$$

The total number of hydrogen turnovers was calculated based on j (current density at different overpotential, Eq. 7) collected from the LSV:

$$Total hydrogen turnovers = \vert j {mAcm}^{- 2} \vert \times ( \frac{1 C {s}^{- 1}}{1000 mA} ) \times ( \frac{1 mol {e}^{- 1}}{96485.3 C} ) \times ( \frac{1 mol}{2 mol {e}^{- 1}} ) \text{} \times ( \frac{6.022 \times 1 {0}^{23} molecules {H}_{2}}{1 mol {H}_{2}} )$$

For example, the best performing sample 90BN—Ag₁Pt₁, when the overpotential is 100 mV, j is 74 mA cm⁻².

$$Total hydrogen turnovers = \vert 74 {mAcm}^{- 2} \vert \times ( \frac{1 C {s}^{- 1}}{1000 mA} ) \times ( \frac{1 mol {e}^{- 1}}{96485.3 C} ) \times ( \frac{1 mol}{2 mol {e}^{- 1}} ) \times ( \frac{6.022 \times 1 {0}^{23} molecules {H}_{2}}{1 mol {H}_{2}} ) = 2.31 E 17$$

$$TOF = \frac{Total hydrogen turnovers per geometric area}{The number of Ag + Pt active sites} = \frac{2.31 E 17}{9.18 E 15} = 25.15$$

When Ag and Pt atoms are all considered as the active sites,

$$T OF = \frac{Total hydrogen turnovers per geometric area}{The number of Ag + Pt active sites} = \frac{2.31 E 17}{2.27 E 16} = 10.17$$

### Computational Details

The equilibrium geometries and electronic structure calculations in the bulk or surface of defect-free hBN, d-BN, d-BN: AgPt and d-BN: Pt were computed using unrestricted periodic hybrid DFT (UDFT), with the B3LYP functional as implemented in the ab initio CRYSTAL14 code, which is within the localized Gaussian basis sets formalism. Specifically, the hybrid B3LYP functional was combined with the dispersion interactions corrections of the Grimme's D2 approach, which is in summary the UDFT-B3LYP-D2 approach or DFT for short. The triple-zeta valence with polarization quality (TZVP) Gaussian basis sets were used for H, B, N, and O atoms, whereas TZVP type basis set with Doll type effective core potentials (ECPs) were used for Ag and Pt atoms. The threshold used for evaluating the convergence of the energy, forces, and electron density was 10⁻⁷ a.u. for each parameter. This DFT approach has been shown to give accurate thermochemistry for both covalently bonded systems and systems dominated by dispersion forces, additionally densities and energies obtained with the method are less affected by spin contamination than other approaches.

The electronic properties (i.e., band structures and DOS) of all the structures were calculated using the optimized equilibrium structures. Integrations inside of the first Brillouin zone were sampled on 20×20×1 Monkhorst-Pack k-mesh grids for geometry optimization and electronic properties calculations. The reciprocal space for all the structures was sampled by a Γ-centered Monkhorst-Pack scheme with a resolution of around 2π1/60 Å⁻¹. The band pathway followed the symmetry points: Γ-M-K-Γ. A vacuum layer of ˜500 Å along the z-axis is used to simulate the vacuum environment (i.e., in the Gaussian Basis Set formalism the size of the vacuum layer does not require extra computational resources). Electrostatic potential calculations were considered in these calculations; thus, the E_{F} is reported with respect to (w.r.t.) vacuum.

For the mechanistic studies, we developed a molecular cluster model system (Pt or Ag₂Pt₂) bound to d-BN to investigate adsorption energy and the HER mechanism. For this molecular approach, UDFT-B3LYP-D3 was combined with the 6-31+G** basis sets for H, B, and N atoms, while LANL2DZ basis sets for Pt and Ag. The harmonic vibrational frequency calculations were carried out at the optimized geometry to obtain the Gibbs free energy and zero-point vibrational energy (ZPE). The transition states were confirmed by observing only one imaginary frequency in the vibrational modes. All the computations for the HER mechanism were performed with the general-purpose electronic structure quantum chemistry program Gaussian09. The polarizable continuum model (PCM) was included for all the calculations to capture solvation effects (i.e., a dielectric constant of 21.90 for H₂SO₄).

The d-BN: Pt formation energy, ΔE_{d-BN:Pt}, is calculated by using the formula ΔE_{d-BN: Pt}=E_{d-BN:Pt}-E_{d-BN}-Eₚₜ; where E_{d-BN} is the total energy of the single N vacancy d-BN, E_{d-BN:Pt} is the total energy of the single N vacancy d-BN and E_{Pt} is the total energy of the single Pt atom. Similarly, the formation energy of the d-BN: AgₓPtₓ is defined as ΔE_{d-BN:AgxPtx}=E_{d-BN:AgxPtx}-E_{d-BN}-XE_{Ag}-XE_{Pt}.

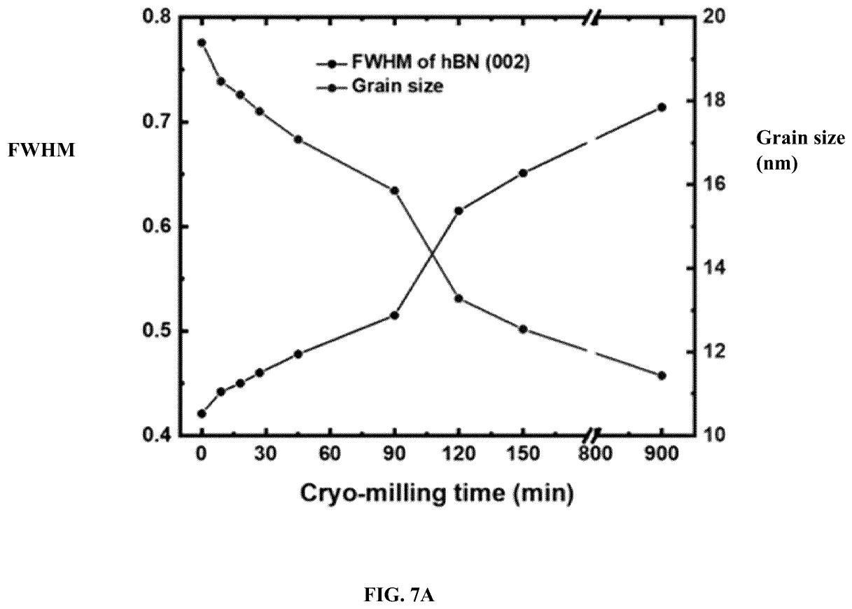

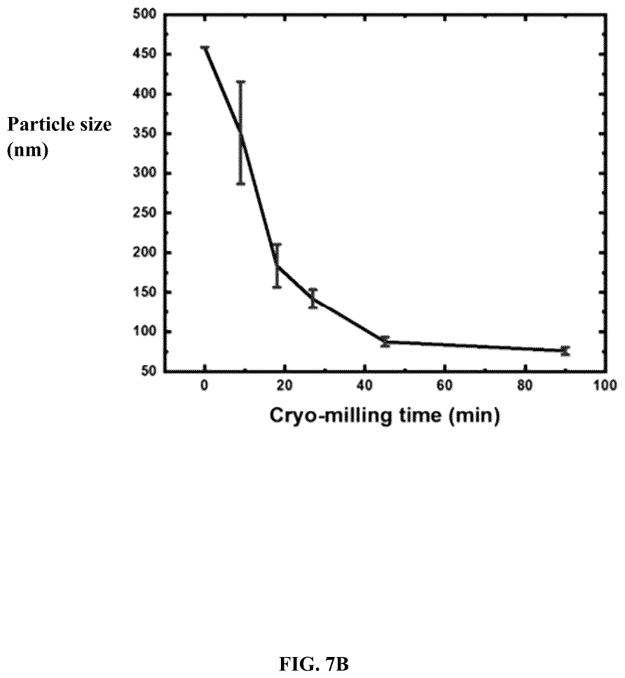

FIG. 7A shows the measured full width half maximum (FWHM) and the calculated grain size of the BN vs. different cryo-milling time (0, 9, 18, 27, 45, 90, 120, 150, and 900 min), based on the BN (002) peak. The grain size perpendicular to (002) was calculated using the Scherrer equation with the measured FWHM. FIG. 7B shows particle size vs. cryo-milling time (0, 9, 18, 27, 45, and 90 min).

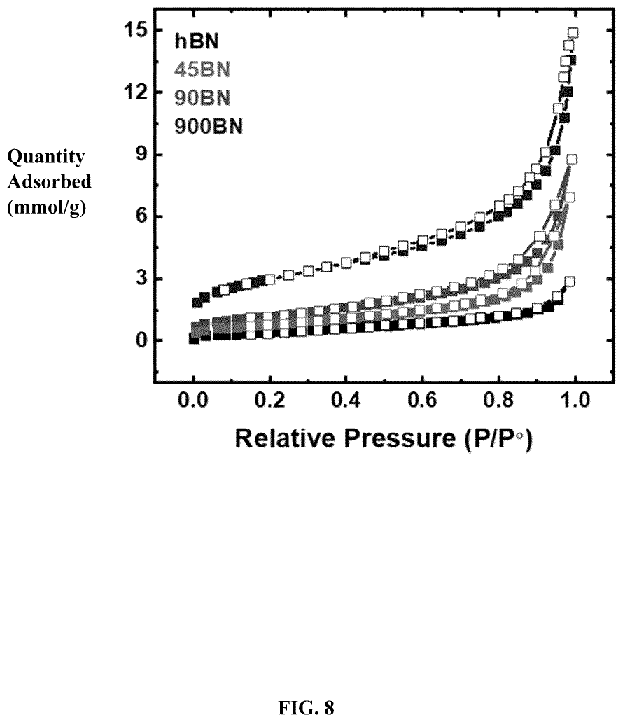

FIG. 8 shows N₂ adsorption/desorption isotherms (filled/empty squares, respectively) of hBN, 45BN, 90BN, and 900BN.

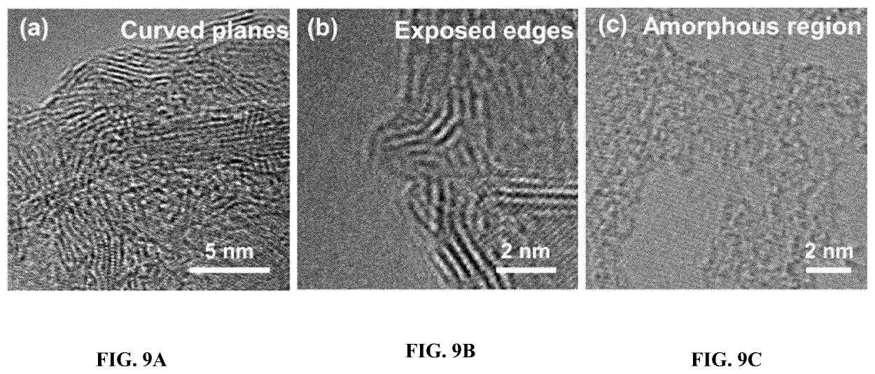

FIGS. 9A, 9B, and 9C show HRTEM of the disordered structures with extended vacancies in 90BN: FIG. 9A curved planes; FIG. 9B exposed edges; FIG. 9C amorphous region.

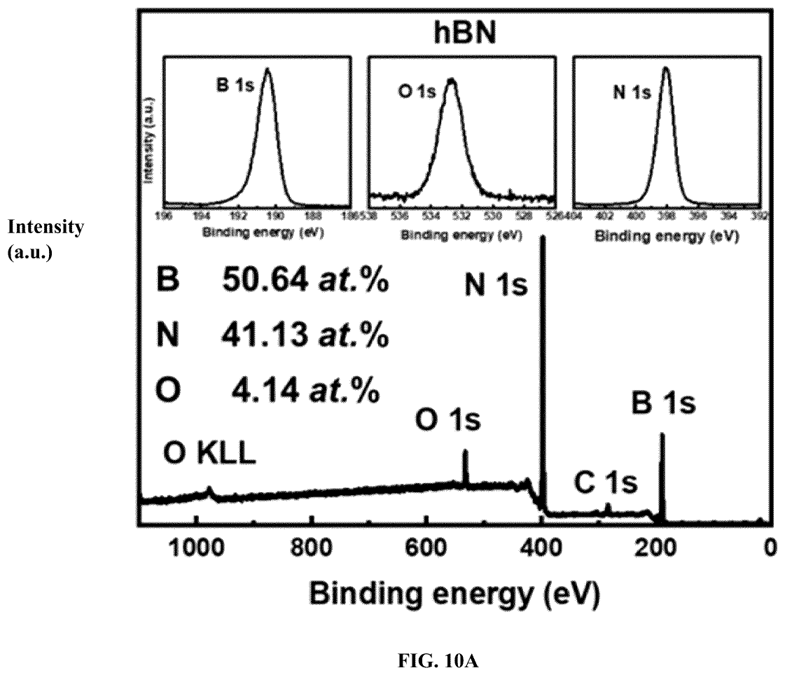

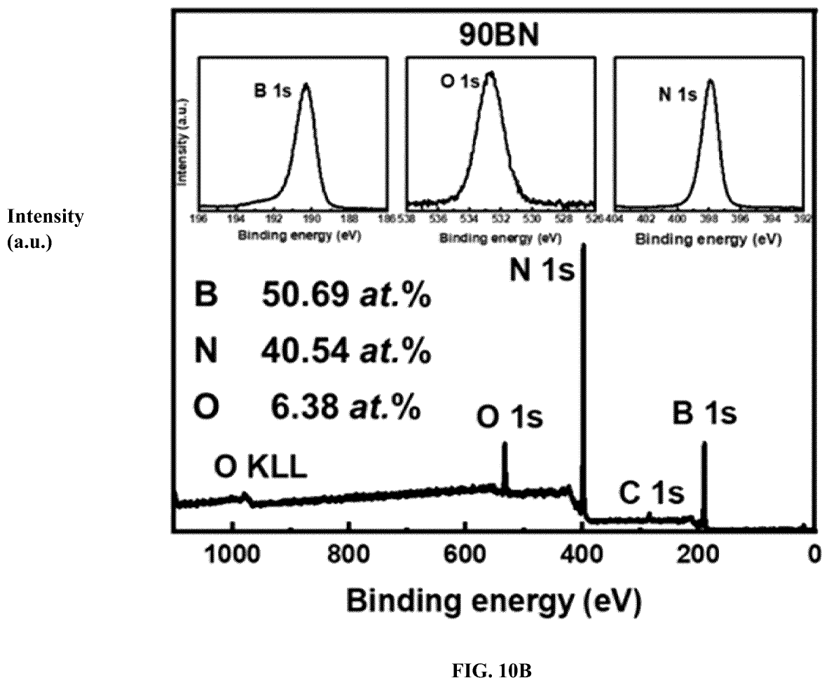

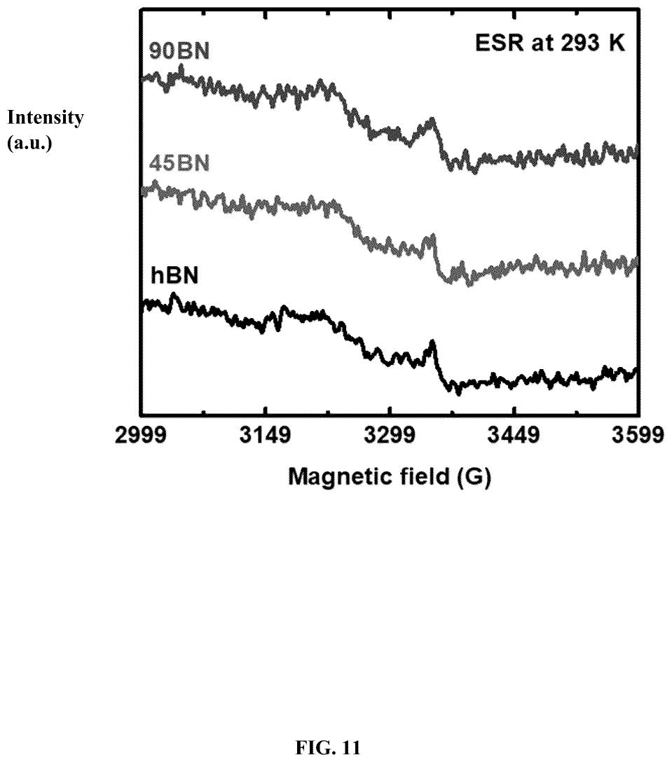

FIG. 10A shows XPS analysis of hBN; FIG. 10B shows XPS analysis of 90BN. The insets are the high-resolution B Is, O Is, and N Is scan, and the concentration of B, N, and O. FIG. 11 shows ESR spectra of hBN, 45 BN, 90BN at 293 K.

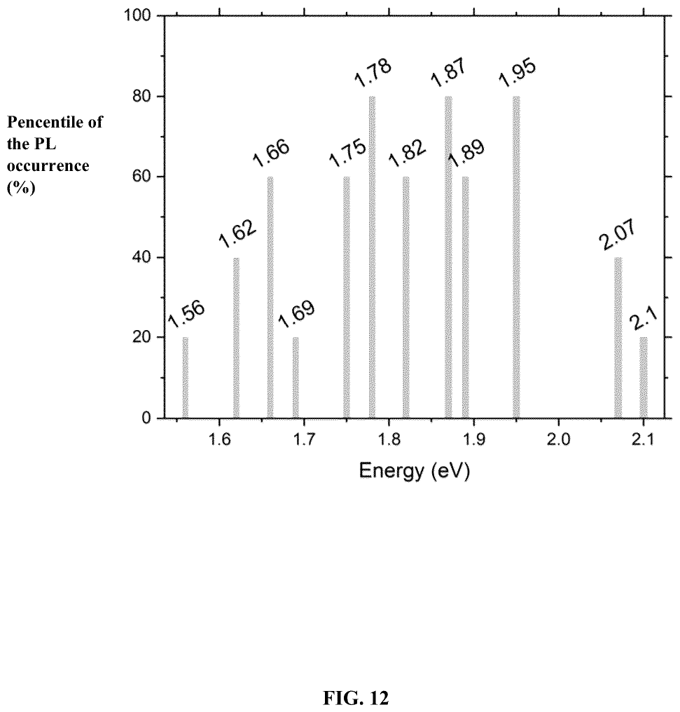

FIG. 12 shows statistic PL emission study of 90BN with a 488 nm excitation laser.

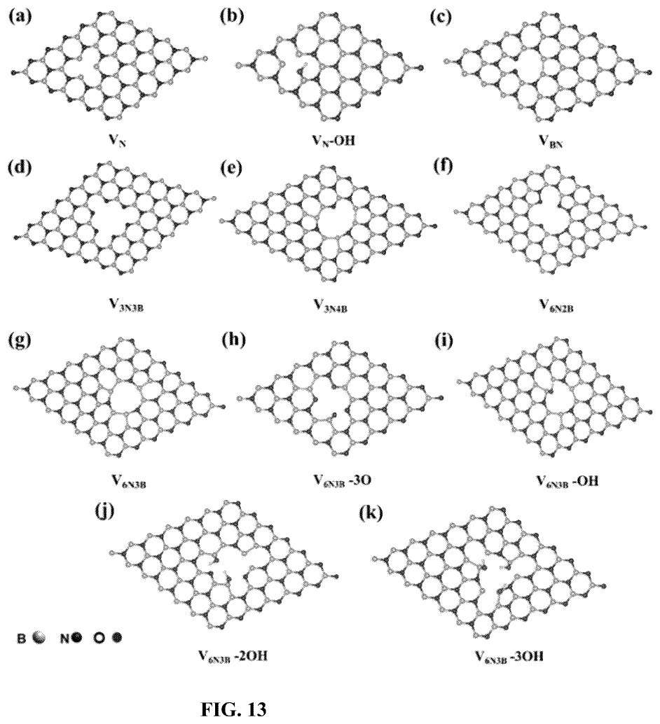

FIG. 13 shows model systems of 11 types of defects in dBN are shown: (a) V_{N}, (b) V_{N}—OH, (c) V_{BN}, (d) V_{3N3B}, (c) V_{3N4B}, (f) V_{6N2B}, (g) V_{6N3B}, and (h) V_{6N3B}-3O, (i) V_{6N3B}—OH, (j) V_{6N3B}-2OH, and (k) V_{6N3B}-3OH. The structures were computed by periodic DFT.

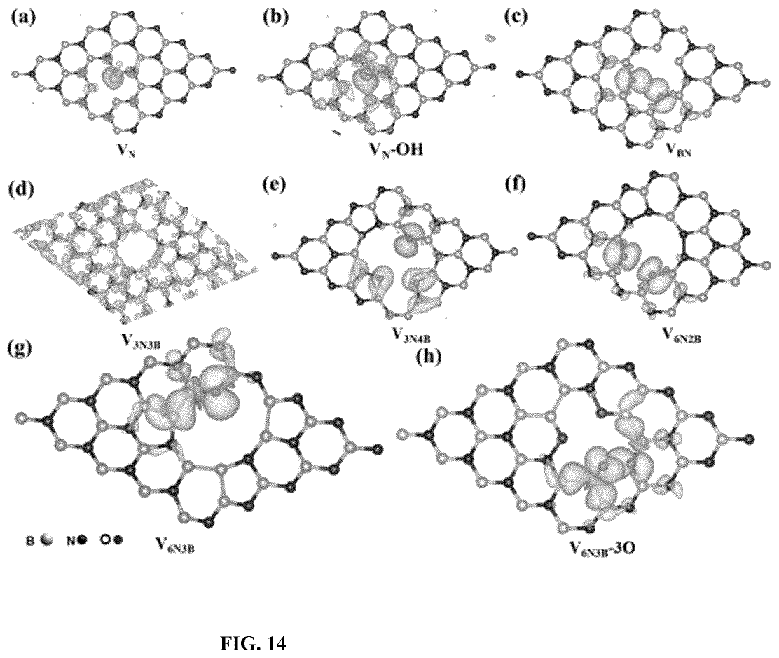

FIG. 14 shows the electron spin densities are shown for various dBN in a unit cell: (a) V_{N}, (b) V_{N}—OH, (c) V_{BN}, (d) V_{3N3B}, (c) V_{3N4B}, (f) V_{6N2B}, (g) V_{6N3B}, and (h) V_{6N3B}-3O computed by DFT. The yellow color represents the up-spin electrons (i.e. a electrons) and blue down-spin electrons (i.e. β electrons).

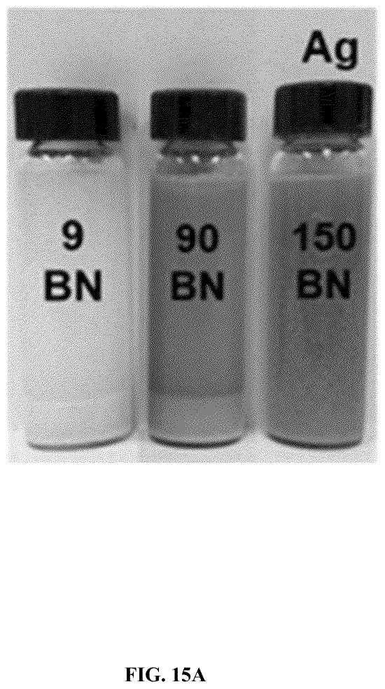

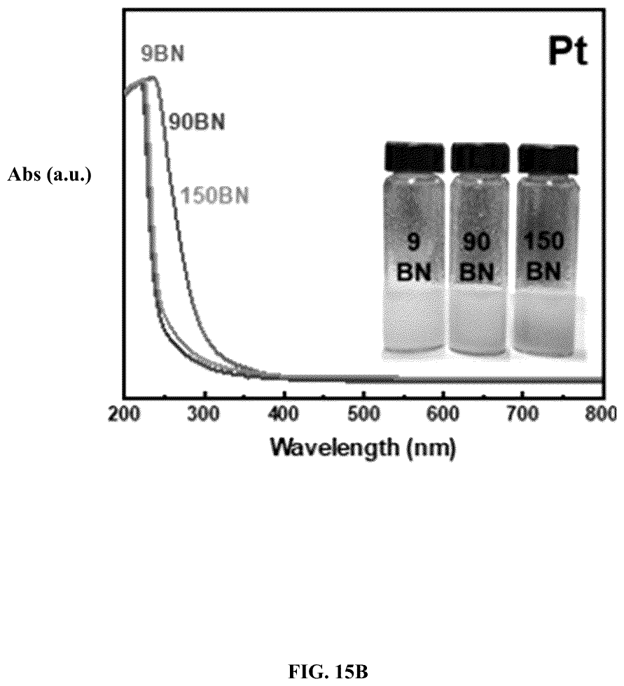

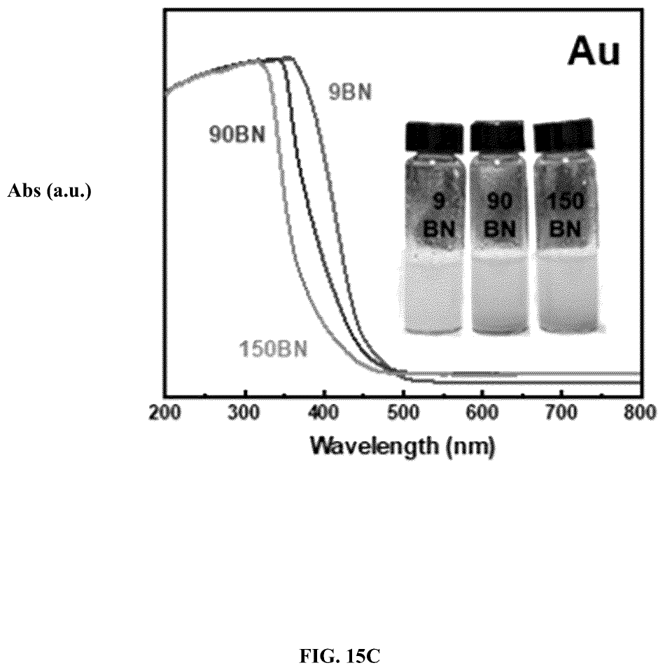

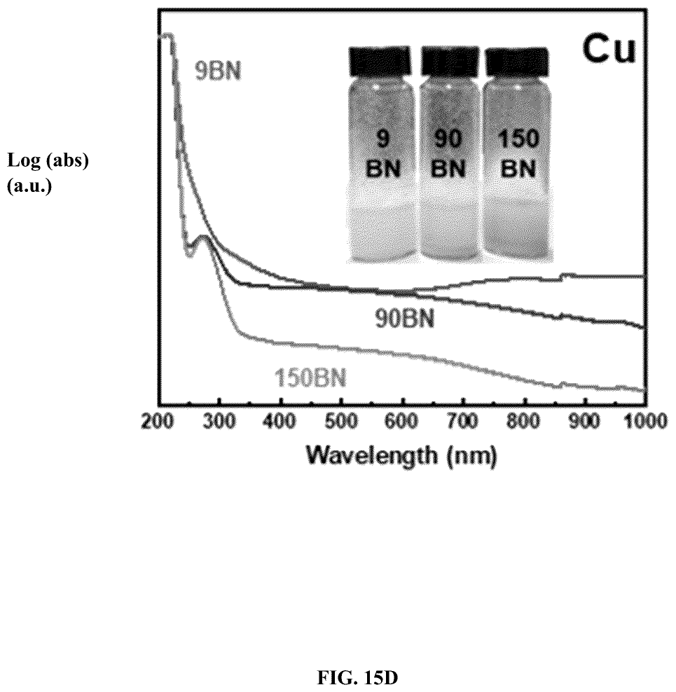

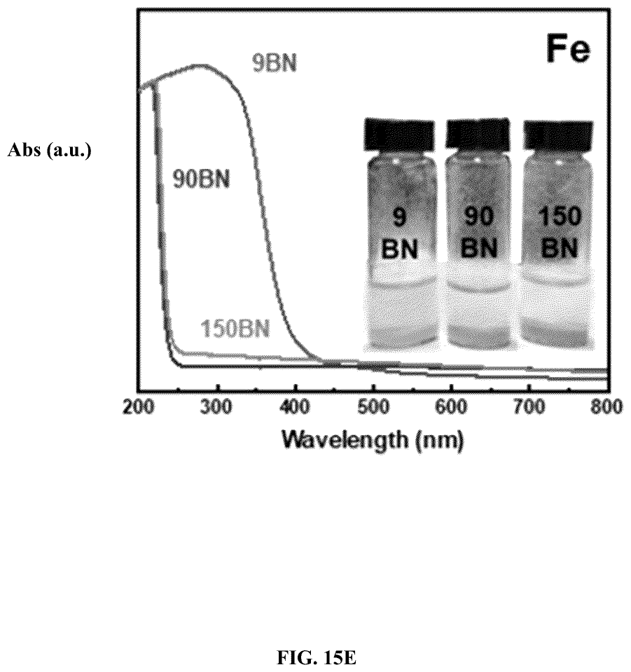

FIGS. 15A, 15B, 15C, 15D, and 15E show a characterization of 9, 90 and 150BN reducing (FIG. 15A) Ag, (FIG. 15B) Pt, (FIG. 15C) Au, (FIG. 15D) Cu and (15E) Fe. The photographs show the 9, 90 and 150BN samples after reaction at room temperature with (FIG. 15A) 0.001 M AgNO₃, (FIG. 15B) 0.001 M PtCl₄, (FIG. 15C) 0.01 M HAuCl₄ (FIG. 15D) 0.01 M CuSO₄, (FIG. 15E) 0.01 M FeCl₃ aqueous solution, respectively. UV-Vis spectra of the supernatant after d-BN (9, 90, and 150BN) reacts with (FIG. 15B) PtCl₄, (FIG. 15C) HAuCl₄ (FIG. 15D) CuSO₄, and (FIG. 15E) FeCl₃ aqueous solution. The reduction is visually evident by observing more discoloration for 150BN when compared to 9BN.

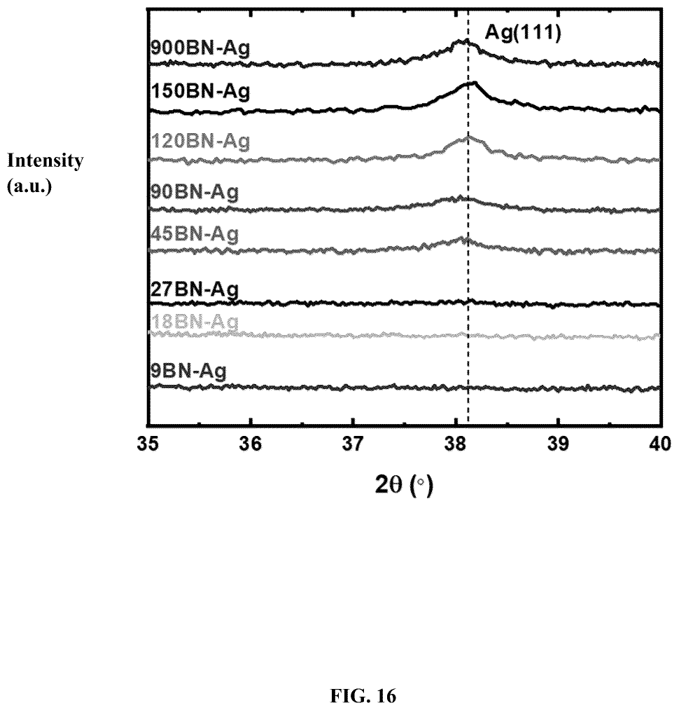

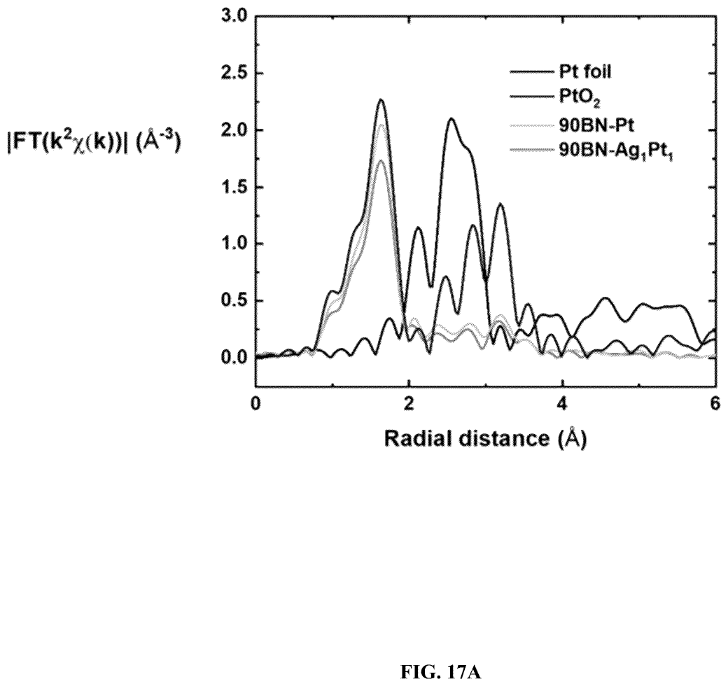

FIG. 16 shows XRD of the dried resultants from 500 mg d-BN (9, 18, 27, 45, 90, 120, 150, and 900 min) after the reaction with 10 ml 0.001 M AgNO₃ aqueous solution at room temperature.

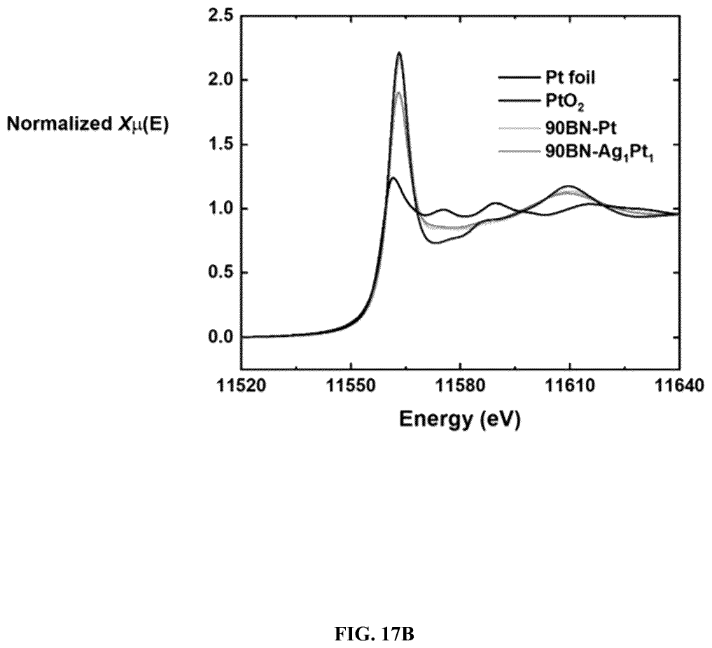

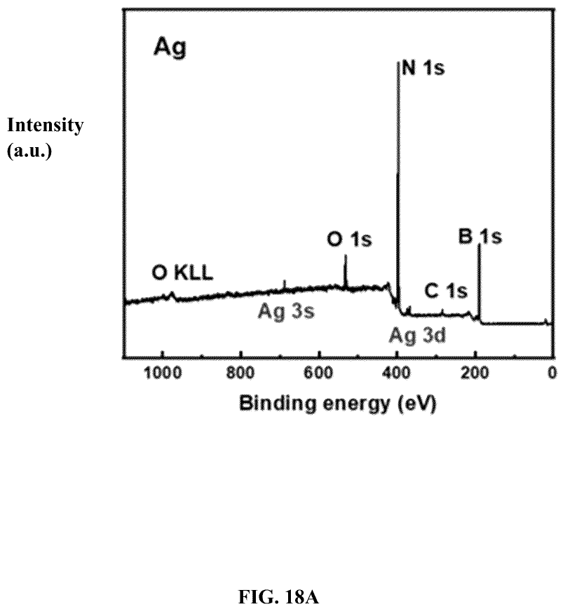

FIG. 17A shows the Fourier transformed R-space and FIG. 17B shows Pt L3-edge XANES spectra of 90BN—Pt, 90BN—Ag₁Pt₁, Pt foil and PtO₂ from EXAFS.

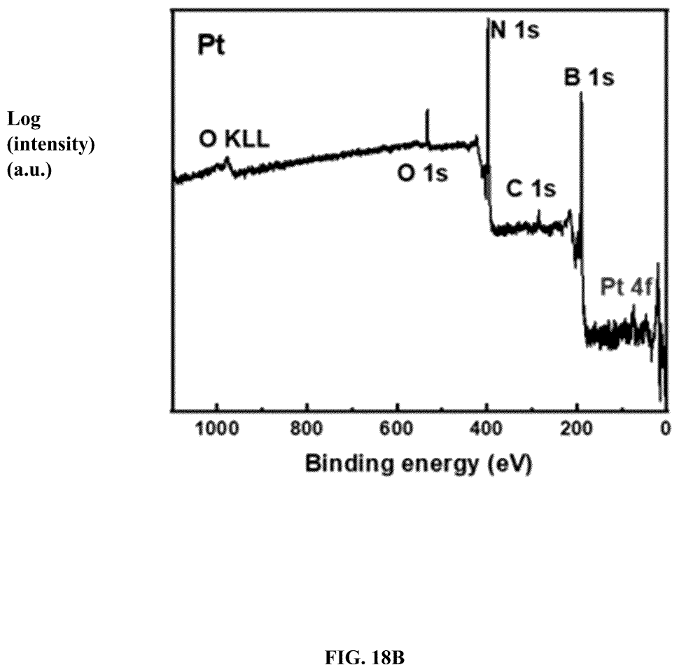

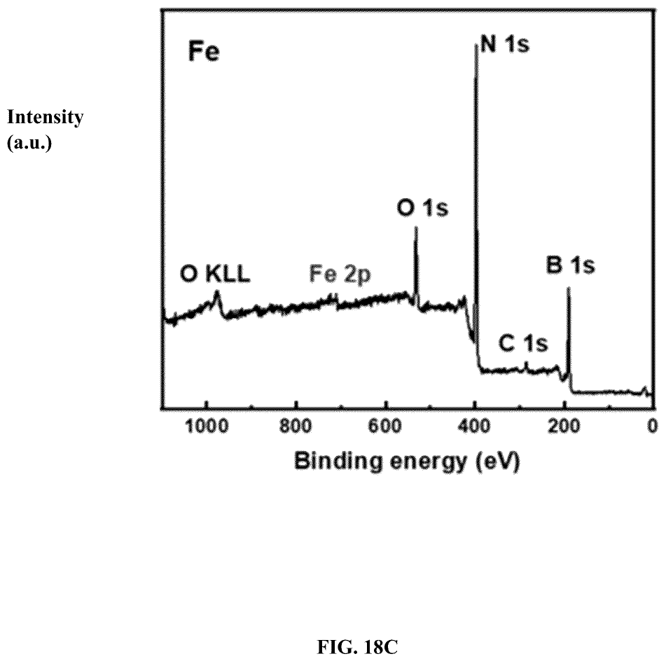

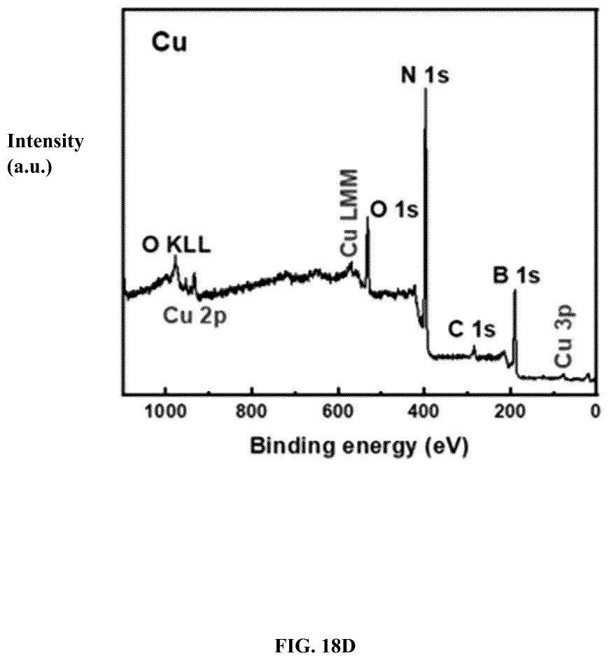

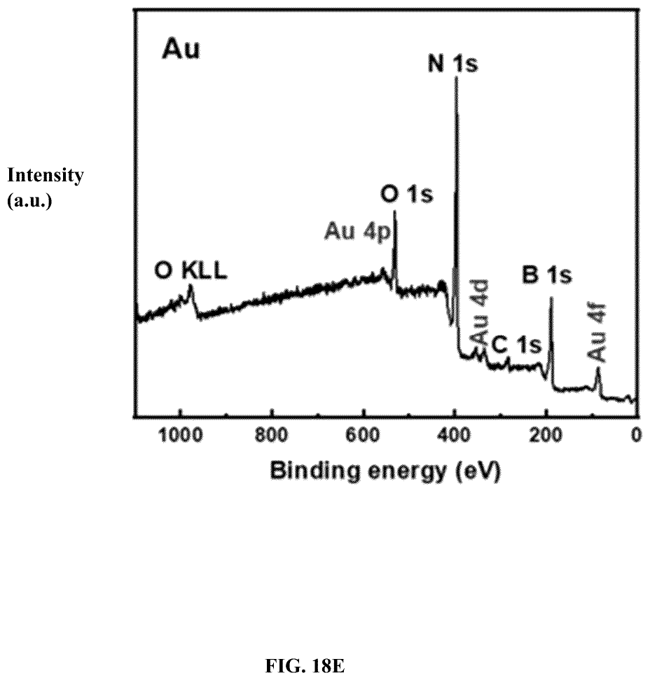

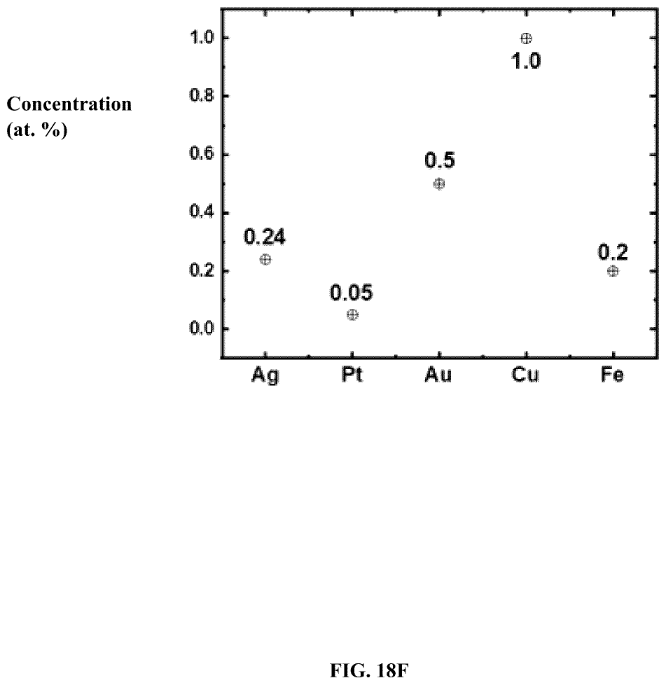

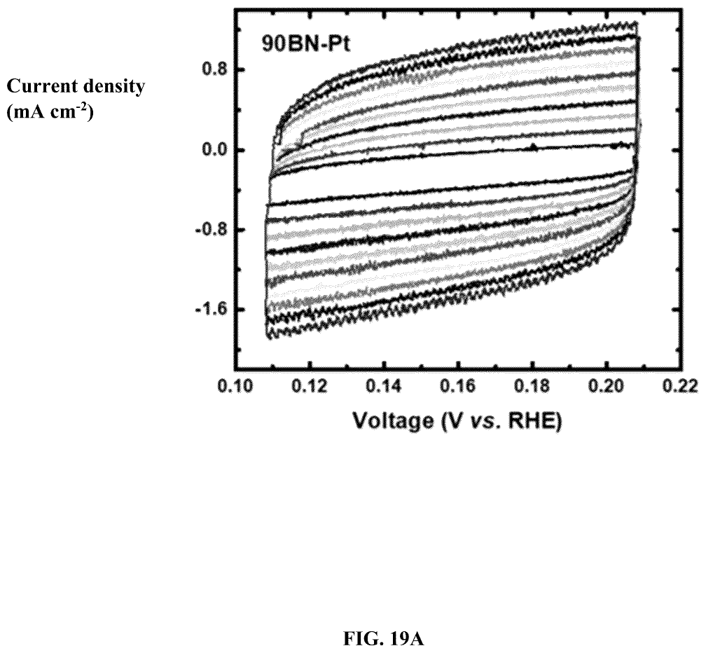

FIGS. 18A, 18B, 18C, 18D, 18E, and 18F show XPS survey spectra measured for (FIG. 18A) 90BN—Ag, (FIG. 18B) 90BN—Pt, (FIG. 18C) 90BN—Fe, (FIG. 18D) 90BN—Cu, and (FIG. 18E) 90BN—Au. FIG. 18F shows the summary of the metal content based on the XPS results.

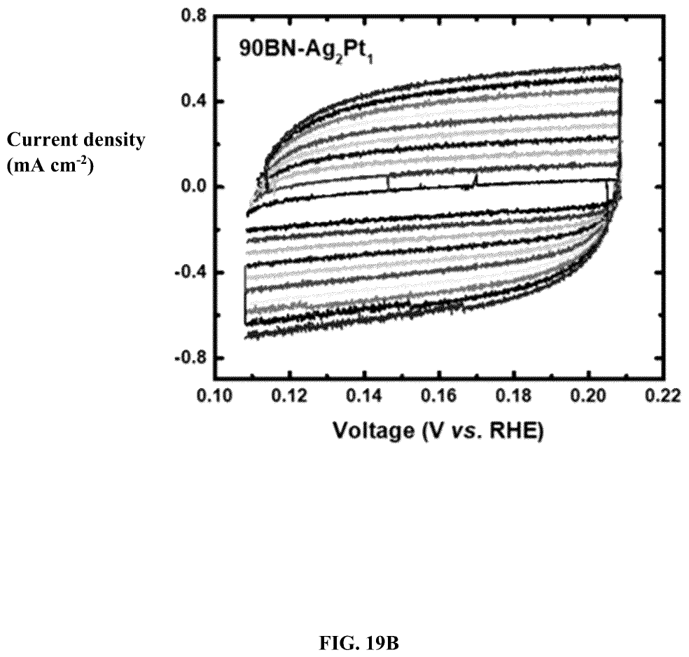

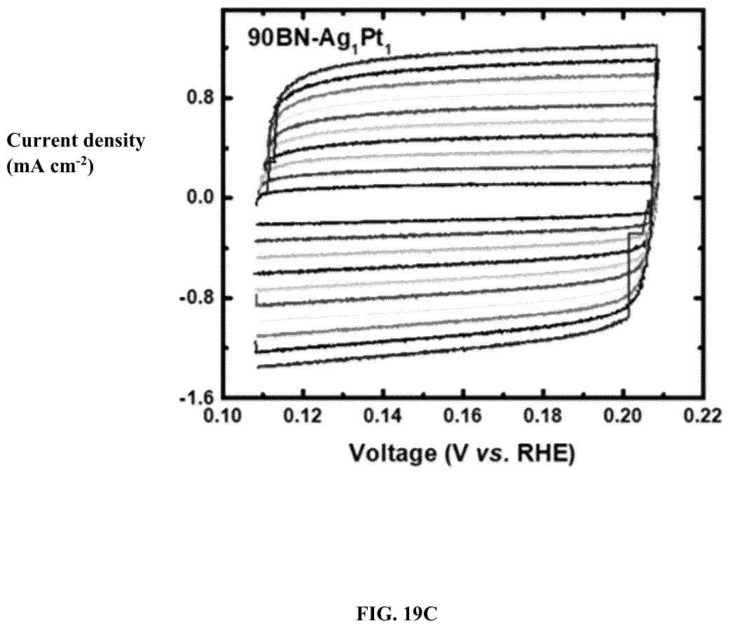

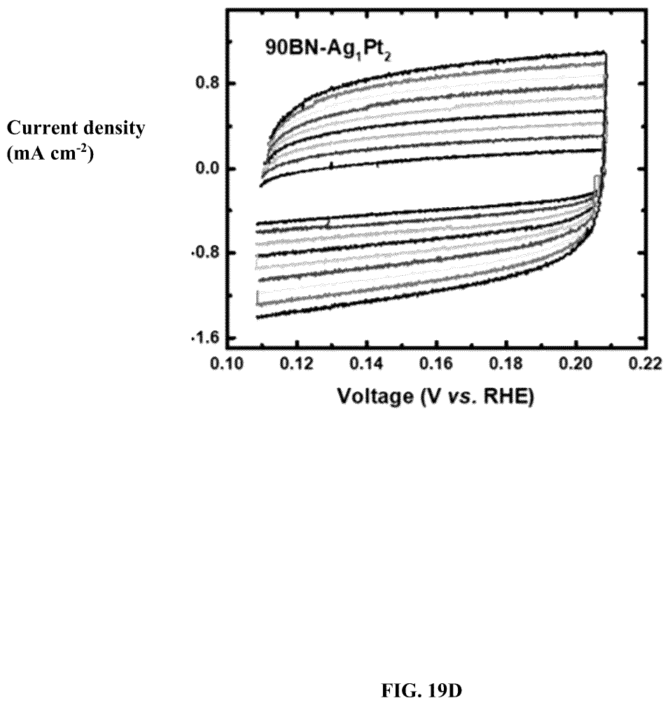

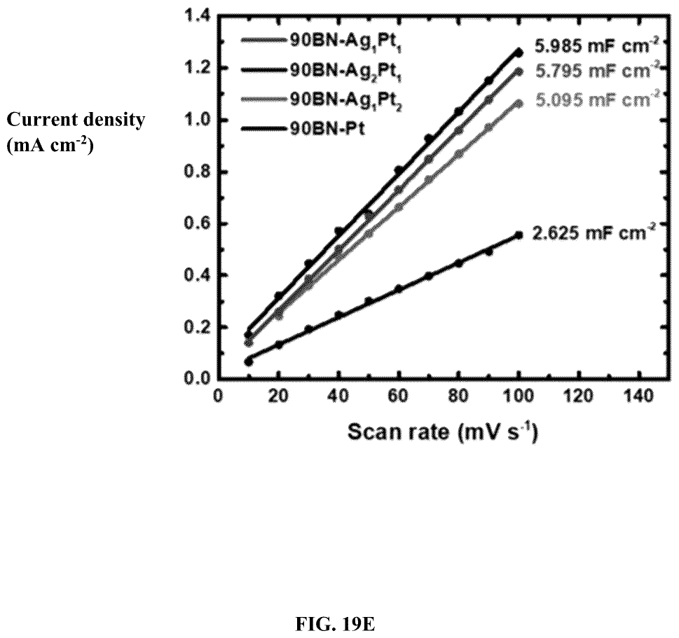

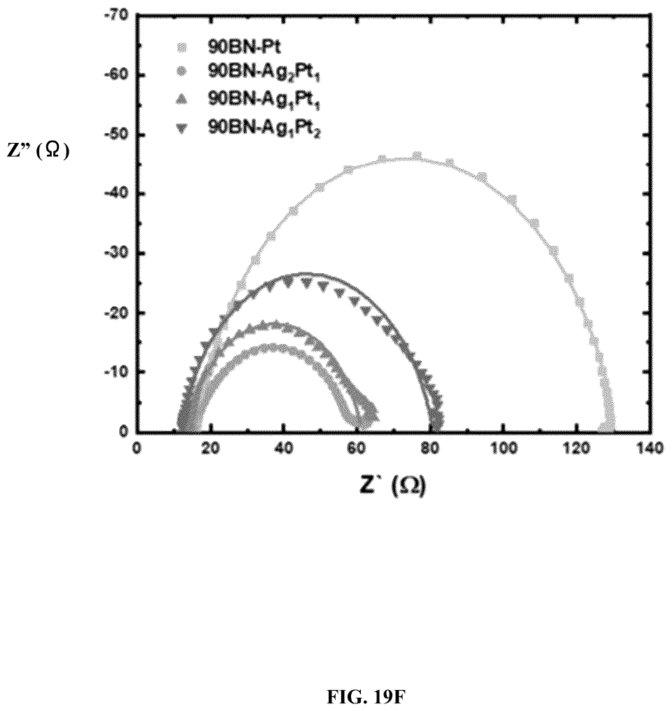

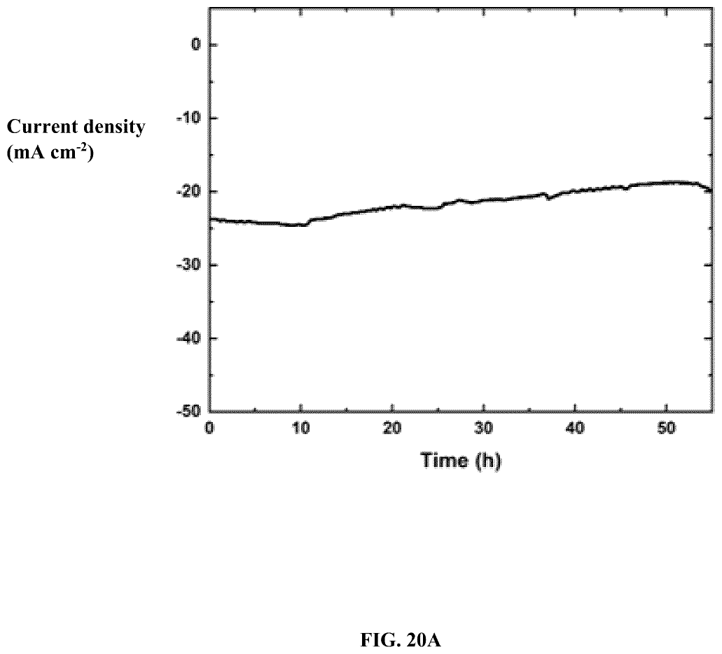

FIGS. 19A, 19B, 19C, 19D, and 19E show electrochemical active surface area (ECSA) measurements using cyclic voltammetry (CV) scans at different scan rates (10 mV s¹, 20 mV s⁻¹, 30 mV s¹, 40 mV s¹, 50 mV s¹, 60 mV s¹, 70 mV s¹, 80 mV s¹, 90 mV s¹, 100 mV s⁻¹); CV scans of (FIG. 19A) 90BN—Pt, (FIG. 19B) 90BN—Ag₂Pt₁, (FIG. 19C) 90BN—Ag₁Pt₁, and (FIG. 19D) 90BN—Ag₁Pt₂; (FIG. 19E) the average of the absolute values of cathodic and anodic current collected at 0.16 V (vs. RHE) as the function of the scan rate, and the slope of the linear fitted line is used to calculate the double-layer capacitance. FIG. 19F shows EIS curves of the 90BN with Pt, Ag₂Pt₁, Ag₁Pt₁, and Ag₁Pt₂ as the working electrodes in 0.5 M H₂SO₄.

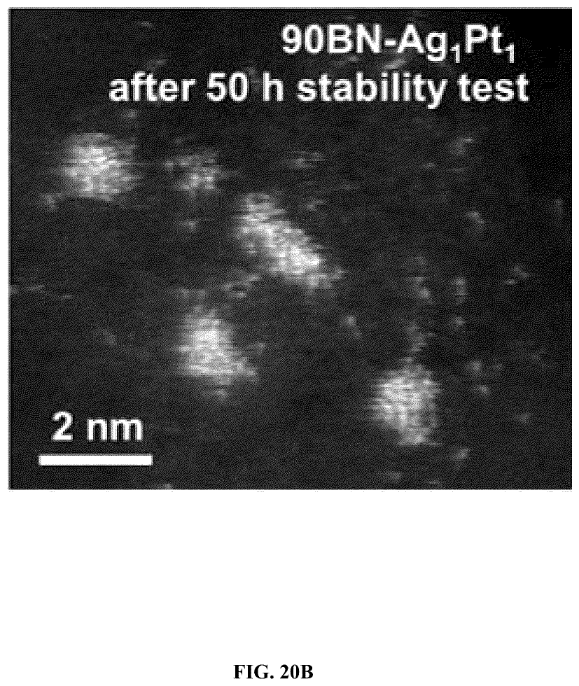

FIG. 20A shows the amperometric I-t stability curve at a constant overpotential of 55 mV for 50 h. FIG. 20B shows a STEM image of 90BN—Ag₁Pt₁ after the amperometric stability test.

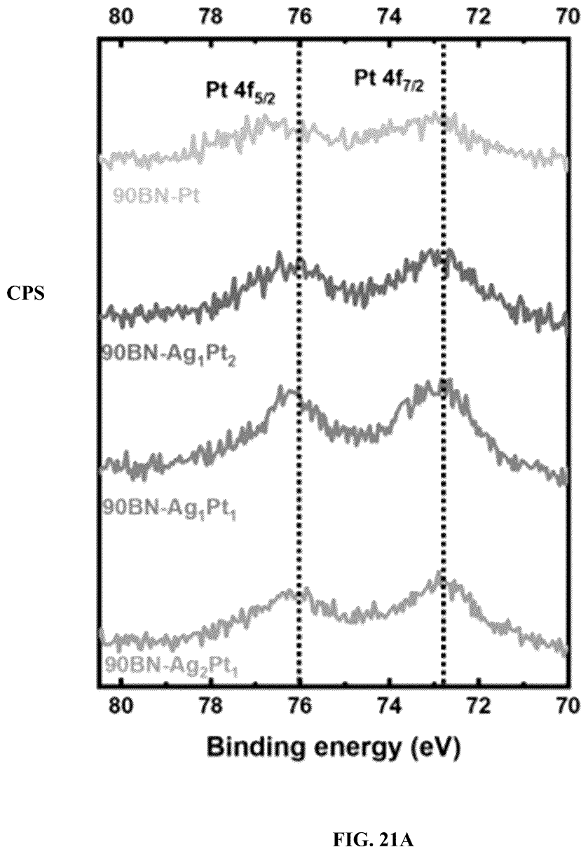

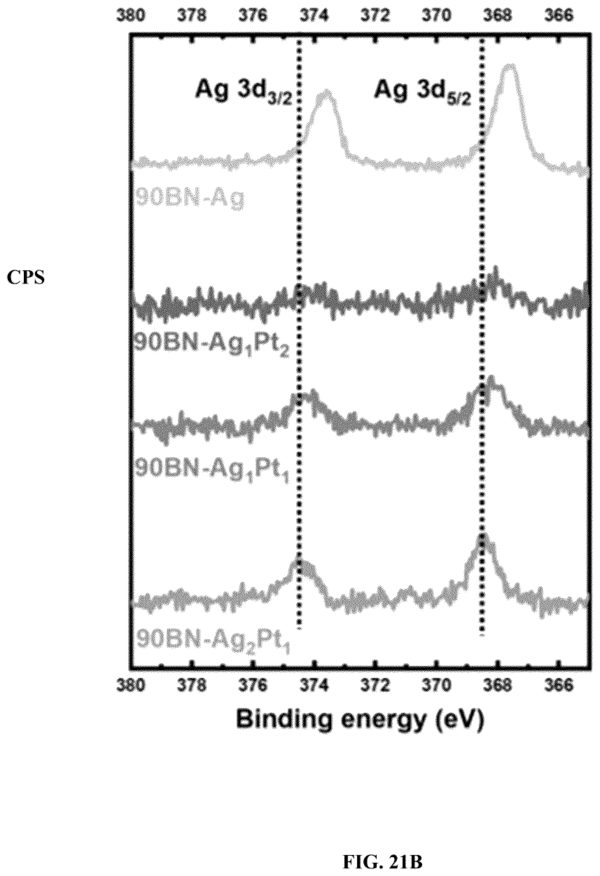

FIGS. 21A and 21B show XPS spectra of 90BN—Pt, Ag₁Pt₂, Ag₁Pt₁, and Ag₂Pt₁ in the (FIG. 21A) Pt 4f region; (FIG. 21B) Ag 3d region.

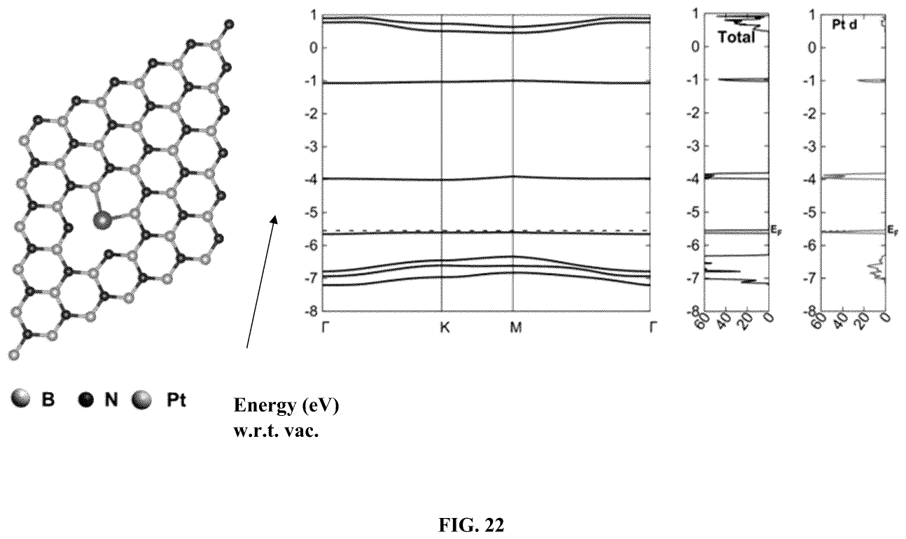

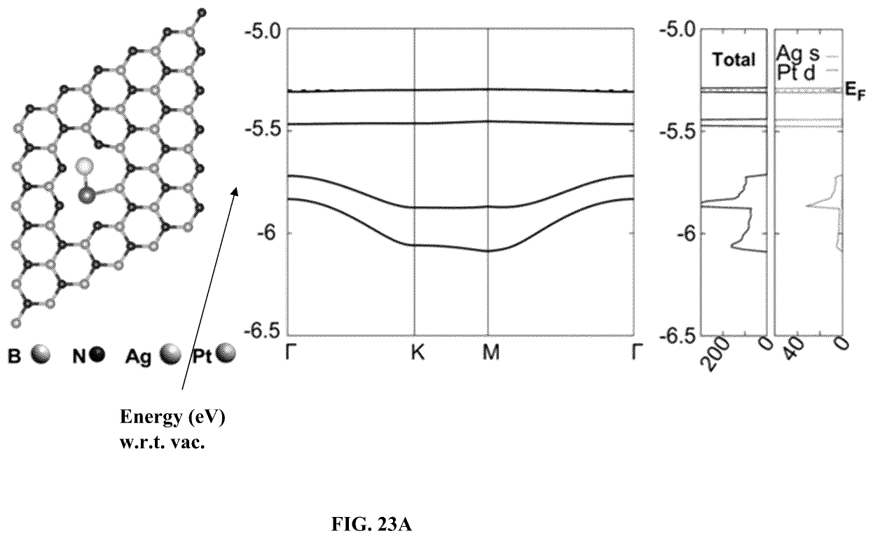

FIG. 22 shows DFT calculations, illustrating the optimized structures, band structure, and DOS for d-BN: Pt. The DOS also shows the subshells contributions.

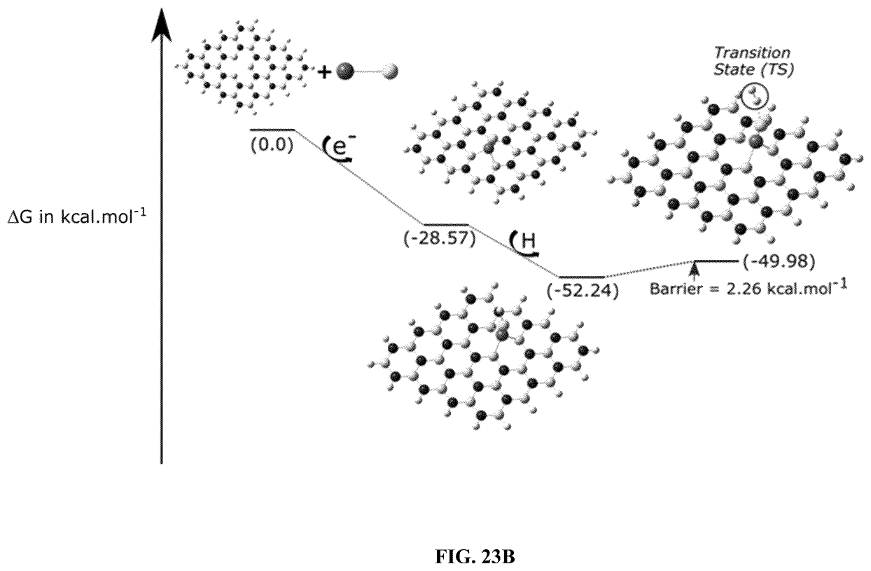

FIGS. 23A and 23 B show DFT calculations. FIG. 23A shows the optimized d-BN: Ag₁Pt₁ structure, band structure, and total and partial DOS. FIG. 23 B shows the mechanism for HER in d-BN: Ag₁Pt₁: (i) cluster adsorption; (ii) H⁺ adsorption, and (iii) H₂ formation. The reactions pathways are performed in an implicit solvation model for H₂SO₄.

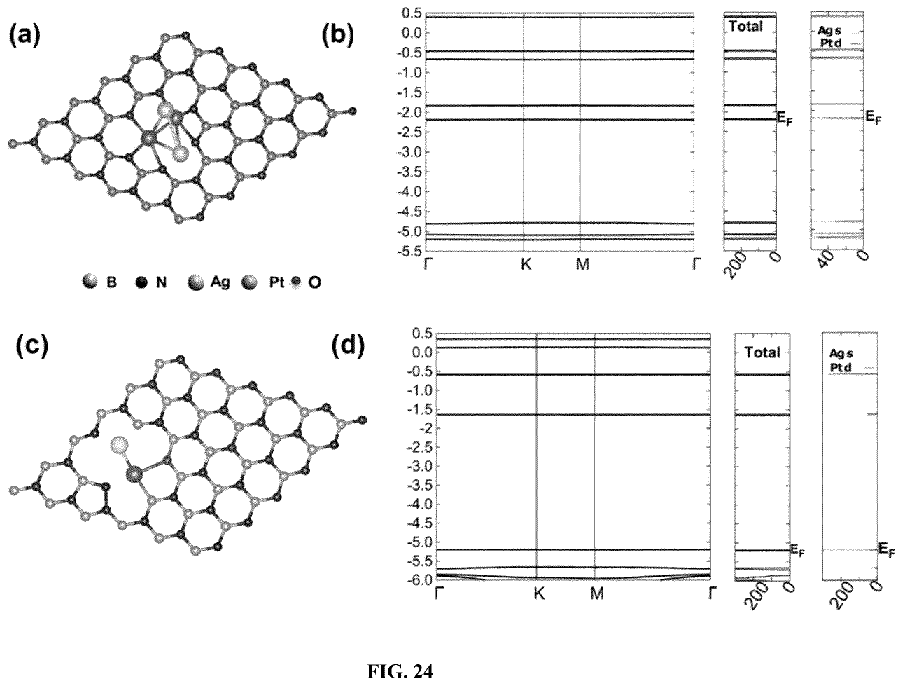

FIG. 24 shows (a) the equilibrium structures of the d-BN: Ag₂Pt₂, (b) its band structure and total DOS along with s-subshells contribution from Ag atoms and d-subshells contributions from the Pt atom, (c) the equilibrium structures of the d-BN: AgPt bonded with O, and (d) its band structure and total DOS along with s-subshells contribution from Ag atoms and d-subshells contributions from the Pt atom.

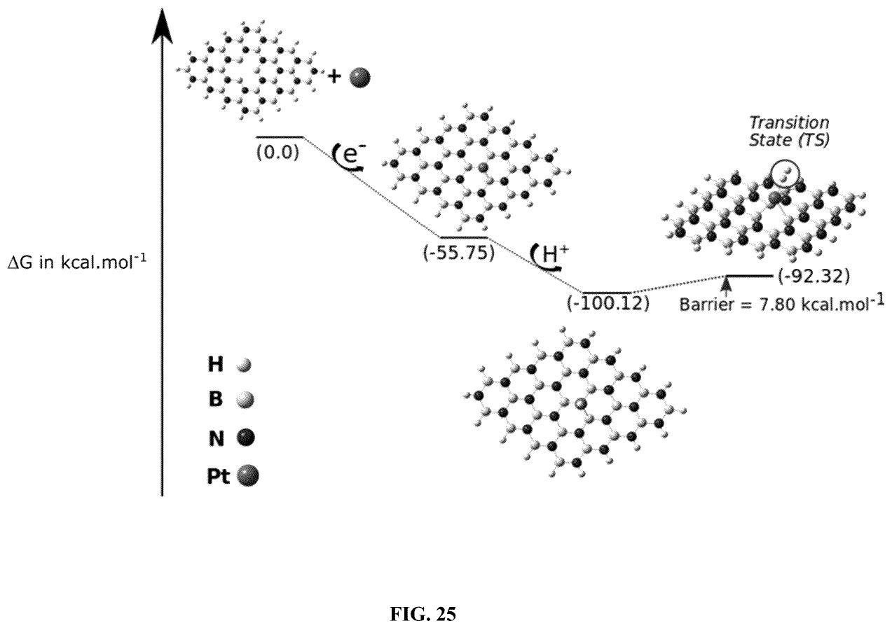

FIG. 25 shows molecular cluster model system to investigate the HER; (i) Pt adsorption; (ii) H⁺ adsorption; and (iii) H₂ formation. The reaction pathways are computed in acidic solvent phase using PCM model with a dielectric constant of 21.90 for H₂SO₄. The highly exothermic values are because the values for the cohesive energy of the metals are not included in the calculations.

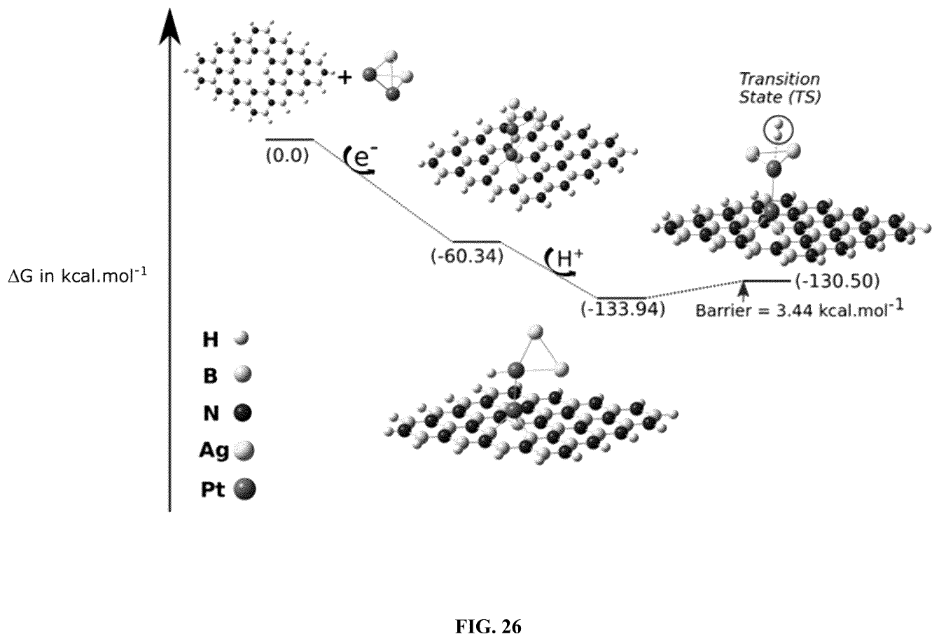

FIG. 26 shows the mechanism for HER in d-BN: Ag₂Pt₂: (i) cluster adsorption; (ii) H⁺ adsorption, and (iii) H₂ formation. The reaction pathways are in solvent phase (H₂SO₄). The highly exothermic values are because the values for the cohesive energy of the metals are not included in the calculations.

TABLE 1
Summary of the band structure changes due to the
defects with respect to vacuum in eV units.

| | | Valence | Conduction | Band | Emissions due | |
|---|---|---|---|---|---|---|
| | | band | band | Gap | to internal | IT |
| Systems | E_{F} | (VB) | (CB) | (E_{g}) | transition (IT) | in CB |
| Bulk BN | −6.22 | −6.25 | −0.09 | 6.16 | | |
| 1L BN | −6.28 | −6.29 | 0.5 | 6.79 | | |
| V_{N} | −1.56 | −1.57 | 0.32 | 1.89 | | |
| V_{N}—OH | −4.56 | −4.57 | −2.58 | 1.99 | | |
| V_{BN} | −3.32 | −3.51 | −2.35 | 1.16 | | |
| V_{3N3B} | −5.95 | −5.951 | −1.07 | 4.88 | 1.61 | 0.54 |
| V_{3N4B} | −5.56 | −5.57 | −3.63 | 1.94 | | |
| V_{6N2B} | −6.00 | −6.05 | −4.26 | 1.79 | | |
| V_{6N3B} | −5.54 | −5.55 | −1.74 | 3.81 | | |
| V_{6N3B}—OH | −4.88 | −4.89 | −1.78 | 3.11 | 1.57 | −0.21 |
| V_{6N3B}—2OH | −5.26 | −5.27 | −1.92 | 3.35 | 1.35 and 1.59 | −0.57 and −0.33 |
| V_{6N3B}—3OH | −4.72 | −4.73 | −2.12 | 2.61 | 1.73 and 1.97 | −0.39 and −0.15 |
| V_{6N3B}—3O | −5.41 | −5.42 | −1.28 | 4.14 | 1.67 | 0.39 |

TABLE 2
PIXE summary of 90BN—Pt, 90BN—Ag₁Pt₂, 90BN—Ag₁Pt₁,
and 90BN—Ag₂Pt₁ in at. ppm units.

| | 90BN—Pt | 90BN—Ag₁Pt₂ | 90BN—Ag₁Pt₁ | 90BN—Ag₂Pt₁ |
|---|---|---|---|---|
| Na | 245.6 | 156.4 | 168.5 | 192.6 |
| Mg | 62.1 | 64.9 | 61.8 | 68.1 |
| Al | 20.7 | 0.0 | 19.4 | 25.4 |
| Si | 85.0 | 65.6 | 82.9 | 84.2 |
| P | 0.0 | 0.0 | 26.1 | 21.7 |
| S | 7.0 | 0.0 | 6.2 | 6.2 |
| Cl | 11.9 | 52.7 | 89.2 | 28.8 |
| Ca | 5.6 | 5.9 | 7.5 | 5.6 |
| Fe | 24.7 | 18.7 | 21.0 | 22.7 |
| Cu | 0.0 | 0.0 | 0.4 | 0.0 |
| Zn | 0.2 | 0.0 | 0.6 | 0.2 |
| Ag | 0.0 | 91.2 | 159.3 | 217.0 |
| Pt | 77.7 | 125.7 | 118.1 | 75.9 |
| Ag/Pt | 0.00 | 0.73 | 1.35 | 2.86 |
| ratio | | | | |

TABLE 3
Summary of the HER performance

| | Onset | Tafel | TOF (s⁻¹) | | Exchange | | |
|---|---|---|---|---|---|---|---|
| | potential | slope | @100 mV | | current | | |
| | mV@10 mA cm⁻² | mV dec⁻¹ | Ag + Pt | Pt | mA cm⁻² | Stability | Ref. |
| 90BN—Ag₁Pt₁ | 30.18 +/− 4.05 | 33.18 +/− 3.06 | 10.17 | 25.17 | 1.45 | 10000 | This |
| | | | | | | cycles/ | work |
| | | | | | | 10 h | |
| 90BN—Ag₂Pt₁ | 61.45 +/− 5.57 | 44.77 +/− 4.34 | 4.20 | 14.80 | 0.48 | | |
| 90BN—Ag₁Pt₂ | 39.52 +/− 2.39 | 33.41 +/− 5.66 | 10.73 | 18.87 | 0.65 | | |
| 90BN—Pt | 82.52 +/− 5.02 | 51.42 +/− 1.29 | 8.15 | 8.15 | 0.29 | | |
| 20 wt. % Pt/C | 53.08 +/− 4.09 | 34.41 +/− 2.34 | 0.13 | 0.13 | 0.33 | | |
| Pt₁/OLC | 38 | 35 | N.A. | 40.78 | N.A. | 6000 | |
| | | | | | | cycles/ | |
| | | | | | | 100 h | |
| Pt₁/graphene | ~75 | 42 | N.A. | 17.67 | N.A. | | |
| Mo₂TiC₂Tₓ—Pt_{SA} | 30 | 30 | N.A. | N.A. | 1.54 | 10000 | |
| | | | | | | cycles/ | |
| | | | | | | 100 h | |
| Pt-GT-1 | 66 | 24 | N.A. | N.A. | 1.14 | 10000 | |
| | | | | | | cycles/ | |
| | | | | | | 5.5 h | |
| Pt/np- | 55 | 35 | N.A. | 3.93 | N.A. | 3000 | |
| Co_{0.85}Se | | | | | | cycles/ | |
| | | | | | | 40 h | |
| ALD50Pt/NG | ~42 | 29 | N.A. | N.A. | N.A. | 1000 | |
| Ns | | | | | | cycles | |

TABLE 4
EIS fitting results

| | Rₚ (Ω) | Rₛ (Ω) | CPE-T | CPE-P |
|---|---|---|---|---|
| 90BN—Pt | 114.3 | 16.08 | 3.79E−05 | 0.86516 |
| 90BN—Ag₁Pt₂ | 69.11 | 11.68 | 2.61E−05 | 0.83713 |
| 90BN—Ag₁Pt₁ | 47.68 | 13.62 | 2.78E−05 | 0.83196 |
| 90BN—Ag₂Pt₁ | 43.17 | 15.18 | 5.37E−05 | 0.75085 |

TABLE 5
Band gap (E_{g}), position of the Fermi energy level (E_{F}) and the
formation energy (ΔE) of various system studied in this
work. The units of band gap, position of Fermi level and formation
energy are expressed in eV. The values for the cohesive energy
of the metals are not included in the calculations.

| Systems | E_{g} (eV) | E_{F} (eV) | ΔE (eV) |
|---|---|---|---|
| d-BN:Pt | 1.54 | −5.55 | −2.57 |
| d-BN:Ag₁Pt₁ | 0.00 | −5.26 | −2.89 |
| d-BN:Ag₂Pt₂ | 0.00 | −3.87 | −2.72 |

### REFERENCES

The following references are incorporated herein by reference in their entireties.
1. Armand M, Tarascon J M. Building better batteries. Nature 2008, 451 (7179): 652-657.
2. Etacheri V, Marom R, Elazari R, Salitra G, Aurbach D. Challenges in the development of advanced Li-ion batteries: a review. Energy & Environmental Science 2011, 4 (9): 3243-3262.
3. Tarascon J M, Armand M. Issues and challenges facing rechargeable lithium batteries. Nature 2001, 414 (6861): 359-367.
4. Liang Y, Dong H, Aurbach D, Yao Y. Current status and future directions of multivalent metal-ion batteries. Nature Energy 2020, 5 (9): 646-656.
5. Goodenough J B, Kim Y. Challenges for Rechargeable Li Batteries. Chemistry of Materials 2010, 22 (3): 587-603.
6. Masias A, Marcicki J, Paxton W A. Opportunities and Challenges of Lithium Ion Batteries in Automotive Applications. ACS Energy Letters 2021, 6 (2): 621-630.
7. Aricò A S, Bruce P, Scrosati B, Tarascon J-M, van Schalkwijk W. Nanostructured materials for advanced energy conversion and storage devices. Nature Materials 2005, 4 (5): 366-377.
8. Cabana J, Monconduit L, Larcher D, Palacin M R. Beyond Intercalation-Based Li-Ion Batteries: The State of the Art and Challenges of Electrode Materials Reacting Through Conversion Reactions. Advanced Materials 2010, 22 (35): E170-E192.
9. Liu J, Bao Z, Cui Y, Dufek E J, Goodenough J B, Khalifah P, et al. Pathways for practical high-energy long-cycling lithium metal batteries. Nature Energy 2019, 4 (3): 180-186.
10. Poizot P, Laruelle S, Grugeon S, Dupont L, Tarascon J M. Nano-sized transition-metal oxides as negative-electrode materials for lithium-ion batteries. Nature 2000, 407 (6803): 496-499.
11. Nowroozi M A, Mohammad I, Molaiyan P, Wissel K, Munnangi A R, Clemens O. Fluoride ion batteries—past, present, and future. Journal of Materials Chemistry A 2021, 9 (10): 5980-6012.
12. Nowroozi M A, Wissel K, Donzelli M, Hosseinpourkahvaz N, Plana-Ruiz S, Kolb U, et al. High cycle life all-solid-state fluoride ion battery with La2NiO4+d high voltage cathode. Communications Materials 2020, 1 (1): 27.
13. Augustyn V, Simon P, Dunn B. Pseudocapacitive oxide materials for high-rate electrochemical energy storage. Energy & Environmental Science 2014, 7 (5): 1597-1614.
14. Liu J, Wang J, Xu C, Jiang H, Li C, Zhang L, et al. Advanced Energy Storage Devices: Basic Principles, Analytical Methods, and Rational Materials Design. Advanced Science 2018, 5 (1): 1700322.
15. Lübke M, Shin J, Marchand P, Brett D, Shearing P, Liu Z, et al. Highly pseudocapacitive Nb-doped TiO₂ high power anodes for lithium-ion batteries. Journal of Materials Chemistry A 2015, 3 (45): 22908-22914.
16. Avvaru V S, Fernandez I J, Feng W, Hinder S J, Rodríguez M C, Etacheri V. Extremely pseudocapacitive interface engineered CoO@3D-NRGO hybrid anodes for high energy/power density and ultralong life lithium-ion batteries. Carbon 2021, 171:869-881.
17. Lei Y, Pakhira S, Fujisawa K, Liu H, Guerrero-Bermea C, Zhang T, et al. Low temperature activation of inert hexagonal boron nitride for metal deposition and single atom catalysis. Materials Today 2021.
18. Leofanti G, Padovan M, Tozzola G, Venturelli B. Surface area and pore texture of catalysts. Catalysis Today 1998, 41 (1-3): 207-219.
19. Chen G H, Weng W G, Wu D J, Wu C L, Lu J R, Wang P P, et al. Preparation and characterization of graphite nanosheets from ultrasonic powdering technique. Carbon 2004, 42 (4): 753-759.
20. Du M, Li X, Wang A, Wu Y, Hao X, Zhao M. One-Step Exfoliation and Fluorination of Boron Nitride Nanosheets and a Study of Their Magnetic Properties. Angewandte Chemie International Edition 2014, 53 (14): 3645-3649.
21 Chastain J, King Jr R C. Handbook of X-ray photoelectron spectroscopy. Perkin-Elmer Corporation 1992, 40:221.
22. Meiyazhagan A, Serles P, Salpekar D, Oliveira E F, Alemany L B, Fu R, et al. Gas-Phase Fluorination of Hexagonal Boron Nitride. Advanced Materials 2021, 33 (52): 2106084.
23. Singh R S, Tay R Y, Chow W L, Tsang S H, Mallick G, Teo E H T. Band gap effects of hexagonal boron nitride using oxygen plasma. Applied Physics Letters 2014, 104 (16): 163101.
24 Marom R, Haik O, Aurbach D, Halalay I C. Revisiting LiCIO [sub 4] as an Electrolyte for Rechargeable Lithium-Ion Batteries. Journal of The Electrochemical Society 2010, 157 (8): A972.
25. Leifer N, Smart M C, Prakash G K S, Gonzalez L, Sanchez L, Smith K A, et al. <sub>13</sub>C Solid State NMR Suggests Unusual Breakdown Products in SEI Formation on Lithium Ion Electrodes. Journal of The Electrochemical Society 2011, 158 (5): A471-A480.
26. Hamdi H, Thiering G, Bodrog Z, Ivády V, Gali A. Stone-Wales defects in hexagonal boron nitride as ultraviolet emitters. npj Computational Materials 2020, 6 (1): 178.
27. Hou S, Birowosuto M D, Umar S, Anicet M A, Tay R Y, Coquet P, et al. Localized emission from laser-irradiated defects in 2D hexagonal boron nitride. 2D Materials 2017, 5 (1): 015010.
28 Huber S P, Gullikson E, van de Kruijs R W E, Bijkerk F, Prendergast D. Oxygen-stabilized triangular defects in hexagonal boron nitride. Physical Review B 2015, 92 (24): 245310.
29. Liu Q, Chen C, Du M, Wu Y, Ren C, Ding K, et al. Porous Hexagonal Boron Nitride Sheets: Effect of Hydroxyl and Secondary Amino Groups on Photocatalytic Hydrogen Evolution. ACS Applied Nano Materials 2018, 1 (9): 4566-4575.
30 Tawfik S A, Ali S, Fronzi M, Kianinia M, Tran T T, Stampfl C, et al. First-principles investigation of quantum emission from hBN defects. Nanoscale 2017, 9 (36): 13575-13582.
31. Tran T T, Elbadawi C, Totonjian D, Lobo C J, Grosso G, Moon H, et al. Robust Multicolor Single Photon Emission from Point Defects in Hexagonal Boron Nitride. ACS Nano 2016, 10 (8): 7331-7338.
32. Weston L, Wickramaratne D, Mackoit M, Alkauskas A, Van de Walle C G. Native point defects and impurities in hexagonal boron nitride. Physical Review B 2018, 97 (21): 214104.
33. Alkauskas A, Buckley B B, Awschalom D D, Van de Walle C G. First-principles theory of the luminescence lineshape for the triplet transition in diamond NV centres. New Journal of Physics 2014, 16 (7): 073026.
34. Kubo R, Toyozawa Y. Application of the Method of Generating Function to Radiative and Non-Radiative Transitions of a Trapped Electron in a Crystal. Progress of Theoretical Physics 1955, 13 (2): 160-182.
35. Ebadi M, Marchiori C, Mindemark J, Brandell D, Araujo C M. Assessing structure and stability of polymer/lithium-metal interfaces from first-principles calculations. Journal of Materials Chemistry A 2019, 7 (14): 8394-8404.
36. Kheirabadi N, Shafiekhani A. Graphene/Li-ion battery. Journal of Applied Physics 2012, 112 (12): 124323.
37. Maurer R J, Ruiz V G, Camarillo-Cisneros J, Liu W, Ferri N, Reuter K, et al.

Adsorption structures and energetics of molecules on metal surfaces: Bridging experiment and theory. Progress in Surface Science 2016, 91 (2): 72-100.
38. Holzwarth U, Gibson N. The Scherrer equation versus the ‘Debye-Scherrer equation’. Nat Nanotechnol 2011, 6 (9): 534-534.
39 Brunauer S, Emmett P H, Teller E. Adsorption of Gases in Multimolecular Layers. J Am Chem Soc 1938, 60 (2): 309-319.
40. Seah M. Summary of ISO/TC 201 Standard: VII ISO 15472:2001-surface chemical analysis—x-ray photoelectron spectrometers—calibration of energy scales. Surface and Interface Analysis: An International Journal devoted to the development and application of techniques for the analysis of surfaces, interfaces and thin films 2001, 31 (8): 721-723.
41. Giannozzi P, Andreussi O, Brumme T, Bunau O, Buongiorno Nardelli M, Calandra M, et al. Advanced capabilities for materials modelling with Quantum ESPRESSO. Journal of Physics: Condensed Matter 2017, 29 (46): 465901.
42. Perdew J P, Burke K, Ernzerhof M. Generalized Gradient Approximation Made Simple. Physical Review Letters 1996, 77 (18): 3865-3868.
43. Kaduk B, Kowalczyk T, Van Voorhis T. Constrained Density Functional Theory. Chemical Reviews 2012, 112 (1): 321-370.
44. Grimme S. Semiempirical G GA-type density functional constructed with a long-range dispersion correction. Journal of Computational Chemistry 2006, 27 (15): 1787-1799.
45. Becke A D. A new mixing of Hartree-Fock and local density-functional theories. The Journal of Chemical Physics 1993, 98 (2): 1372-1377.
46. Perdew J P, Ernzerhof M, Burke K. Rationale for mixing exact exchange with density functional approximations. The Journal of Chemical Physics 1996, 105 (22): 9982-9985.
47. Adamo C, Barone V. Toward reliable density functional methods without adjustable parameters: The PBEO model. The Journal of Chemical Physics 1999, 110 (13): 6158-6170.
48. Holzwarth, U., and Gibson, N., Nat. Nanotechnol. (2011) 6 (9), 534.
49. Brunauer, S., et al., J. Am. Chem. Soc. (1938) 60 (2), 309.
50 Seah, M., Surface and Interface Analysis: An International Journal devoted to the development and application of techniques for the analysis of surfaces, interfaces and thin films (2001) 31 (8), 721.
51. Becke, A. D., The Journal of chemical physics (1993) 98 (7), 5648.
52. Lee, C. T., et al., Phys. Rev. B (1988) 37 (2), 785.
53 Pakhira, S., et al., J. Phys. Chem. C (2017) 121 (39), 21160.
54. Dovesi, R., et al., Int. J. Quantum Chem. (2014) 114 (19), 1287.
55. Grimme, S., J. Comput. Chem. (2006) 27 (15), 1787.
56. Sinha, N. et al., ACS Appl. Electro. Mat. (2021), 3 (2), 720.
57. Upadhyay, S. N. et al., J. Mat. Chem. C (2021), 9, 11331.
58. Pakhira, S. RSC Adv. (2021), 9 (65), 38137.
59. Peintinger, M. F., et al., J. Comput. Chem. (2013) 34 (6), 451.
60 Doll, K., Surf. Sci. (2004) 573 (3), 464.
61. Grimme, S., et al., J. Chem. Phys. (2010) 132 (15), 19.
62. Wenhan, N., et al., Adv. Energy Mater. 0 (0), 1800480.
63 Baker, J., et al., Chem. Phys. Lett. (1993) 216 (3-6), 380.
64 Montoya, A., et al., J. Phys. Chem. A (2000) 104 (26), 6108.
65. Monkhorst, H. J., and Pack, J. D., Phys. Rev. B (1976) 13 (12), 5188.
66 Dill, J. D., and Pople, J. A., J. Chem. Phys. (1975) 62 (7), 2921.
67 Hehre, W. J., et al., J. Chem. Phys. (1972) 56 (5), 2257.
68. Hay, P. J., and Wadt, W. R., J. Chem. Phys. (1985) 82 (1), 299.
69. Frisch, M., et al., Inc. Gaussian 09, Rev. E.01; Gaussian, Inc.: Wallingford, C T, 2016.
70 Liu, D., et al., Nat. Energy (2019) 4 (6), 512.
71 Zhang, J., et al., Nature Catalysis (2018) 1 (12), 985.
72. Tiwari, J. N., et al., Nat. Energy (2018) 3 (9), 773.
73 Jiang, K., et al., Nat. Commun. (2019) 10 (1), 3997.
74 Cheng, N., et al., Nat. Commun. (2016) 7 (1), 13638.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the apparatuses and methods of using and making the same disclosed herein have been discussed and illustrated, it is to be distinctly understood that the invention is not limited thereto but may be otherwise variously embodied and practiced within the scope of the following claims.

What is claimed is:

1. An electrode, comprising:
an electrically conductive member including a microstructure layer, the microstructure layer comprising boron nitride (BN) having a surface defect configured to provide a diffusion independent pseudocapacitive ion storage mechanism.

2. The electrode of claim 1, wherein:
the BN microstructure is hexagonal BN (hBN) platelets, hBN nanotubes, cubic BN, BN nanostructures, amorphous BN, non-stoichiometric BN, BₐX_{b} Y_{c}N_{d} (X, Y═H, C, O, P, Si), or any combination thereof.

3. The electrode of claim 1, further comprising:
plural surface defects, at least one surface defect of the plural surface defects configured to provide the pseudocapacitive ion storage mechanism.

4. The electrode of claim 3, wherein:
at least one surface defect is a type of defect that differs from a type of defect for at least one other surface defect.

5. The electrode of claim 1, wherein:
the surface defect includes a nitrogen vacancy.

6. The electrode of claim 3, wherein:
the plural surface defects includes a vacancy defect, a Stone-Wales defect, an oxygenated defect, a hydroxylized defect, and/or a substitutional defect.

7. The electrode of claim 1, wherein:
the surface defect is configured to provide the pseudocapacitive ion storage mechanism for a Li ion, a Na ion, a K ion, a Ca ion, a Zn ion, an Al ion, or a Mg ion.

8. The electrode of claim 1, wherein:
the electrically conductive member is configured as an anode electrode for a fuel cell, a battery device, a capacitor device, a hybrid battery-capacitor device, or a solid-state device.

9. The electrode of claim 1, wherein:
the electrically conductive member is an electrode for a thermally stable secondary fuel cell operable within a range from −30° C. to 100° C.

10. The electrode of claim 9, wherein:
the thermally stable secondary fuel cell is an ion battery comprising a Li-ion battery, a K-ion battery, a Na-ion battery, an Al-ion battery, a Ca-ion battery, a Zn-ion battery, a Mg-ion battery, or any combination thereof.

11. The electrode of claim 1, wherein:
at least a portion of the electrically conductive member having the microstructure layer is fire retardant, fire resistance, or fireproof.

12. A fuel cell, comprising:
an anode including a microstructure layer, the microstructure layer comprising boron nitride (BN) having a surface defect configured to provide a diffusion independent pseudocapacitive ion storage mechanism.

13. The fuel cell of claim 12, wherein:
the cycle-life of the fuel cell is equal to or greater than 500 cycles;
the energy density is equal to or greater than 400 Wh kg⁻¹; and/or
the power density is equal to or greater than 1 kW kg⁻¹.

14. A method for defect engineering boron nitride (BN), the method comprising:
forming reactive BN (RBN) by breaking B—N bonds; and
activation of the RBN.

15. The method of claim 14, wherein:
forming RBN involves cryo-milling, ball-milling, sonication, focused ion/electron beam irradiation, detonation, chemical treatment, and/or thermal treatment in limited oxygen; and
activation of the RBN involves chemical activation and/or electrochemical activation.

16. The method of claim 15, wherein:
the activation involves creating an F-ion, and forming a metal-F bond with the F-ion.

17. The method of claim 16, wherein:
the activation involves electrochemical cyclic voltammetry, galvanostatic cycling, and/or potentiostatic cycling.

18. The method of claim 16, wherein:
the activation involves cycling the RBN using a F-ion supporting electrolyte, wherein the cycling decomposes the electrolyte to reversably store a metal ion through metal ion-F bond formation.

19. The method of claim 18, wherein:
the activation involves cycling an electrochemical cell comprising:
an anode comprising a microstructure layer of RBN;
a cathode comprising a metal; and
electrolyte containing ion salts of the metal and F.

20. The method of claim 19, wherein:
anions comprise PF6, TFSI, and/or F.

21. A method of generating an ion storage mechanism in or on a microstructure surface, the method comprising:
generating a surface defect configured to provide a diffusion independent pseudocapacitive ion storage mechanism without use of intercalation.
